(19) United States
(12) Patent Application Publication
(10) Pub. No.: US 2006/0204886 A1
(43) Pub. Date: Sep. 14, 2006

(54) Heat transfer sheet, image forming material and image forming method

(76) Inventors: Hideyuki Nakamura, Shizuoka (JP); Shinichi Yoshinari, Shizuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/555,016

(22) PCT Filed: May 28, 2004
(86) PCT No.: PCT/JP04/07767

§ 371 Date: Nov. 1, 2005

(30) Foreign Application Priority Data
May 30, 2003 (JP) 2003-155477
Jun. 19, 2003 (JP) 2003-175083
Sep. 26, 2003 (JP) 2003-335449

(51) Int. Cl. G03C 1/76

(52) U.S. Cl. 430/270.1

(57) ABSTRACT

The present invention provides a heat transfer sheet comprising a support, a light-to-heat converting layer and an image forming layer, wherein the image forming layer contains at least a white pigment and an amorphous organic polymer having a softening point of 40° C. to 150° C., an average particle size of the white pigment is from 0.01 μm to 0.32 μm, an amount of the white pigment is from 40% by weight to 90% by weight based on the total weight of the image forming layer, an amount of the amorphous organic polymer is from 10% by weight to 60% by weight based on the total weight of the image forming layer, and a thickness of the image forming layer is from 0.5 μm to 3.0 μm; an image forming material comprising the heat transfer sheet; and an image forming method using the image forming material.

### TECHNICAL FIELD

The present invention relates to a heat transfer sheet, an image forming material and an image forming method for forming a high resolution image by use of a laser beam. In particular, the invention relates to a heat transfer sheet, an image forming material and an image forming method useful for the preparation of a color proof (DDCP: direct digital color proof) or a mask image in the printing field from a digital signal by laser recording.

### BACKGROUND ART

In the graphic art field, printing of a printing plate is carried out using a set of color separation films prepared from a color original by use of a lith film. In general, a color proof is prepared from the color separation films for checking errors in a color separation process and necessity of color correction before final printing (actual printing operation). The color proof has been desired to realize high resolving power which enables high reproducibility of a medium image, and to have performances such as high process stability. Further, for obtaining the color proof approximating to actual printed matter, materials used for the actual printed matter such as stock paper (an actual printing paper) as a substrate and a pigment as a colorant are preferably used as materials used for the color proof. As a method for preparing the color proof, a dry method using no developing solution is highly desired.

A DDCP (Direct Digital Color Proof) recording system for directly preparing the color proof from a digital signal has been developed with the recent dissemination of the electronic system in the preliminary process of printing (prepress field). Also, in the progress of a DTP (Desk Top Publication) circumstance, the users of CTP (Computer To Plate) eliminate an intermediate film forming step and strongly request proofing by the DDCP system instead of proof printing or proofing by an analog system. Further, in recent years, a large-size DDCP system of high grade and high stability and excellent in coincidence in printing has been desired. Such a system is intended for the preparation of color proof of particularly high image quality, and in general, a laser beam which can be modulated by a digital signal and make recording light thin is used as a recording head in the system, whereby a halftone dot image of 150 lines/inch is reproduced. Accordingly, it is necessary to develop an image forming material having high transfer sensitivity to the laser beam and exhibiting high resolution which makes it possible to reproduce highly fine halftone dots.

As an image forming material used in a transfer image formation method using a laser beam, there is known a heat melt transfer sheet comprising a support having provided thereon a light-to-heat converting layer absorbing a laser beam to generate heat and an image forming layer in which a pigment is dispersed in a component such as heat-meltable wax or binder, in this order (see Patent Document 1). In the image formation method using this image forming material, heat generated in a laser beam-irradiated region of the light-to-heat converting layer melts the image forming layer corresponding to the region to transfer an image onto an image receiving sheet arranged by lamination on the transfer sheet, thereby forming a transferred image on the image receiving sheet.

Further, Patent Document 2 discloses a heat transfer sheet comprising a support having provided thereon a light-to-heat converting layer containing a light-to-heat converting substance, a heat release layer having an extremely thin thickness (0.03 μm to 0.3 μm) and an image forming layer containing a colorant, in this order. In this heat transfer sheet, irradiation of a laser beam reduces the bonding force between the image forming layer and the light-to-heat converting layer bonded by intervention of the heat release layer to form a highly fine image on an image receiving sheet arranged by lamination on the transfer sheet. In the image formation method using the heat transfer sheet, so-called “ablation” is utilized. Specifically, the heat release layer is partly decomposed to vaporize in a region irradiated with the laser beam, which causes the bonding force between the image forming layer and the light-to-heat converting layer in that region to be weakened to transfer the image forming layer of that region onto the image receiving sheet laminated thereon.

These image forming methods have the advantages that stock paper provided with an image receiving layer (adhesive layer) as an image receiving sheet material can be used, and that a multicolor image can be easily obtained by transferring images different in color one after another onto an image receiving sheet. In particular, the image formation method utilizing ablation has the advantage that a highly fine image can be easily obtained, and is useful for preparing a color proof (DDCP: Direct Digital Color Proof) or a highly fine mask image.

In the progress of a DTP circumstance, the users of CTP (Computer To Plate) eliminate an intermediate film forming step and strongly request proofing by the DDCP system instead of proof printing or proofing by an analog system. Further, in recent years, a large-size DDCP system of high grade and high stability and excellent in coincidence in printing has been desired.

According to laser heat transfer systems, printing at high resolution is possible, and the systems include (1) a laser sublimation system, (2) a laser ablation system and (3) a laser melt system. However, all of the above respective systems have the problem that the recording halftone dot form is not sharp. The laser sublimation system of (1) has the problems that the approximation to printed matter is insufficient, because a dye is used as a colorant, and that the contour of a halftone dot is blurred, resulting in insufficient resolution, because the colorant is sublimated. On the other hand, the laser ablation system of (2) is good in the approximation to printed matter, because a pigment is used as a colorant, but has the problem that the contour of a halftone dot is blurred, resulting in insufficient resolution, similarly to the sublimation system, because the colorant is scattered. Further, the laser melt system of (3) also has the problem that no clear contour is obtained, because a melt flows.

Against these systems, a laser thin layer transfer system has recently proposed (see, for example, Patent Document 3) as means for making the contour of a halftone dot clear and achieving high resolution and high image quality of transferred image.

On the other hand, in the field of packaging, there is a need in which a white background is first transferred in order to hide a background of image receiving substance or to transfer on a transparent image receiving substance and then process colors are transferred thereon. Thus, an image forming material which is excellent in opacifying power, specifically, which has white color of high whiteness is required in addition to conventionally used four colors of yellow, magenta, cyan and black (so-called process colors).

As the white color image forming material capable of being utilized in the laser heat transfer, an image forming material containing white pigment, for example, titanium oxide is exemplified (see, for example, Patent Document 4).

In the case of using an infrared absorbing dye as the light-to-heat converting substance in the light-to-heat converting layer of heat transfer sheet, however, there is a problem that the infrared absorbing dye is decomposed at the time of laser beam irradiation and the decomposed material moves into an image forming layer to stain the image forming layer, whereby original hue of the image forming layer is changed.

In particular, when the image forming layer is white, the stain is noticeable.

Patent Document 1: JP-A-5-58045 (the term “JP-A” as used herein means an “unexamined published Japanese patent application”)

Patent Document 2: JP-A-6-219052

Patent Document 3: JP-A-2002-274051

Patent Document 4: JP-A-2001-353968

It is required for the transferred image formed by the above-described laser transfer system to have durability, particularly, strength against scratch. When the strength against scratch of the transferred image is low, lack of image is apt to occur and as a result, a problem arises in that defect of the transferred image occurs in case of transferring multicolor image or in that opacifying power is reduced in case of transferring an image intended to white background.

Under these circumstances, an object of the invention is to provide a heat transfer sheet, an image forming material and an image forming method exhibiting good transfer sensitivity and capable of forming an image having high resolution, white color excellent in the opacifying power and excellent durability.

Another object of the invention is to provide an image forming material and an image forming method capable of forming an image having good hue, high image quality, a stable transfer density and durability.

A still another object of the invention is to provide a multicolor image forming material which is prevented from change in hue of an image forming layer due to the decomposed material of infrared absorbing dye formed at the time of laser beam irradiation.

A still another object of the invention is to provide a multicolor image forming material which can provide a large-size DDCP having an extended range of reproducible hue and particularly, white color excellent in the opacifying power, and a multicolor image forming method using the same.

A still another object of the invention is to provide a multicolor image forming material which can provide a large-sized DDCP of high grade and high stability and excellent in coincidence in printing.

A still another object of the invention is to provide a multicolor image forming material which can form an image of good image quality and stable transfer density on an image receiving sheet even when the laser recording is conducted at high energy by multiple laser beams under different conditions of temperature and humidity.

A further object of the invention is to provide a heat transfer sheet for white image formation which has favorable white hue and opacifying power, provides white image of high image quality and exhibits high transfer sensitivity and high productivity.

### DISCLOSURE OF THE INVENTION

The above objects of the invention can be achieved by the following means.

1. A heat transfer sheet comprising a support, a light-to-heat converting layer and an image forming layer, wherein the image forming layer contains at least a white pigment and an amorphous organic polymer having a softening point of 40° C. to 150° C., an average particle size of the white pigment is from 0.01 μm to 0.32 μm, an amount of the white pigment is from 40% by weight to 90% by weight based on the total weight of the image forming layer, an amount of the amorphous organic polymer is from 10% by weight to 60% by weight based on the total weight of the image forming layer, and a thickness of the image forming layer is from 0.5 μm to 3.0 μm.

2. The heat transfer sheet as described in 1, wherein the white pigment is at least one white pigment selected from titanium oxide, aluminum oxide and silicon oxide.

3. The heat transfer sheet as described in 1 or 2, wherein the image-forming layer contains titanium oxide having an average particle size of from 0.15 μm to 0.32 μm.

4. The heat transfer sheet as described in any one of 1 to 3, wherein the light-to-heat converting layer contains at least a polyamideimide resin or a polyimide resin as a binder.

5. The heat transfer sheet as described in any one of 1 to 4, wherein the light-to-heat converting layer contains a cyanine dye as a light-to-heat converting agent.

6. The heat transfer sheet as described in any one of 1 to 5, wherein the image forming layer contains at least one of a blue pigment and a fluorescent brightening agent.

7. The heat transfer sheet as described in 6, wherein the blue pigment is at least one blue pigment selected from ultramarine blue and organic blue pigments.

8. The heat transfer sheet as described in any one of 1 to 7, wherein hue of the image-forming layer after image recording satisfies the following conditions when measured on a black backing:

L* is not less than 70,
a* is from −3.0 to 0 and
b* is from −6.0 to −3.0.
   9. The heat transfer sheet as described in any one of 1 to 8, wherein b* is from −6.0 to −3.0.
   10. The heat transfer sheet as described in any one of 1 to 9, wherein an opacifying ratio of the image forming layer is not less than 55%.
   11. The heat transfer sheet as described in any one of 1 to 10, wherein thickness of the image forming layer is from 0.5 μm to 1.8 μm.
   12. The heat transfer sheet as described in any one of 1 to 11, wherein absorbance (A) of the light-to-heat converting layer at an absorption wavelength of a laser beam used for image recording is from 1.0 to 2.0 and a ratio (A/X) of the absorbance (A) of the light-to-heat converting layer to thickness (X) (μm unit) of the light-to-heat converting layer is 2.5 to 3.2.
   13. The heat transfer sheet as described in any one of 1 to 12, which further comprises an intermediate layer between the light-to-heat converting layer and the image forming layer.
   14. The heat transfer sheet as claimed in claim 13, wherein the intermediate layer contains at least an ionomer resin or polyvinyl alcohol.
   15. The heat transfer sheet as described in any one of 1 to 14, wherein an extinction coefficient of the light-to-heat converting layer at a wavelength of an active ray is not more than 1.3.
   16. An image forming material which comprises an image receiving sheet having an image receiving layer and the heat transfer sheet as described in any one of 1 to 15, and is used by superposing the image forming layer on the image receiving layer of image receiving sheet so that the image forming layer faces the image receiving layer, irradiating the image forming layer with a laser beam, and transferring the irradiated area of the image forming layer onto the image receiving layer of image receiving sheet to perform image recording.
   17. An image forming method comprising preparing the image forming material as described in 16, superposing the image forming layer on the image receiving layer of image receiving sheet so that the image forming layer faces the image receiving layer, irradiating the image forming layer with a laser beam, and transferring the irradiated area of the image forming layer in the state of a thin film onto the image receiving layer of image receiving sheet.

### BRIEF DESCRIPTION OF THE DRAWINGS

FIG. 1 shows views for illustrating an outline of a mechanism of multicolor image formation by thin film heat transfer using a laser beam.

FIG. 2 is a schematic view showing a structural example of a recording device for laser heat transfer.

FIG. 3 is a schematic view showing a structural example of a heat transfer device.

FIG. 4 is a diagram showing a structural example of a system using a recording device for laser heat transfer, FINALPROOF.

### DESCRIPTION OF REFERENCE NUMERALS AND SIGNS

1: Recording devise
2: Recording head
3: Sub-scanning rail
4: Recording drum
5: Heat transfer sheet loading unit
6: Image receiving sheet roll
7: Conveying roller
8: Squeeze roller
9: Cutter
10: Heat transfer sheet
10K, 10C, 10M, 10Y, 10W: Heat transfer sheet roll
12: Support
14: Light-to-heat converting layer
16: Image forming layer
16′: Laser beam-irradiated region
20: Image forming sheet
22: Support for image forming sheet
24: Image receiving layer
30: Laminate
31: Discharge table
32: Discarding outlet
33: Discharge outlet
34: Air
35: Discharging box
42: Image receiving substance
43: Heat roller
44: Insertion table
45: Mark indicating loading position
46: Insertion roller
47: Guide made of heat-resistant sheet
48: Stripping claw
49: Guide plate
50: Discharge outlet

### BEST MODE FOR CARRYING OUT THE INVENTION

As a result of intensive investigations for the purpose of providing large-sized DDCPs of B2/A2 or more and further B1/A1 or more, which have high grade and high stability and are excellent in coincidence in printing, the inventors have developed a laser heat transfer recording system for DDCP comprising an image forming material of stock paper transfer, actual halftone dot output and pigment type having a B2 or more size, an output device and a high grade CMS soft.

The outlines of the characteristics of performances, the system constitution and the technical points of the laser heat transfer recording system developed by the inventors are as follows. The performances are characterized by (1) that the dot form is sharp, so that a halftone dot excellent in the approximation to printed matter can be reproduced, (2) that the hues are good in the approximation to printed matter, and (3) that the record quality is difficult to be influenced by environmental temperature and humidity, and the cyclic reproducibility is good, so that a stable proof can be prepared. The technical points of materials giving such characteristics of performances are the establishment of a thin film transfer process and improvements in vacuum adhesion retaining properties, following up to high resolution recording and heat resistance of the materials required for the laser heat transfer system. Specific examples thereof include (1) thinning of a light-to-heat converting layer by introduction of an infrared absorption dye, (2) enhancement of the heat resistance of the light-to-heat converting layer by introduction of a high Tg polymer, (3) intending to stabilize hues by introduction of a heat-resistant pigment, (4) control of adhesion and cohesion by addition of a low molecular weight component such as wax or an inorganic pigment and (5) imparting of vacuum adhesion without deterioration of image quality by addition of a matting agent to the light-to-heat converting layer. The technical points of the system include (1) air conveyance for continuous accumulation of a large number of sheets in a recoding device, (2) insertion on stock paper for reducing curls after transfer in a heat transfer device and (3) connection of a general-purpose output driver allowed to have system connection expansion. As described above, the laser heat transfer recording system developed by the inventors is constituted by a variety of characteristics of performances, system constitution and technical points. However, these are for the purpose of illustration and not of limitation.

The inventors have developed the system based on the idea that individual materials, respective coating layers, for example, a light-to-heat converting layer, an image forming layer and an image receiving layer, each heat transfer sheet and an image receiving sheet should be arranged organically and overall, not existing individually and loosely, and the image forming material exhibit the maximum performances in combination with a recording device and a heat transfer device. The inventors have examined closely the respective coating layers of the image forming material and the constituent materials, prepared the coating layers bringing out the maximum of features of these materials to form the image forming material, and found suitable ranges of various physical characteristics such that the image forming material exhibits the maximum performances. As a result, the relationships among the respective materials, the respective coating layers, the respective sheets and the physical characteristics have been studied thoroughly, and further, the image forming material has been allowed to act together with the recording device and the heat transfer device organically and overall, thereby being able to unexpectedly find the high-quality image forming material.

In connection with the system developed by the inventors, the present invention is positioned as an important invention to provide an image forming material suitable for the system, in particular, to provide a heat transfer sheet, an image forming material and an image forming method capable of forming an image having white color excellent in the opacifying power and durability.

More specifically, the inventors have found that by using the heat transfer sheet in which the amounts of white pigment and amorphous organic polymer included in the image forming layer, the average particle size of white pigment and the thickness of image forming layer are controlled in the specific ranges, respectively, an image having extremely high whiteness, sufficiently high opacifying power and excellent can be provided and that transfer sensitivity at the time of recording can also be remarkably increased to complete the invention. The heat transfer sheet of the invention is suitably used in combination with an image receiving sheet having an image receiving layer to form an image forming material and suitably used in a image forming method wherein an image forming layer is transferred in the state of a thin film onto an image receiving layer. It is also suitably used for a multicolor image forming material and image forming method in combination with other color heat transfer sheets. The heat transfer sheet, image forming material and image forming method according to the invention are suitably used in the-above-described system.

The invention will be described in more detail below.

First, a heat transfer sheet (heat transfer sheet W (white)) capable of providing a white color image, which has at least a light-to-heat converting layer and an image forming layer, wherein the image forming layer contains a white pigment and an amorphous organic polymer is described.

The white pigment incorporated into the image forming layer of the heat transfer sheet W has ordinarily an average particle size of from 0.01 μm to 0.32 μm, preferably from 0.15 μm to 0.32 μm, and particularly preferably from 0.27 μm to 0.31 μm. When the average particle size of white pigment exceeds 0.32 μm, whiteness of the transfer image obtained becomes poor (insufficient whiteness). In order to enhance the whiteness, it is necessary to increase thickness of the image forming layer, which is disadvantageous in view of transfer sensitivity. Also, coarse particles may also disturb adhesion between the image forming layer and the image receiving layer at the transfer and it also causes degradation of the transfer sensitivity. On the other hand, when the average particle size of white pigment is less than 0.01 μm, problems may occur in the dispersion of pigment, for example, increase in dispersion cost or occurrence of gelation of the dispersion solution.

An amount of the white pigment is ordinarily from 40% by weight to 90% by weight, preferably from 50% by weight to 80% by weight, based on the total weight of the image forming layer. When the amount of the white pigment is less than 40% by weight, whiteness of the transfer image obtained becomes poor. On the other hand, when the amount of the white pigment exceeds 90% by weight, the image forming layer per se becomes poor in view of heat melting property and difficult to transfer onto stock paper.

Examples of the white pigment include titanium oxide, aluminum oxide, silicon oxide, barium oxide, zinc oxide, calcium oxide and calcium sulfate. Two or more white pigments may be used as a mixture thereof. Particularly, titanium oxide, aluminum oxide and silicon oxide are preferred. Of the titanium oxides, a rutile type titanium oxide is preferably used.

An amount of the amorphous organic polymer incorporated into the image forming layer of the heat transfer sheet W is ordinarily from 10% by weight to 60% by weight, preferably from 20% by weight to 40% by weight, based on the total weight of the image forming layer. When the amount of the amorphous organic polymer is less than 10% by weight, transferability onto stock paper become poor. On the other hand, when the amount of the amorphous organic polymer exceeds 60% by weight, cutting of a film of the image forming layer becomes difficult and it is disadvantageous in view of resolution.

A softening point of the amorphous organic polymer is ordinarily from 40° C. to 150° C., preferably from 40° C. to 80° C. Examples of the polymer include butyral resins, polyamide resins, polyethyleneimine resins, sulfonamide resins, polyesterpolyol resins, petroleum resins, homopolymers or copolymers of styrene and derivatives thereof, for example, styrene, vinyltoluene, α-methylstyrene, 2-methylstyrene, chlorostyrene, vinyl-benzoic acid, sodium vinylbenzenesulfonate or aminostyrene, and homopolymers of vinyl monomers, for example, methacrylates, e.g., methyl methacrylate, ethyl methacrylate, butyl methacrylate or hydroxyethyl methacrylate, methacrylic acid, acrylates, for example, methyl acrylate, ethyl acrylate, butyl acrylate or α-ethylhexyl acrylate, acrylic acid, dienes, e.g., butadiene or isoprene, acrylonitrile, vinyl ethers, maleic acid, maleates, maleic anhydride, cinnamic acid, vinyl chloride or vinyl acetate, and copolymers thereof with other monomers. The polymers may also be used as a mixture of two or more of thereof. Among them, butyral resins and styrene resins are preferred, and polyvinyl butyral is particularly preferred.

Into the image forming layer of the heat transfer sheet W, components other than the white pigment and amorphous organic polymer may be incorporated, if desired. Other components to be incorporated are described hereinafter.

A thickness of the image forming layer is ordinarily from 0.5 μm to 3.0 μm, preferably from 0.5 μm to 1.8 μm. When the thickness of the image forming layer is less than 0.5 μm, transfer unevenness may occur. On the other hand, when the thickness of the image forming layer exceeds 3.0 μm, transfer sensitivity tends to decrease, resulting in degradation of resolution.

Specific construction of the light-to-heat converting layer of the heat transfer sheet W is described hereinafter.

It is preferred in the heat transfer sheet W that an intermediate layer is provided between the light-to-heat converting layer and the image forming layer. The intermediate layer is a layer having a function for trapping, that is, capturing a light-to-heat converting substance, for example, a dye or a decomposed compound thereof in the light-to-heat converting layer at the time of image recording to prevent or control migration of such compounds into the image forming layer. Therefore, the trap layer is preferably a layer compatible with a decomposed compound of an infrared absorbing dye and the light-to-heat converting layer. A binder for the trap layer is preferably an ionomer resin or a water-soluble resin. Also, a resin having a solubility parameter (SP value) of not less than 23 is preferred.

The intermediate layer acting as the trap layer can be provided not only in the heat transfer sheet W but also in heat transfer sheets for other colors.

The ionomer resin is a polymer containing ethylene as the main component and includes mordanting resins having a carboxylate, sulfonate, phosphate, quaternary ammonium salt or the like in the side chain thereof. Specific examples of the ionomer resin include Chemipearl S-100 and S-200 (manufactured by Mitsui Chemicals, Inc.).

As the water-soluble resin, PVP (polyvinyl pyrrolidone), PVA (polyvinyl alcohol), a gelatin, a water-soluble nylon, a cellulose, a modified cellulose or the like is preferred, and PVA is particularly preferred.

The resins may be used in combination of two or more thereof.

A thickness of the trap layer is preferably from 0.03 μm to 0.5 μm, more preferably from 0.03 μm to 0.1 μm.

The light-to-heat converting layer of the heat transfer sheet W has preferably an extinction coefficient at a wavelength of an active ray of not more than 1.3, more preferably not more than 1.0. The extinction coefficient not more than 1.3 is preferred because coloration due to transfer of the heat-decomposed compound of light-to-heat converting substance, for example, an infrared absorbing dye can be reduced. For the reason above, it is preferred that the extinction coefficient becomes smaller. However, when the extinction coefficient is too small, there is a possibility that the sensitivity decreases and thus, the lower limit is 0.5.

The term “wavelength of an active ray” means a peak wavelength of a laser beam used at the image formation on the heat transfer sheet W. The peak wavelength of a laser beam used includes, for example, 808 nm or 830 nm.

According to the invention, full-color image formation can be conducted using heat transfer sheets for process colors, for example, yellow, magenta, cyan and black, and further, if desired, special color, for example, red or blue, in addition to the heat transfer sheet W. Such heat transfer sheets for other colors than white can be obtained by using a pigment corresponding to the desired color in the image forming layer.

The multicolor image forming material of the invention comprises at least two kinds of heat transfer sheets having image forming layer s for colors different from each other (one kind being white) and an image receiving layer. The heat transfer sheets having image forming layers for colors different from each other are preferably four kinds or more, more preferably five kinds or more. When four kinds of heat transfer sheets are used, their colors are yellow (Y), magenta (M), cyan (C) and white (W), and when five kinds of heat transfer sheets are used, black (K) is added to the above-described colors.

The heat transfer sheets may further include those for other colors that are not expressed by the combination of the process colors, for example, green (G), orange (O), red (R), blue (B), gold (Go), silver (S) and pink (P).

According to the invention, at least one of the heat transfer sheets is a heat transfer sheet for white color (hereinafter also referred to as a “heat transfer sheet W”) The heat transfer sheet W is characterized by containing a white pigment as the main component and at least one of a blue pigment and/or fluorescent brightening agent in the image forming layer thereof.

By incorporating a blue pigment into the image forming layer of the heat transfer sheet W according to the invention, yellow-like color caused by the heat-decomposed compound of an infrared absorbing dye migrated to the image forming layer at the laser irradiation can be rendered to sickly gray hue or white according to the blue pigment that is in a relation of complementary color with yellow and thus, the change of white color in the image forming layer can be restrained.

The blue pigment is preferably used in an amount of from 0.001 part by weight to 0.03 parts by weight, more preferably from 0.01 part by weight to 0.02 parts by weight, based on 100 parts by weight of the white pigment.

The image forming layer of the heat transfer sheet W preferably has a reflection optical density (reflection OD) of not more than 0.6, more preferably not more than 0.4, when measured a solid portion of recorded image on the image forming layer using a visual filter. The reflection OD is determined by measuring a solid portion of recorded image on a transparent image receiving substance on a black backing and is measured using X-rite 938. As the reflection OD is small, white is thicker, that is, opacifying power is higher, so that undesired colors are hardly seen through the image formed on the receiving substance and only the image heat-transferred can be seen clearly.

Examples of the white pigment incorporated into the image forming layer of the heat transfer sheet W include rutile type or anatase type titanium oxide, calcium carbonate and calcium sulfate. Among them, rutile type titanium oxide is preferred.

The incorporation of a fluorescent brightening agent into the image forming layer of the heat transfer sheet W raises reflectance on a shorter wavelength side of a spectral absorption curve of white, thereby coming close to proper white.

The fluorescent brightening agent is preferably used in an amount of from 0.1 part by weight to 7 parts by weight, more preferably from 0.5 part by weight to 3 parts by weight, based on 100 parts by weight of the white pigment.

A thickness of the image forming layer of the heat transfer sheet for at least one color used in the multicolor image forming material of the invention, particularly, a thickness of the image forming layer for white color is preferably not more than 3.0 μm, more preferably not more than 1.8 μm.

With respect to the hue of the image forming layer after image recording, L* a* b* denotes a CIELAB color space defined by CIE. L* represents lightness, a* and b* each represent hue. In the case of white, it can be said that as L* is larger and a* and b* are closer to 0, the degree of white is higher. In the case of actually using white ink, however, it is rather preferred that b* is low so that white appears somewhat bluish. In this case, b* takes a negative value. The measurement of L* a* b* was carried out on a black backing under the condition of D50² by X-rite 938 (manufactured by X-rite Inc.). The measurement on a black backing indicates that the color measurement is carried out by placing a sample to be measured on a black object.

According to the method, since measurement of reflection of light transmitted the sample is prevented, surface color of the sample can be precisely measured. As the black backing, CCS-2 Color Standard Plate 4 Batch B (manufactured by Murakami Color Research Laboratory Co., Ltd.) was used in the invention, but the black backing is not limited thereto.

With respect to the hue of image forming layer (white) when measured on a black backing, L* is preferably not less than 70, more preferably not less than 72. a* is preferably from −3 to 0, more preferably from −2.0 to −0.5. b* is preferably from −8.0 to −1.0, more preferably from −6.0 to −3.0. An opacifying ratio of the image forming layer is preferably not less than 55%, more preferably not less than 58%. The term “opacifying ratio” as used herein means a value as defined in the example described hereinafter. Thickness of the image forming layer is preferably from 0.5 μm to 1.8 μm, more preferably from 1.3 μm to 1.7 μm. Out of the ranges, a problem on the quality of white image may undesirably arise.

The pigment is in general classified roughly into organic pigment and inorganic pigment. As the white pigment, inorganic pigment can be used. Rutile type titanium oxide having a weight average particle size of from 0.15 μm to 0.32 m is preferably used and rutile type titanium oxide having a weight average particle size of from 0.27 μm to 0.31 μm is more preferred. When the weight average particle size of titanium oxide is larger or smaller than the above range, it is necessary to increase thickness of the image forming layer in order to achieve the desired opacifying power, resulting in decrease in transfer sensitivity and degradation of image quality.

The fluorescent brightening agent used in the image forming layer absorbs ultraviolet ray and generates fluorescence of violet blue to blue green color in a short wavelength part (400 nm to 450 nm) of visible range so that yellowish tone of the image forming layer is counteracted to increase whiteness. Specific examples of the fluorescent brightening agent include fluorescent pigment containing an oxide, sulfide, silicate, phosphate or tungstate of atom, for example, Ca, Ba, Mg, Zn or Cd as the main component and including an activator, for example, Mn, Ag, Cu, Sb or Pb in an amount of from 1% to 0,01%, and an organic substance, for example, a benzoxazole, stilbene, imidazole or naphthalimide compound. Among them, the benzoxazole compound is preferably used and bisbenzoxazolethiophene is more preferred.

Now, the image forming material comprising the heat transfer sheet including heat transfer sheets for other colors and the image receiving sheet and the image forming method are described with reference to an overall picture of the system developed by the inventors.

In the image forming material of the invention, the image forming layer of the heat transfer sheet and the image receiving layer of the image receiving sheet each preferably have a contact angle to water of from 7.0 degrees to 120.0 degrees. By adjusting the contact angle of each of the image forming layer and the image receiving layer in the above-described range, compatibility between the image forming layer and the image receiving layer is improved, the transfer sensitivity is increased and temperature and humidity dependency of transfer can be decreased.

In the invention, the contact angles of the respective layer surfaces to water are values measured using a contact angle meter of CA-A type (manufactured by Kyowa Kaimen Kagaku Co., Ltd.).

A ratio (OD_{LH}/T_{LH}) of the optical density (OD_{LH}) of the light-to-heat converting layer of the heat transfer sheet to the thickness (T_{LH}) (in μm) thereof is preferably not less than 4.36. The upper limit of the ratio (OD_{LH}/T_{LH}) is not particularly restricted and the lager, the more preferred. However, it is approximately 10 under the present situation.

The optical density (OD_{LH}) of the light-to-heat converting layer of the heat transfer sheet means absorbance of the light-to-heat converting layer at a peak wavelength of a laser beam used at the image formation using the image forming material of the invention and it can be measured by a known spectrophotometer. In the invention, a UV spectrophotometer (UV-240, manufactured by Shimadzu Corp.) Was used for the measurement. In the measurement, the light-to-heat converting layer provided on a support is measured to obtain an optical density and a value obtained by subtracting absorbance of the support alone from the absorbance of the light-to-heat converting layer and the support.

It is preferred to adjust the ratio (OD_{LH}/T_{LH}) within the above-described range because heat conductance from the light-to-heat converting layer to the image forming layer at the laser irradiation of transfer is enhanced, thus, the transfer sensitivity of the image forming layer to a receiving material is increased and temperature and humidity dependency of transfer can be decreased. Specifically, since the transfer sensitivity is increased by increasing the ratio (OD_{LH}/T_{LH}), a large-size transferred image preferably having resolution of 2,400 dpi or more, more preferably 2,600 dpi or more can be formed.

Thickness of the light-to-heat converting layer is preferably from 0.03 μm to 1.0 μm, more preferably from 0.05 μm to 0.5 μm.

With respect to the image forming layer of the heat transfer sheet other than the heat transfer sheet W, a ratio (OD_{I}/T_{I}) of the optical density (OD_{I}) of the image forming layer to the thickness (T_{I}) (in μm) thereof is preferably not less than 1.6, more preferably not less than 1.8, and particularly preferably not less than 2.50. The upper limit of the ratio (OD_{I}/T_{I}) is not particularly restricted and the lager, the more preferred. However, it is approximately 6 under the present situation.

By adjusting the ratio (OD_{I}/T_{I}) within the above-described range, an image having high transfer density and good resolution can be obtained. Further, by reducing the thickness of the image forming layer, color reproducibility can be improved.

The OD_{I} means reflective optical density obtained by measuring an image formed on art paper as stock paper by further transferring the image transferred onto an image receiving sheet by a densitometer (for example, X-rite 938, manufactured by X-rite Inc.) in each color mode, for example, yellow (Y), magenta (M), cyan (C) or black (K). Specifically, it means the maximum value, when the density is measured through a red filter (filter for cyan), a blue filter (filter for yellow), a green filter (filter for magenta) or the like.

The OD_{I} is preferably from 0.5 to 3.0, more preferably from 0.8 to 2.0.

With respect to the image forming layer of the heat transfer sheet W for white color, the optical density thereof is preferably from 0.1 to 0.4, more preferably from 0.25 to 0.35.

According to the invention, by controlling physical properties (for example, the contact angle, optical density or thickness) of the heat transfer sheet and image receiving sheet, the transfer sensitivity and resolution are improved and an image having a large size can be formed. The recording area of image is preferably a size of 515 mm or more×728 mm or more, more preferably 594 mm or more×841 mm or more.

Thus, the image receiving sheet preferably has a size of 465 mm or more×686 mm or more.

The entire system developed by the inventors including the contents of the present invention will be described below.

In the system, the thin film heat transfer system has been invented and employed, thereby achieving high resolution and high image quality of a transferred image. The system can provide a transferred image of 2,400 dpi or more, preferably 2,600 dpi or more. The thin film heat transfer system is a system of transferring the image forming layer having a thickness of approximately from 0.01 μm to 2.0 μm, in the state partly not melted or little melted, to the image receiving sheet. Specifically, a recorded portion is transferred as a thin film, so that extremely high resolution is obtained in the heat transfer system. According to a preferred method for efficiently conducting thin film heat transfer, the inside of the light-to-heat converting layer is deformed into a dome shape by optical recording to push up the image forming layer, which causes the adhesion between the image forming layer and the image receiving layer to be enhanced, thereby making it easy to transfer the image forming layer. When such deformation is large, the transfer becomes easy because a force to press the image forming layer onto the image receiving layer is large. On the other hand, when the deformation is small, some portions are not sufficiently transferred because a force to press the image forming layer onto the image receiving layer is small. The deformation preferred for the thin film transfer can be observed by a laser microscope (VK8500, manufactured by Keyence Corp.). The dimensions of the deformation can be evaluated by a deformation rate calculated by adding the sectional area (a) of a recorded portion of the light-to-heat converting layer increased after optical recording to the sectional area (b) of the recorded portion of the light-to-heat converting layer before optical recording, dividing the sum total by the sectional area (b) of the recorded portion of the light-to-heat converting layer before optical recording, and multiplying the resulting value by 100. Specifically, the deformation rate is expressed by {((a)+(b))(b)}×100. The deformation rate is ordinarily 110% or more, preferably 125% or more, and more preferably 150% or more. When the breaking elongation is increased, the deformation rate may be more than 250%. However, it is ordinarily preferred that the deformation rate is kept below about 250%.

The technical points of the image forming material in the thin film transfer are as follows.

1. Compatibility of High Temperature Responsibility and Preservability

For achieving high image quality, the transfer of a thin film of the submicronicorder is necessary, whereas for obtaining desired density, it is required to form a layer in which a pigment is dispersed at high concentration. This conflicts with heat responsibility. The heat responsibility also conflicts with preservability (adhesion). The conflicting relations have been solved by development of a novel polymer additive.

2. Securing of High Vacuum Adhesion

In the thin film transfer pursuing high resolution, a smoother transfer interface is better, but does not provide sufficient vacuum adhesion. Not bound by usual common sense of imparting vacuum adhesion, a matte agent having a relatively small particle size is introduced into a lower layer of the image forming layer s in a somewhat larger quantity, thereby keeping uniform a proper gap between the heat transfer sheet and the image receiving sheet, which has imparted vacuum adhesion while securing the characteristics of the thin film transfer without development of a blank area in an image caused by the matte agent.

3. Use of Heat-Resistant Organic Material

The light-to-heat converting layer for converting laser light to heat in laser recording reaches a temperature as high as about 700° C., and the image forming layer containing the colorant reaches a temperature as high as about 500° C. A modified resin applicable as an organic solvent has been developed as the material for the light-to-heat converting layer, and a pigment higher in heat resistance than a printing pigment, safety and matching in hues has been developed as the pigment colorant.

4. Securing of Surface Cleanness

In the thin film transfer, dust between the heat transfer sheet and the image receiving sheet causes an image defect, which poses an important problem. The dust enters from the outside of an instrument, or is produced in cutting the material, so that it is insufficient to prevent the dust only by the control of the material. Accordingly, it is necessary to equip the instrument with a dust removing mechanism. However, a material which can maintain suitable stickiness for cleaning a surface of the transfer material has been discovered, and the removal of the dust has been realized without a reduction in productivity by changing a material of a conveying roller.

The invention is preferred because it can realize the formation of a large-sized heat transfer image with sharp halftone dots and perform transfer to stock paper.

The features of the system developed by the inventors are described below.

One of the features of the performances of the system developed by the inventors is that a sharp dot form is obtained. The heat-transferred image obtained by the system has resolution of 2,400 dpi or more, and can be a half tone dot image corresponding to the number of print lines. Each halftone dot is scarcely blurred or broken, and the form thereof is sharp, so that halftone dots in the wide range from a highlight to a shadow can be clearly formed. As a result, the output of high-quality halftone dots at the same resolution as with an image setter or a CTP setter and high grade is possible, and halftone dots and gradation good in the approximation to printed matter can be reproduced.

The second of the features of the performances of the system of the invention is that the repeating reproducibility is good. This heat-transferred image can faithfully reproduce a halftone dot corresponding to a laser beam because of its sharp halftone dot form. Further, the environmental temperature and humidity dependency of recording characteristics is very low, so that the stable repeating reproducibility can be obtained for both hues and density under conditions of temperature and humidity over a wide range.

Further, the third of the features of the performances of the system of the invention is that the color reproduction is good. The heat-transferred image obtained by the system is formed using a coloring pigment for use in printing ink, and good in repeating reproducibility. Accordingly, a high-accuracy CMS (color management system) can be realized.

The heat-transferred image can be allowed to approximately agree in hues with Japan color and SWOP color, that is, hues with printed matter, and can show changes similar to those of printed matter, also with respect to how to look in color at the time when a light source is changed to a fluorescent lamp or a incandescent lamp.

Further, the use of the heat transfer sheet W according to the invention makes it possible to obtain white color of high whiteness and high opacifying power.

The fourth of the features of the performances of the system of the invention is that the character quality is good. The heat-transferred image obtained by the system is sharp in the dot form, so that a narrow line of a fine character can be sharply reproduced.

The features of material techniques of the system of the invention will be further described in detail below.

The heat transfer system for DDCP includes (1) a sublimation system, (2) an ablation system and (3) a melt system. In the systems of (1) and (2), a coloring material is sublimated or scattered, so that an outline of a halftone dot is blurred. On the other hand, also in the system of (3), a melt flows, so that a clear contour is not obtained. In order to solve new problems in the laser heat transfer system and to obtain high image quality, the inventors have incorporated techniques described below into the thin film transfer technique.

The first of the features of the material techniques is to sharpen the dot form. Laser light is converted to heat by the light-to-heat converting layer, the heat is transmitted to the adjacent image forming layer, and the image forming layer is brought into contact with an image receiving layer, thereby making an image recording. For sharpening the dot form, the heat generated by the laser light is transmitted to a transfer interface without diffusion in a plane direction, and the image forming layer is sharply broken at a boundary of the heated area and the unheated area. Consequently, thickness of the light-to-heat converting layer and mechanical properties of the image forming layer in the heat transfer sheet are controlled.

Technique 1 for sharpening the dot form is to make the light-to-heat converting layer thinner. According to the simulation, the light-to-heat converting layer is presumed to reach about 700° C. momentarily. When the layer is thin, deformation and destruction of the layer are liable to occur. When the deformation and destruction occur, the damage arises in that the light-to-heat converting layer is transferred to the image sheet together with the image forming layer, or in that a transferred image becomes non-uniform. On the other hand, for obtaining a specified temperature, a light-heat conversion substance is required to be incorporated into the layer at a high concentration, which also causes a problem of deposition of a dye or migration thereof to the adjacent layer. As the light-heat conversion substance, carbon has hitherto been used in many cases. However, in the material of the invention, an infrared absorbing dye is used which can be used in an amount smaller in comparison with the carbon. As a binder, a resin having a sufficient mechanical strength and good carrying properties for the infrared absorbing dye is introduced.

Thus, it is preferred that the light-to-heat converting layer is thinned to about 1.0 μm or less by selecting the infrared absorbing dye excellent in a light-heat conversion property and the heat-resistant binder, for example, a polyamideimide resin or a polyimide resin.

In particular, by using an infrared absorbing dye and a polyamideimide compound in combination in the light-to-heat converting layer, preservation stability of a coating solution for the light-to-heat converting layer becomes good, resulting in prevention of decrease in absorbance with the lapse of time. Further, the absorbance of the light-to-heat converting layer increases and thus, the sensitivity increases. In addition, change in hue after the irradiation is small and light-fastness is improved.

Technique 2 for sharpening the dot form is improvement in characteristics of the image forming layer. When the light-to-heat converting layer is deformed or the image forming layer itself is deformed due to intense heat, thickness unevenness corresponding to a sub-scanning pattern of a laser beam is generated in the image forming layer transferred to the image receiving layer, resulting in a non-uniform image to reduce the apparent transfer density. Such tendency is significant with a decrease in the thickness of the image forming layer. On the other hand, when the image forming layer is thick, the dot sharpness is impaired, and the sensitivity is decreased.

For allowing these conflicting performances to be compatible with each other, it is preferred that a low melting point substance, for example, wax is added to the image forming layer, thereby improving the transfer unevenness. Further, fine inorganic particles are added in place of the binder to properly increase the layer thickness, which causes the image forming layer to be sharply broken at the boundary of the heated area and the unheated area. Thus, the transfer unevenness can be improved while keeping the dot sharpness and sensitivity.

In general, the low melting point substance, for example, wax tends to ooze out on a surface of the image forming layer or to crystallize, which poses a problem with regard to the image quality or preservation stability of the heat transfer sheet in some cases.

In response to the problem, the use of the low melting point substance small in the SP value difference from the polymer of the image forming layer is preferred. Improvement in compatibility with the polymer can prevent separation of the low melting point substance from the image forming layer. It is also preferred that several kinds of low melting point substances different in structure are mixed to form a eutectic mixture, thereby preventing crystallization. As a result, the image having the sharp dot form and little unevenness is obtained.

The second of the features of the material techniques is that the existence of the temperature and humidity dependency in transfer sensitivity has been found and the problem has been improved. In general, moisture absorption of a coating layer of the heat transfer sheet changes mechanical properties and thermal properties of the layer, resulting in the occurrence of humidity dependency of recording environment.

For decreasing the temperature and humidity dependency, the dye/binder system of the light-to-heat converting layer and the binder system of the image forming layer are preferably converted to organic solvent systems. Further, it is preferred that polyvinyl butyral is selected as the binder for the image receiving layer, and a technique for making the polymer hydrophobic is introduced for reducing its moisture absorbing property. The techniques for making the polymer hydrophobic include a reaction of a hydroxy group with a hydrophobic group and crosslinking of two or more hydroxy groups with a hardening agent, as described in JP-A-8-238858.

The third of the features of the material techniques is that the hue approximation to printed matter is improved. In addition to color matching of a pigment in a thermal head type color proof (for example, First Proof® manufactured by Fuji Photo Film Co., Ltd.) and a stable dispersion technique, the following problems newly encountered in the laser heat transfer system have been solved.

Specifically, technique 1 for improving the hue approximation to printed matter is the use of a high heat-resistant pigment. Usually, at the printing by laser exposure, heat of about 500° C. or more is also applied to the image forming layer, and some conventionally used pigments are decomposed by the heat. However, this can be prevented by the adoption of the high heat-resistant pigment in the image forming layer.

Technique 2 for improving the hue approximation to printed matter is diffusion prevention of the infrared absorbing dye. For preventing changes in hues at the time when the infrared absorbing dye moves from the light-to-heat converting layer to the image forming layer by the intense heat, it is preferred that the light-to-heat converting layer is designed as a combination of the infrared absorbing dye/binder having strong carrying properties as described above.

The fourth of the features of the material techniques is increase in sensitivity. In general, energy becomes insufficient in high-speed printing, and a gap corresponding to the interval of laser sub-scanning is generated. As described above, the increase in the dye concentration of the light-to-heat converting layer and the reduction of thickness of the light-to-heat converting layer and the image forming layer can increase the efficiency of generation/transfer of heat. Further, for the purpose of achieving an effect of filling the gap by a slight flow of the image forming layer at the heating and improving the adhesion with the image receiving layer, the low melting point substance is preferably added to the image forming layer. Furthermore, for improving the adhesion between the image forming layer and the image receiving layer and imparting sufficient strength to the transferred image, it is preferred that, for example, the polyvinyl butyral used in the image forming layer is employed as a binder for the image receiving layer.

The fifth of the features of the material techniques is improvement in vacuum adhesion. The image receiving sheet and the heat transfer sheet are preferably held on a drum by vacuum adhesion. The vacuum adhesion is important, because the image is formed by adhesion control of both sheets, so that the behavior of image transfer is very sensitive to a clearance between the image receiving layer of the image receiving sheet and the image forming layer of the transfer sheet. When the clearance between the materials is widened with foreign matter, for example, dust, image defect or image transfer unevenness occurs.

For preventing such image defect or image transfer unevenness, it is preferred that uniform unevenness is formed on the heat transfer sheet, thereby making air passage well to obtain a uniform clearance.

Technique 1 for improving the vacuum adhesion is formation of unevenness on a surface of the heat transfer sheet. The unevenness is formed on the heat transfer sheet so that an effect of the vacuum adhesion is sufficiently achieved even in overprinting of two or more colors. Methods for imparting unevenness to the heat transfer sheet generally include after-treatment, for example, emboss treatment and addition of a matting agent to a coating layer. However, the addition of the matting agent is preferred in terms of simplification of the manufacturing process and the preservation stability of the material. The matting agent is required to have a size larger than the thickness of a coating film, and addition of the matting agent to the image forming layer causes the problem that an image is broken at a portion where the matting agent exists. It is therefore preferred that the matting agent having the optimum size is added to the light-to-heat converting layer, thereby resulting in the approximately uniform thickness of the image forming layer itself. Thus, an image having no defect can be obtained on the image receiving sheet.

Next, the features of systematization techniques of the system of the invention will be described. Feature 1 of the systematization techniques is constitution of the recording device. For surely reproducing the sharp dots as described above, high-accuracy design is required on the recording device side. The basic constitution is the same as with a conventional laser heat transfer recording device. The constitution is a so-called heat mode outer drum recording system in which recording is made by irradiating the heat transfer sheet and the image receiving sheet fixed on a drum with a recording head having a plurality of high-power lasers. The following embodiments are preferred among others.

Constitution 1 of the recording device is to avoid contamination with dust. The image receiving sheet and the heat transfer sheet are supplied by a full automatic roll supply system. In the case of sheet supply in which a small number of sheets are supplied, the sheets are contaminated by a large amount of dust generated from the human body. Accordingly, roll supply has been employed.

In the case of the formation of multicolor image, one roll of the heat transfer sheet for each of colors is necessary, so that the roll of each color is turned over by rotation of a loading unit. Each sheet is cut to a specified length with a cutter during loading, and then, fixed to a drum.

Constitution 2 of the recording device is to strengthen the adhesion between the image receiving sheet and the heat transfer sheet on a recording drum. The image receiving sheet and the heat transfer sheet are fixed on the recording drum by vacuum adhesion. Mechanical fixing cannot strengthen the adhesion between the image receiving sheet and the heat transfer sheet, so that vacuum adhesion has been employed. A large number of vacuum adhesion holes are formed on the recording drum, and the inside of the drum is evacuated with a blower or a pressure reducing pump, thereby adhering the sheets by suction to the drum. The heat transfer sheet is further adhered by suction onto the image receiving sheet adhered by suction to the drum, so that the size of the heat transfer sheet is designed to be larger than that of the image receiving sheet. Air between the heat transfer sheet and the image receiving sheet, which exerts the greatest influence on the recording performance, is sucked from an area of only the heat transfer sheet outside the image receiving sheet.

Constitution 3 of the recording device is to stably accumulate the plural sheets on a discharge table. In the device, it is preferred that many sheets having a large area larger than B2 can be accumulated one over the other on the discharge table. When a subsequent sheet B is discharged on a heat-adhesive sheet A already accumulated, both may be adhered to each other. In such a case, the next sheet is not discharged in good order to cause jamming. For preventing the adhesion, it is best to prevent the sheets A and B from coming into contact with each other. As means for preventing the contact, there are known some methods including (a) a method of forming a difference in level on the discharge table to make a sheet form uneven, thereby forming a clearance between the sheets, (b) a method of arranging a discharge outlet at a position higher than the discharge table, and dropping a discharged sheet downward, and (c) a method of blowing air between both sheets to float the sheet subsequently discharged. In such a system, since sheets having a very large size as large as B2 are also used, the methods of (a) and (b) require a very large construction. Therefore, the air blowing method of (c) is preferably employed. Specifically, the method of blowing air between both sheets to float the sheet subsequently discharged is preferably employed.

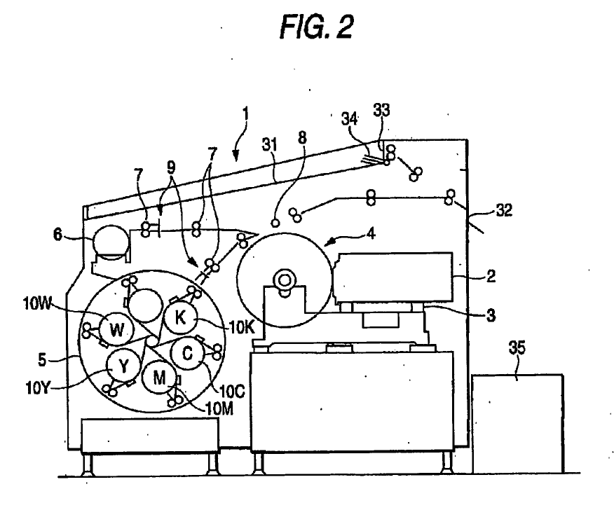

A structural example of the recording device having the above-described features is shown in FIG. 2.

A sequence of applying the image forming material of the invention to the device to form a full color image (hereinafter referred to as an image formation sequence of the system) will be illustrated.

1) A sub-scanning shaft of a recording head 2 of the recording device 1 returns to a starting position by means of sub-scanning rails 3, and a main scanning rotating shaft of a recording drum 4 and a heat transfer sheet loading unit 5 return to starting positions.

2) A image receiving sheet is unwound from a image receiving sheet roll 6 with a conveying roller 7, and a leading edge of the image receiving sheet is fixed by vacuum suction onto the recording drum 4 through suction holes formed on the recording drum.

3) A squeeze roller 8 comes down on the recording drum 4, and presses the image receiving sheet to the recording drum. The image receiving sheet is further conveyed by a specified amount by rotation of the drum while pressing the sheet, then stopped, and cut to a specified length with a cutter 9.

4) The recording drum 4 further makes one revolution to terminate loading of the image receiving sheet.

5) Then, a heat transfer sheet of the first color, for example, a heat transfer sheet of black (K), is unwound from a heat transfer sheet roll 10K by the same sequence as with the image receiving sheet, cut and loaded.

6) Then, the recording drum 4 starts to rotate at high speed, and the recording head 2 on the sub-scanning rails 3 starts to move. When the recording head arrives at a recording start position, a recording laser beam is irradiated on the recording drum 4 by the recording head 2 according to a recording signal. The irradiation is terminated at a recording termination position, and the operation of the sub-scanning rails and the rotation of the drum are stopped. The recording head on the sub-scanning rails is returned to the starting position.

7) Only the heat transfer sheet K is peeled off while leaving the image receiving sheet on the recording drum. For that purpose, the leading edge of the heat transfer sheet K is hooked with a claw, followed by pulling out in a discharge direction. Then, the heat transfer sheet K is discarded to a discarding box 35 through a discarding outlet 32.

8) 5) to 7) are repeated for each heat transfer sheet of the desired colors. Recording is made in the order, for example, of cyan, magenta, yellow, white (further blue, orange) subsequent to black. Specifically, a heat transfer sheet C of the second color, cyan, a heat transfer sheet M of the third color, magenta, a heat transfer sheet Y of the fourth color, yellow and a heat transfer sheet W of the fifth color, white, are in turn unwound from a heat transfer sheet roll 10C, a heat transfer sheet roll 10M, a heat transfer sheet roll 10Y, and a heat transfer sheet roll 10W, respectively. Although the order is the reverse of the ordinarily printing order, this is because the color order on an image receiving substance, for example, a transparent image receiving substance or stock paper is reversed by transfer in the subsequent process.

9) After the above-described operation is completed, the recorded image receiving sheet is finally discharged to a discharge table 31. A method for peeling off the image receiving sheet from the drum is the same as with the heat transfer sheet described in 7). However, the image receiving sheet is not discarded, different from the heat transfer sheet, so that it is returned to the discharge table by switch back at the time when it has proceeded to the discarding outlet 32. When the image receiving sheet is discharged to the discharge table, air 34 is blown from under the discharge outlet 33 to make it possible to accumulate the plural sheets.

In the above-described recording device, as the conveying roller 7 of either of a supply site or a conveying site of the heat transfer sheet roll and the image receiving sheet roll, there is preferably used an adhesive roller on a surface of which an adhesive material is disposed. The use of the adhesive roller allows cleaning of surfaces of the heat transfer sheet and the image receiving sheet.

The adhesive material disposed on the surface of the adhesive roller includes an ethylene-vinyl acetate copolymer, an ethylene-ethyl acrylate copolymer, a polyolefin resin, a polybutadiene resin, a styrene-butadiene copolymer (SBR), a styrene-ethylene-butene-styrene copolymer (SEBS), an acrylonitrile-butadiene copolymer (NBR), a polyisoprene resin (IR), a styrene-isoprene copolymer (SIS), an acrylic ester copolymer, a polyester resin, a polyurethane resin, an acrylic resin, butyl rubber and polynorbornene.

The adhesive roller comes into contact with the surfaces of the heat transfer sheet and the image receiving sheet to clean the surfaces thereof. There is no particular limitation on the contact pressure, as long as the adhesive roller is in contact with the surfaces thereof.

It is preferred that the adhesive material used in the adhesive roller has a Vickers hardness Hv of 50 kg/mm² (approximately equal to 490 MPa) or less, because dust which is foreign matter is sufficiently removed, and an image defect can be inhibited. The term “Vickers hardness” means hardness measured by applying a static load onto a pyramid diamond indenter having an angle between the opposite faces of 136 degrees, and Vickers hardness Hv is determined from the following equation:
Hv=1.854 P/d² (kg/mm²)=approximately 18.1692 P/d² (MPa)
wherein P represents weight of a load (Kg) and d represents length of a diagonal line of a square of a hollow.

Further, in the invention, it is preferred that the adhesive material used in the adhesive roller has an elastic coefficient at 20° C. of 200 kg/mm² (approximately equal to 19.6 MPa) or less, because dust which is foreign matter is sufficiently removed, and an image defect can be inhibited, similarly to the above.

Feature 2 of the systematization techniques is constitution of the heat transfer device.

For performing a step of transferring the image sheet on which the image is printed with the recording device to an image receiving substance, for example, a plastic film or a printing stock paper (referred to as “stock paper”), a heat transfer device is used. This process is entirely same as that of First Proof®. When the image receiving sheet is overlaid with the image receiving substance and heat and pressure are applied thereto, both are adhered to each other. Then, when the image receiving sheet is peeled off from the image receiving substance, only the image and the adhesive layer remain on the stock paper, and a support of the image receiving sheet and a cushion layer are separated. Accordingly, the image is practically transferred from the image receiving sheet to the image receiving substance.

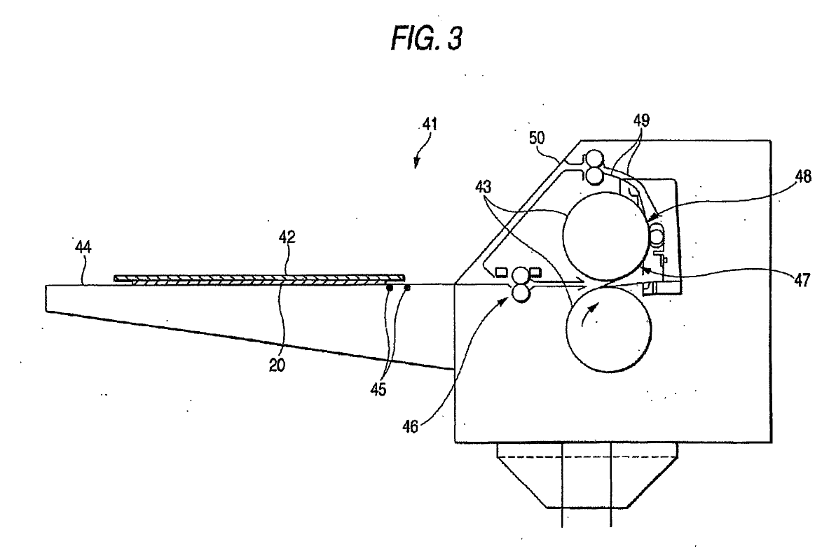

In First Proof®, an aluminum guide plate is overlaid with stock paper and an image receiving sheet, and passed between heat rollers to transfer an image. The aluminum guide plate is used for preventing deformation of the stock paper. However, when it is employed in the system of B2 size used in the invention, an aluminum guide plate larger in size than B2 becomes necessary, which poses the problem that the installation space of the devise is increased. Then, in this system, such a structure that no aluminum guide is used and further a conveying pass is turned at an angle of 180 degrees to discharge the stock paper and the image receiving sheet to the insertion side is employed. Accordingly, the installation space of the devise has become very compact (FIG. 3). However, the use of no aluminum guide causes the problem that the stock paper is deformed. Specifically, a pair of the stock paper and the image receiving sheet discharged are curled with the image receiving sheet facing inside, resulting in rolling on the discharge table. It is very difficult as an operation to peel off the image receiving sheet from the rolled-up stock paper.

For preventing the rolling-up, there are employed a bimetal effect caused by the difference in shrinkage between the stock paper and the image receiving sheet and an ironing effect due to a structure of winding around a heat roller. When the image receiving sheet is laid on the stock paper and inserted as in a conventional method, the heat shrinkage of the image receiving sheet in the direction of insertion and movement is greater than that of the stock paper, so that the upper sheet is disposed inside a curl caused by the bimetal effect. This curl direction agrees with the direction of a curl due to the ironing effect, so that the curl becomes increasingly strong by the synergistic effect. However, when the image receiving sheet and the stock paper are inserted so that the image receiving sheet is placed under the stock paper, the curl caused by the bimetal effect faces downward, and the curl due to the ironing effect faces upward. Accordingly, the problem of the curl has been solved by cancellation. The above-described devise can also be employed in the case wherein the image receiving substance used is a substance made of a material similar to the image receiving sheet, for example, a polymer film. However, since in such a case the above-described problems are smaller in comparison with the stock paper, a conventional heat roller is also used.

A sequence of image receiving substance transfer (hereinafter referred to as a stock paper transfer method used in the system) is as follows. A heat transfer device 41 used in the method, which is shown in FIG. 3, is a manually operated device, different from the recording device.

1) First, the temperature (100° C. to 110° C.) of heat rollers 43 and the conveying speed in transfer are set with a dial (not shown) depending on the kind of image receiving substance 42.

2) Then, an image receiving sheet 20 is placed on an insertion table with an image facing upward, and dust on the image is removed with a static eliminating brush (not shown). The image receiving substance 42 from which dust has been removed is placed thereon. In that case, the image receiving substance 42 placed on the upper side is larger in size than the image receiving sheet 20 placed on the lower side, so that the position of the image receiving sheet 20 becomes invisible, resulting in the difficulty of positioning it. For improving the workability, marks 45 for indicating placing positions of the image receiving sheet and the image receiving substance, respectively, are put on the insertion table 44. The reason why the image receiving substance is larger in size is that the image receiving substance 42 prevents the heat rollers 43 from being stained with an image receiving layer of the image receiving sheet 20 slipped out of the image receiving substance 42.

3) When the image receiving sheet and the image receiving substance are overlaid with each other and forced into an insertion inlet, insertion rollers 46 are driven for rotation to send out both toward the heat rollers 43.

4) When a leading edge of the image receiving substance arrives at the position of the heat rollers 43, the heat rollers are nipped to start transfer. The heat rollers are heat-resistant silicone rubber rollers. Pressure and heat are applied here at the same time, thereby adhering the image receiving sheet and image receiving substance to each other. A guide 47 made of a heat-resistant sheet is mounted downstream from the heat rollers, and the image receiving sheet/image receiving substance pair is conveyed upward between the upper heat roller and the guide 47, while applying heat. The pair is peeled off from the heat roller at position of a stripping claw 48, and introduced to a discharge outlet 50 along a guide plate 49.

5) The image receiving sheet/image receiving substance pair coming out of the discharge outlet 50 is discharged onto the insertion table. Subsequently, the image receiving sheet 20 is manually peeled off form the image receiving substance 42.

Feature 3 of the systematization techniques is constitution of a system.

The function as a color proof can be exhibited by connecting the device described above to a plate making system. As the system, printed matter having image quality extremely close to that of printed matter supplied from certain plate making data is required to be supplied from the proof. Then, a software for bringing color and halftone dots close to the printed matter is necessary. A specific connecting example will be introduced.

When a proof of printed matter from a plate making system, Celebra® manufactured by Fuji Photo Film Co., Ltd., is taken, system connection is as follows. A CTP (Computer To Plate) system is connected to Celebra. A printing plate supplied therefrom is subjected to a printing machine, thereby obtaining final printed matter. As the color proof, Luxel FINALPROOF 5600 (hereinafter also referred to as FINALPROOF) manufactured by Fuji Photo Film Co., Ltd., which is the above-described recording device, is connected to Celebra. Between them, PD system® manufactured by Fuji Photo Film Co., Ltd. is connected as a proof drive software for bringing color and halftone dots close to the printed matter.

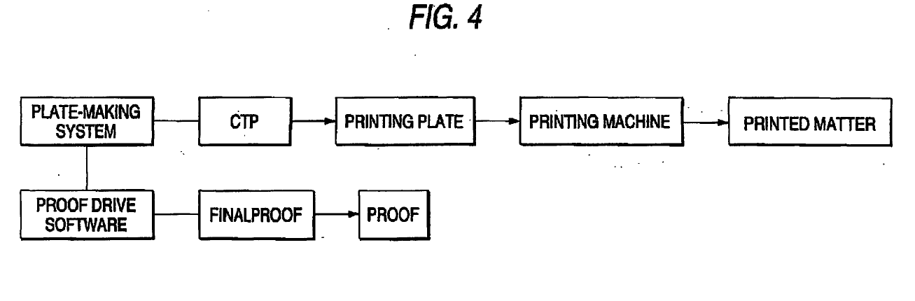

Contone (continuous tone) data converted to luster data by Celebra are converted to binary data for halftone dots, supplied to the CTP system, and finally printed. On the other hand, the same contone data are also supplied to the PD system. The PD system converts the received data by at least four color tables so that color agrees with the above-described printed matter. Finally, the data are converted to binary data for halftone dots so that they agree with halftone dots of the above-described printed matter, and supplied to FINALPROOF (FIG. 4).

The four color tables are previously experimentally prepared, and stored in the system. An experiment for preparing the table is as follows. An image in which important color data are printed through the CTP system and an image in which the data are supplied to FINALPROOF through the PD system are prepared, and calorimetric values thereof are compared with each other. Then, the table is prepared so that the difference between them is minimized.

The heat transfer sheet, which is a material used in the invention, will be described below.

It is preferred that the absolute value of the difference between the surface roughness Rz of a surface of the image forming layer of the heat transfer sheet and the surface roughness Rz of a surface of a back layer thereof is 3.0 μm or less, and that the absolute value of the difference between the surface roughness Rz of a surface of the image receiving layer of the image receiving sheet and the surface roughness Rz of a surface of a back layer thereof is 3.0 μm or less. Such constitution, coupled with the above-mentioned cleaning means, can prevent an image defect, prevent a conveying jam, and further improve dot gain stability.

The term “surface roughness Rz” as used herein means an average surface roughness from ten measurements corresponding to Rz (maximum height) of JIS, and a value obtained by inputting and converting a distance between the average value of the heights of the highest to the fifth mountains and the average value of the depths of the deepest to the fifth valleys, taking as a reference plane an average plane of portions sampled from a curved surface of roughness by a reference area. A stylus type three-dimensional roughness tester (Surfcom 570A-3DF) manufactured by Tokyo Seimitsu Co. Ltd. is used for measurement. The measuring direction is a longitudinal direction, the cutoff value is 0.08 mm, the measuring area is 0.6 mm×0.4 mm, the feed pitch is 0.005 mm, and the measuring speed is 0.12 mm/s.

From the viewpoint of more improving the above-described effect, it is preferred that the absolute value of the difference between the surface roughness Rz of the surface of the image forming layer of the heat transfer sheet and the surface roughness Rz of the surface of the back layer thereof is 1.0 μm or less, and that the absolute value of the difference between the surface roughness Rz of the surface of the image receiving layer of the image receiving sheet and the surface roughness Rz of the surface of the back layer thereof is 1.0 μm or less.

Further, as another embodiment, it is preferred that the surface roughness Rz of the surface of the image forming layer of the heat transfer sheet and the surface of the back layer thereof, and/or the surface of the image receiving layer of the image receiving sheet and the surface of the back layer thereof is from 2 μm to 30 μm. Such constitution, coupled with the above-mentioned cleaning means, can prevent an image defect, prevent a conveying jam, and further improve dot gain stability.

The glossiness of the image forming layer of the heat transfer sheet (excluding the heat transfer sheet for white color) is also preferably from 80 to 99.

The glossiness greatly depends on the smoothness of the surface of the image forming layer, and can exert an influence on the uniformity of the thickness of the image forming layer. The higher glossiness results in the uniform image forming layer, which is more suitable for the application to highly fine images. However, the higher glossiness results in more increased resistance in conveying, and both are in the trade-off relationship. When the glossiness (excluding the heat transfer sheet for white color) is within the range of 80 to 99, both are compatible and balanced.

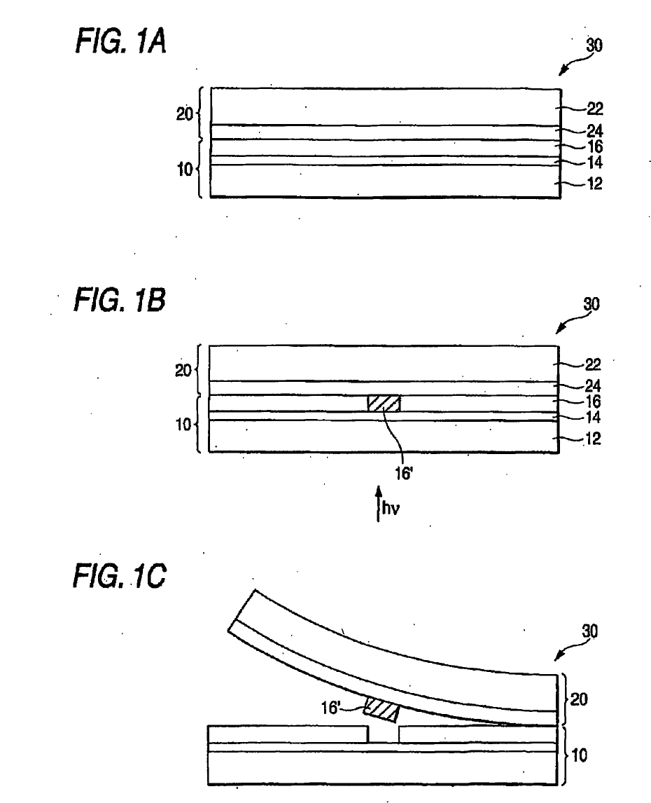

Now, the outline of a mechanism of image formation by thin film heat transfer using a laser beam will be described with reference to FIG. 1.

An image receiving sheet 20 is laminated on a surface of an image forming layer 16 of a heat transfer sheet 10, the layer 16 containing a pigment, for example, white (W), black (K), cyan (C), magenta (M) or yellow (Y), thereby preparing a laminate 30 for image formation. The heat transfer sheet 10 comprises a support 12 having provided thereon a light-to-heat converting layer 14 and an image forming layer 16 in this order. The image receiving layer 20 comprises a support 22 having provided thereon an image receiving layer 24. The image receiving sheet 20 is laminated with the heat transfer sheet 10 in such a manner that the image receiving layer 24 comes in contact with the image forming layer 16 of the heat transfer sheet 10 (FIG. 1A). When the laminate 30 is irradiated imagewise with a laser beam time-sequentially from the side of the support 12 of the heat transfer sheet 10, a laser beam-irradiated region of the light-to-heat converting layer 14 of the heat transfer sheet 10 develops heat to reduce adhesion with the image forming layer 16 (FIG. 1B). Then, the heat transfer sheet 10 is separated from the image receiving sheet 20, and at this time, a laser beam-irradiated region 16′ of the image forming layer 16 is transferred onto the image receiving layer 24 of the image receiving sheet 20 (FIG. 1C).

In the image formation, multiple laser beams are preferably used for light irradiation, and a multiple-beam two-dimensional arrangement is particularly preferred. The term “multiple-beam two-dimensional arrangement” means that plural laser beams are used in recording by laser irradiation, and that a spot arrangement of these laser beams is a two-dimensional plane arrangement comprising plural columns along a main scanning direction and plural rows along a sub-scanning direction.

The use of laser beams of the multiple-beam two-dimensional arrangement can decrease the time required for laser recording.

There is no particular restriction on the laser beam used. Examples of the laser beam used include a direct laser beam, for example, a gas laser beam such as argon ion laser beam, helium neon laser beam and helium cadmium laser beam, a solid laser beam such as YAG laser beam, a semiconductor laser beam, a dye laser beam and an excimer laser beam. A laser beam in which the wavelength is converted to half by passing the above-described laser beam through a secondary harmonic element can also be used. In the multicolor image forming method, the use of semiconductor laser beam is preferred, considering output power and the ease of modulation. In the multicolor image forming method, the laser beam is preferably irradiated under such conditions that the beam diameter on the light-to-heat converting layer is within the range of from 5 μm to 50 μm (particularly from 6 μm to 30 μm), and the scanning speed is preferably lm/second or more (particularly 3 m/second or more).

Further, in performing the multicolor image formation, the thickness of the image forming layer in the heat transfer sheet of black is preferably larger than that of each heat transfer sheet of yellow, magenta and cyan, and from 0.5 μm to 0.7 μm. This can inhibit a decrease in density caused by transfer unevenness when the heat transfer sheet of black is subjected to laser irradiation.

When the thickness of the image forming layer in the heat transfer sheet of black is adjusted to 0.5 μm or more, no transfer unevenness is caused and image density is maintained in the recording at high energy. Thus, image density necessary for a printing proof can be achieved. Such a tendency becomes more significant under conditions of high humidity, so that changes in density depending on the environment can be inhibited. On the other hand, transfer sensitivity in the laser recording can be maintained, and small points and thin lines are also improved, by adjusting the above-mentioned thickness to 0.7 μm or less. Such a tendency is more significant under conditions of low humidity. Further, resolution can also be improved. The thickness of the image forming layer in the heat transfer sheet of black is more preferably from 0.55 μm to 0.65 μm, and particularly preferably 0.60 μm.

Further, it is preferred that the thickness of the image forming layer in the heat transfer sheet of black is from 0.5 μm to 0.7 μm, and that the thickness of the image forming layer in each heat transfer sheet of yellow, magenta and cyan is from 0.2 μm to less than 0.5 μm.

When the thickness of the image forming layer in each heat transfer sheet of yellow, magenta and cyan is adjusted to 0.2 μm or more, no transfer unevenness is caused and image density is maintained at the laser recording. On the other hand, when the thickness is adjusted to 0.5 μm or less, transfer sensitivity and resolution can be improved. More preferably, the thickness is from 0.3 μm to 0.45 μm.

It is preferred that the image forming layer in the heat transfer sheet of black contains carbon black. The carbon black preferably comprises at least two kinds of carbon blacks different in coloring power, because reflection density can be controlled while keeping a P/B (pigment/binder) ratio within the constant range.

The coloring power of carbon black is represented by various methods, which include, for example, PVC blackness described in JP-A-10-140033. The PVC blackness is evaluated by adding carbon black to a PVC resin, dispersing the mixture with a twin-roll mill, forming the resulting product into a sheet, and visually judging the blackness of a sample, compared with the blackness of each of carbon blacks “#40” and “#45” manufactured by Mitsubishi Chemical Corp., which are graded into 1 and 10 as reference values. Two or more kinds of carbon blacks different in PVC blackness can be appropriately selected for use depending on the purpose.

A specific method for preparing a sample will be described below.

<Method for Preparing Sample>

In a 250-cc Banbury mixer, 40% by weight of sample carbon black is mixed with a LDPE (low-density polyethylene) resin, followed by kneading at 115° C. for 4 minutes.

Compounding Conditions:

| | | |
|---|---|---|
| LDPE Resin | 101.89 | g |
| Calcium Stearate | 1.39 | g |
| Irganox 1010 | 0.87 | g |
| Sample Carbon Black | 69.43 | g |

Then, the kneaded product is diluted to a carbon black concentration of 1% by weight at 120° C. by use of a twin-roll mill.

Conditions for Preparing Diluted Compound:

| | |
|---|---|
| LDPE Resin | 58.3 g |
| Calcium Stearate | 0.2 g |
| Resin Containing 40% by Weight Carbon Black | 1.5 g |

The compound is formed into a sheet at a slit width of 0.3 mm, and the resulting sheet is cut to chips. Then, the chips are formed into a film having a thickness of 65±3 μm on a hot plate of 240° C.

As a method for forming a multicolor image, many image layers (image forming layers on which images are formed) may be repeatedly overlaid on the same image receiving sheet, using the heat transfer sheets as described above, thereby forming the multicolor image, or images may be once formed on the image receiving layers of the plural image receiving sheets and then transferred again to stock paper, thereby forming the multicolor image.

As to the latter case, for example, the heat transfer sheets having the image forming layers containing colorants different from each other in hues are prepared, and combined with the image receiving sheets to independently produce five kinds or more (for example, cyan, magenta, yellow, black and red) of laminates for image formation. Each laminate is subjected to laser irradiation according to a digital signal based on the image, for example, through a color separation filter, and subsequently, each heat transfer sheet is separated from each image receiving sheet to independently form a color separation image of each color on the image receiving sheet. Then, each color separation image formed can be in turn laminated on an actual support, for example, stock paper separately prepared or a support similar thereto, thereby forming the multicolor image.

In the heat transfer recording using the laser beam irradiation, it is preferred that the image is formed on the image receiving sheet by the thin film transfer system in which the laser beam is converted to heat, and the pigment-containing image forming layer is transferred to the image receiving sheet by utilizing the heat energy thus generated. However, the technique used for the development of the image forming material comprising the heat transfer sheet and the image receiving sheet is appropriately applicable to the development of heat transfer sheets and/or image receiving sheets used in the melt transfer system, ablation transfer system and the sublimation transfer system, and the system of the invention also includes image forming materials used in these systems.

The heat transfer sheet and the image receiving sheet will be described in greater detail below.

[Heat Transfer Sheet]

The heat transfer sheet comprises a support having provided thereon a light-to-heat converting layer and an image forming layer, and if desired, other layer.

(Support)

There is no particular restriction on the material for the support of the heat transfer sheet. Various support materials can be used depending on the purpose. The support materials are preferably ones having rigidity, good in dimensional stability and resistant to heat in image formation. Preferred examples of the support materials include a synthetic resin material, for example, polyethylene terephthalate, polyethylene 2,6-naphthalate, a polycarbonate, polymethyl methacrylate, polyethylene, polypropylene, polyvinyl chloride, polyvinylidene chloride, polystyrene, a styrene-acrylonitrile copolymer, a polyamide (aromatic or aliphatic), a polyimide, a polyamideimide and a polysulfone. Above all, a biaxially stretched polyethylene terephthalate film is preferred, considering mechanical strength and dimensional stability to heat. When used for the preparation of the color proof utilizing laser recording, the support for the heat transfer sheet is preferably formed from a transparent synthetic resin material transmitting the laser beam. The thickness of the support is preferably from 25 μm to 130 μm, and particularly preferably from 50 μm to 120 μm. The centerline average surface roughness Ra of the support on the image forming layer side (measured based on JIS B0601 using a surface roughness tester (Surfcom manufactured by Tokyo Seimitsu Co. Ltd.) is preferably less than 0.1 μm. Longitudinal Young's modulus of the support is preferably from 200 kg/mm² to 1200 kg/mm² (approximately equal to 2 GPa to 12 GPa), and lateral Young's modulus thereof is preferably from 250 kg/mm² to 1,600 kg/mm² (approximately equal to 2.5 GPa to 16 GPa). The longitudinal F-5 value of the support is preferably from 5 kg/mm² to 50 kg/mm² (approximately equal to 49 MPa to 490 MPa), and the lateral F-5 value of the support is preferably from 3 kg/mm² to 30 kg/mm² (approximately equal to 29.4 MPa to 294 MPa). The longitudinal F-5 value of the support is ordinarily higher than the lateral F-5 value of the support. However, when it is particularly necessary to increase the lateral strength, this does not apply to the case. The degrees of heat shrinkage of the support in longitudinal and lateral directions at 100° C. for 30 minutes are preferably 3% or less, and more preferably 1.5% or less, and those at 80° C. for 30 minutes are preferably 1% or less, and more preferably 0.5% or less. The breaking strengths are preferably from 5 kg/mm² to 100 kg/mm² (approximately equal to 49 MPa to 980 MPa) in both directions, and the elasticity thereof is preferably from 100 kg/mm² to 2,000 kg/mm² (approximately equal to 0.98 GPa to 19.6 GPa).

For improving the adhesion between the support of the heat transfer sheet and the light-to-heat converting layer provided thereon, the support may be subjected to surface activation treatment and/or provided with one or more undercoat layers. The surface activation treatment includes, for example, glow discharge treatment and corona discharge treatment. A material for the undercoat layer is preferably high in adhesion to both surfaces of the support and the light-to-heat converting layer, low in heat conductivity and excellent in heat resistance. Examples of such material include styrene, a styrene-butadiene copolymer and gelatin. The thickness of the whole undercoat layer is usually from 0.01 μm to 2 μm. Further, a surface on the side opposite to the light-to-heat converting layer side of the heat transfer sheet can be provided with various functional layers, for example, an antireflection layer and an antistatic layer, or subjected to surface treatment, if desired.

(Back Layer)

A back layer is preferably provided on the surface on the side opposite to the light-to-heat converting layer side of the heat transfer sheet. It is preferred that the support has a first back layer adjacent to the support and a second back layer provided on the side opposite to the first back layer side. In the invention, a ratio of a weight A of an antistatic agent contained in the first back layer to a weight B of that contained in the second back layer (B/A) is preferably less than 0.3. When the B/A ratio is 0.3 or more, lubricity and powdering from the back layer tend to deteriorate.

The thickness C of the first back layer is preferably from 0.01 μm to 1 μm, and more preferably from 0.01 μm to 0.2 μm. The thickness D of the second back layer is preferably from 0.01 μm to 1 μm, and more preferably from 0.01 μm to 0.2 μm. A ratio of the thickness of the first back layer to the thickness of the second back layer (C:D) is preferably from 1:2 to 5:1.

The antistatic agent used in the first and second back layers includes a nonionic surfactant, for example, polyoxy-ethylenealkylamine and glycerol ester of fatty acid, a cationic surfactant, for example, quaternary ammonium salt, an anionic surfactant, for example, alkyl phosphate, an amphoteric surfactant and a compound, for example, conductive resin.

Fine conductive particles can also be used as the antistatic agent. Such conductive particles include, for example, an oxide, for example, ZnO, TiO₂, SnO₂, Al₂O₃, In₂O₃, MgO, BaO, CoO, CuO, Cu₂O, CaO, SrO, BaO₂, PbO, PbO₂, MnO₃, MoO₃, SiO₂, ZrO₂, Ag₂O, Y₂O₃, Bi₂O₃, Ti₂O₃, Sb₂O₃, Sb₂O₅, K₂Ti₆O₁₃, NaCaP₂O₁₈ and MgB₂O₅; a sulfide, for example, Cus and ZnS; a carbide, for example, SiC, TiC, ZrC, VC, NbC, MoC and WC; a nitride, for example, Si₃N₄, TiN, ZrN, VN, NbN and Cr₂N; aboride, for example, TiB₂, ZrB₂, NbB₂, TaB₂, CrB, MoB, WB and LaB₅; a silicide, for example, TiSi₂, ZrSi₂, NbSi₂, TaSi₂, CrSi₂, MoSi₂ and WSi₂; a metal salt, for example, BaCO₃, CaCO₃, SrCO₃, BaSO₄ and CaSO₄; and a complex, for example, SiN₄—SiC and 9Al₂O₃-2B₂O₃. The conductive particles may be used individually or in combination of two or more thereof. Of these, SnO₂, ZnO, Al₂O₃, TiO₂, In₂O₃, MgO, BaO and MoO₃ are preferred, SnO₂, ZnO, In₂O₃ and TiO₂ are more preferred, and SnO₂ is particularly preferred.

When the heat transfer material of the invention is used in the laser heat transfer recording system, it is preferred that the antistatic agent used in the back layer is substantially transparent so that the laser beam can be transmitted.

When the conductive metal oxide is used as the antistatic agent, it is preferred that the particle size thereof is smaller, for minimizing light scattering. It is to be determined using a ratio of the refractive index of the particles to that of a binder as a parameter, and can be determined by using the theory of Mie. In general, the average particle size is within the range of from 0.001 μm to 0.5 μm, and preferably within the range of from 0.003 μm to 0.2 μm. The term “average particle size” as used herein means a value including not only a primary particle size of the conductive metal oxide, but also a particle size of a higher-order structure.

In addition to the antistatic agent, various additives, for example, a surfactant, a lubricant and a matting agent, and a binder can be added to the first and second back layers. An amount of the antistatic agent contained in the first back layer is preferably from 10 parts by weight to 1,000 parts by weight, and more preferably from 200 parts by weight to 800 parts by weight, based on 100 parts by weight of the binder. Further, an amount of the antistatic agent contained in the second back layer is preferably from 0 part by weight to 300 parts by weight, and more preferably from 0 part by weight to 100 parts by weight, based on 100 parts by weight of the binder.

The binders used for formation of the first and second back layers include a homopolymer and a copolymer of acrylic acid monomer, for example, acrylic acid, methacrylic acid, an acrylate and a methacrylate, a cellulose polymer, for example, nitrocellulose, methyl cellulose, ethyl cellulose and cellulose acetate, a vinyl polymer and a copolymer of vinyl compound, for example, polyethylene, polypropylene, polystyrene, vinyl chloride copolymer, vinyl chloride-vinyl acetate copolymer, polyvinyl pyrrolidone, polyvinyl butyral and polyvinyl alcohol, a condensation polymer, for example, polyester, polyurethane and polyamide, a rubber thermoplastic polymer, for example, butadiene-styrene copolymer, a polymer obtained by polymerization or crosslinking of photopolymerizable or thermopolymerizable compound, for example, epoxy compound, and a melamine compound.

(Light-To-Heat Converting Layer)

The light-to-heat converting layer contains a light-to-heat converting substance and a binder, and if desired, a matting agent, and further other component, if desired.

The light-to-heat converting substance is a substance having the function of converting irradiated light energy to heat energy. In general, it is a dye (including a pigment, hereinafter the same), which can absorb a laser beam. When an image is recorded with an infrared laser, an infrared absorbing dye is preferably used as the light-to-heat converting substance. Examples of the dye include black pigment, for example, carbon black, pigment of macrocyclic compound having absorption in a region from visible to near infrared, for example, phthalocyanine and naphthalocyanine, organic dye used as a laser absorption material for high-density laser recording, for example, optical disk (cyanine dye, for example, indolenine dye, anthraquinone dye, azulene dye and phthalocyanine dye), and organic metal compound dye, for example, dithiol nickel complex. Above all, the cyanine dye is preferred, because it shows high absorption constant to light in the infrared region, so that the use thereof as the light-to-heat converting substance can reduce the thickness of the light-to-heat converting layer, resulting in more improvement in the transfer sensitivity of the heat transfer sheet.

As the light-to-heat converting substance, there can also be used an inorganic material including granular metal material, for example, as blackened silver.

The binder contained in the light-to-heat converting layer is preferably a resin having at least strength enough to form a layer on the support, and high heat conductivity. Further, a heat-resistant resin, which is not decomposed even by heat generated from the light-to-heat converting substance at the image recording is preferred, because the smoothness of the surface of the light-to-heat converting layer after the light irradiation can be maintained even when high-energy light irradiation is carried out. Specifically, a resin having a thermal decomposition temperature (a temperature at which the weight is decreased by 5% in a stream of air at a rate of temperature rise of 10° C./minute by the TGA method (thermal mass spectrometric analysis)) of 400° C. or more is preferred, and a resin having a thermal decomposition temperature of 500° C. or more is more preferred.

It is preferred that the binder has a glass transition temperature of from 200° C. to 400° C., and it is more preferred that the binder has a glass transition temperature of from 250° C. to 350° C. A resin having a glass transition temperature of lower than 200° C. results in occurrence of fog in an image formed in some cases, whereas a resin having a glass transition temperature exceeding 400° C. results in deterioration of solubility of the resin, which causes decrease in production efficiency in some cases.

It is preferred that the binder used in the light-to-heat converting layer is higher in heat resistance (for example, thermal deformation temperature and thermal decomposition temperature) than the materials used in the other layers provided on the light-to-heat converting layer.

Specific examples of the binder include an acrylic acid resin, for example, polymethyl methacrylate, a polycarbonate, a vinyl resin, for example, polystyrene, a vinyl chloride/vinyl acetate copolymer and polyvinyl alcohol, polyvinyl butyral, a polyester, polyvinyl chloride, a polyamide, a polyimide, a polyamideimide, a polyetherimide, a polysulfone, a polyethersulfone, an alamid, a polyurethane, an epoxy resin and a urea/melamine resin. These resins may be used individually or in combination of two or more thereof. Of these, a polyamideimide resin and a polyimide resin are preferred.

The polyamideimide preferably used is a polyamideimide represented by the following formula (A):

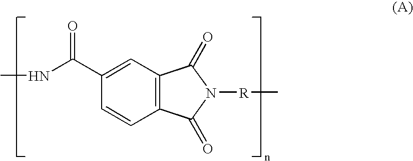

In formula (A), R represents a divalent connection group, and n represents an integer of from 10 to 100 (the compound of formula (A) has a molecular weight of about from 1,000 to hundreds of thousands). Preferred specific examples of the divalent connecting group are set forth below.

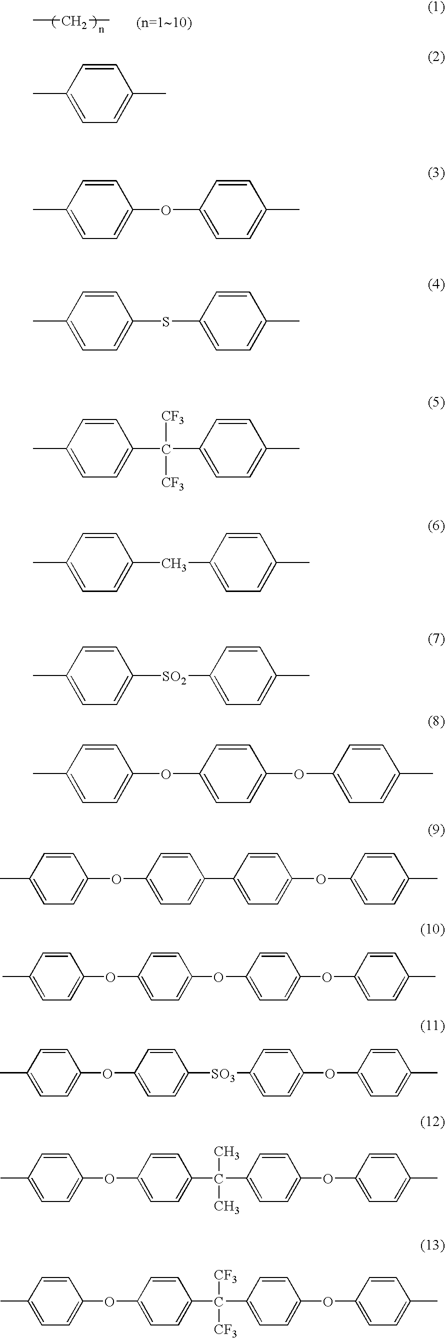

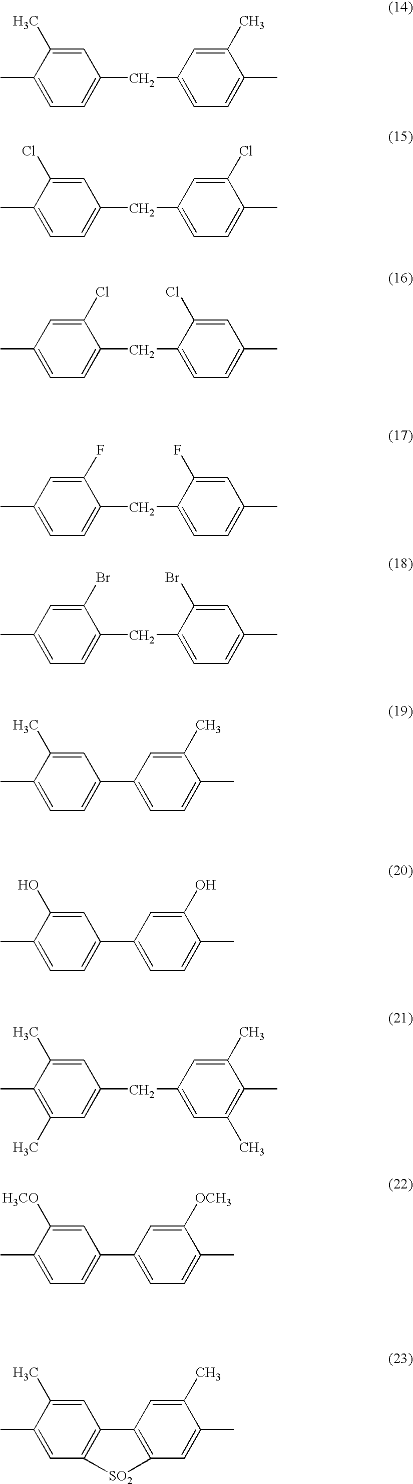

The polyimide resin preferably includes polyimide resins represented by formulae (I) to (VII) shown below.

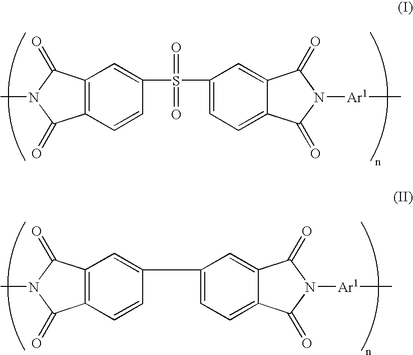

In formulae (I) and (II), Ar¹ represents an aromatic group represented by any one of structural formulae (1) to (3) shown below, and n represents an integer of from 10 to 100.

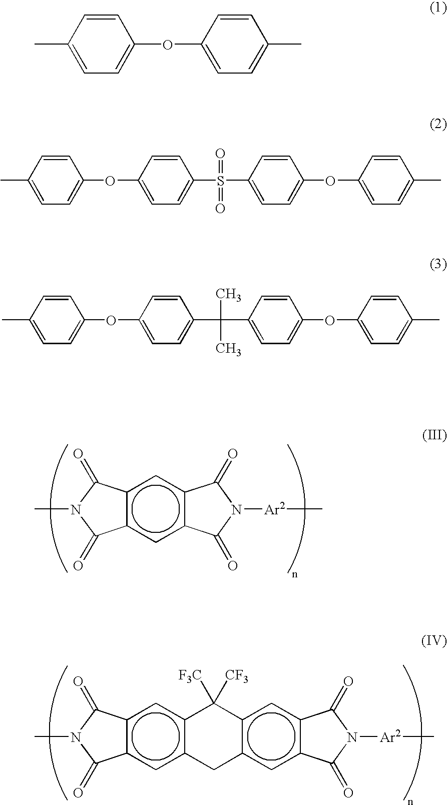

In formulae (III) and (IV), Ar² represents an aromatic group represented by any one of structural formulae (4) to (7) shown below, and n represents an integer of from 10 to 100.

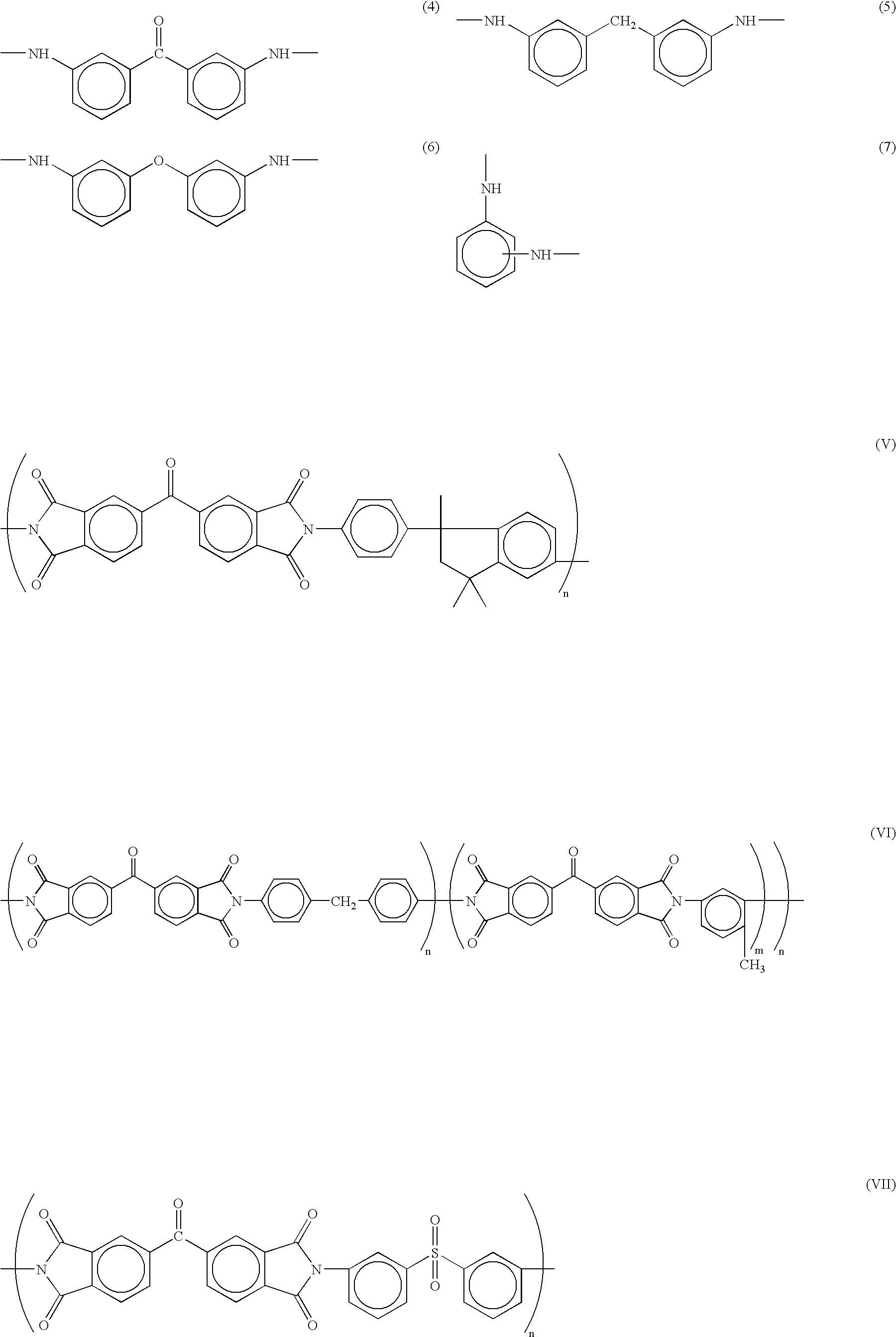

In formulae (V) to (VII), n and m each represent an integer of from 10 to 100. In formula (VI), a n:m ratio is from 6:4 to 9:1.

As a measure for judging whether a resin is soluble in an organic solvent or not, the basis that 10 parts by weight or more of the resin is dissolved in 100 parts by weight of N-methylpyrrolidone at 25° C. is used. When the resin is dissolved in an amount of 10 parts by weight or more, it is preferably used as the resin for the light-to-heat converting layer. The resin, which is dissolved in an amount of 100 parts by weight or more based on 100 parts by weight of N-methylpyrrolidone, is more preferably used.

The resin used as the binder contained in the light-to-heat converting layer, for example, a polyamideimide preferably has SP (solubility parameter) value of not less than 25, calculated by the Okitsu method. When the SP value of the resin contained in the light-to-heat converting layer is not less than 25, an amount of the light-to-heat converting substance, for example, an infrared absorbing dye, and the decomposed material thereof migrated into the image forming layer is reduced.

The Okitsu method is described in detail in The Journal of Adhesion Society of Japan, Vol. 29, No. 5 (1993).

As the light-to-heat converting substance, an infrared absorbing dye represented by formula (B) shown below is extremely preferred, because the dye has excellent heat resistance and it does not decompose and maintains its absorbance when a coating solution containing it is stored. In particular, it is effectively used in combination with the polyamideimide resin as described above.

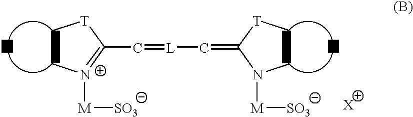

In formula (B), Z represents an atomic group necessary for completing a ring. Examples of the ring completed with Z include a benzene ring, a naphthalene ring, a pyridine ring, a quinoline ring, a pyrazine ring and a quinoxaline ring. Further, a substituent R⁶ may be bonded to Z. Examples of the substituent R⁶ include an alkyl group, an aryl group, a heterocyclic group, a halogen atom, an alkoxy group, an aryloxy group, an alkylthio group, an arylthio group, an alkylcarbonyl group, an arylcarbonyl group, an alkoxycarbonyl group, an aryloxycarbonyl group, an alkylcarbonyloxy group, an arylcarbonyloxy group, an alkylamido group, an arylamido group, an alkylcarbamoyl group, an arylcarbamoyl group, an alkylamino group, an arylamino group, a carboxylic acid group, an alkylsulfonyl group, an arylsulfonyl group, an alkylsulfonamido group, an arylsulfonamido group, an alkylsulfamoyl group, an arylsulfamoyl group, a cyano group and a nitro group. A number (p) of the substituents bonded to Z is preferably from 0 to approximately 4. When p is 2 or more, plural R⁶s may be the same or different from each other.

Of the substituents represented by R⁶, a halogen atom (e.g., a fluorine atom or a chlorine atom), a cyano group, a substituted or unsubstituted alkoxy group having from 1 to 20 carbon atoms (e.g., a methoxy group, an ethoxy group, a dodecyloxy group or a methoxyethoxy group), a substituted or unsubstituted phenoxy group having from 6 to 20 carbon atoms (e.g., a phenoxy group, a 3,5-dichlorophenoxy group or a 2,4-di-tert-pentylphenoxy group), a substituted or unsubstituted alkyl group having from 1 to 20 carbon atoms (e.g., a methyl group, an ethyl group, an isobutyl group, a tert-pentyl group, an octadecyl group or a cyclohexyl group) and a substituted or unsubstituted phenyl group having from 6 to 20 carbon atoms (e.g., a phenyl group, a 4-methylphenyl group, a 4-trifluoromethylphenyl group or a 3,5-dichlorophenyl group) are preferred.

In formula (B), T represents —O—, —S—, —Se—, —N(R¹)—, —C(R²) (R³)— or —C(R⁴)═(R⁵)—. As a group represented by R¹, R², R³, R⁴ or R⁵, a substituted or unsubstituted alkyl group, a substituted or unsubstituted aryl group and a substituted or unsubstituted alkenyl group are preferred, and particularly an alkyl group is preferred. A number of carbon atoms included in the group represented by R¹, R², R³, R⁴ or R⁵ is preferably from 1 to 30, particularly preferably from 1 to 20.

The group represented by R¹, R², R³, R⁴ or R⁵ may further have a substituent. Preferred examples of the substituent include a sulfonic acid group, an alkxycarbonyloxy group, an alkylamido group, an alkylsulfonamido group, an alkoxycarbonyl group, an alkylamino group, an alkylcarbamoyl group, an alkylsulfamoyl group, an alkoxy group, an aryloxy group, an alkylthio group, an arylthio group, an alkyl group, an aryl group, a carboxy group, a halogen atom and a cyano group.

Of the substituents, a halogen atom (e.g., a fluorine atom or a chlorine atom), a cyano group, a substituted or unsubstituted alkoxy group having from 1 to 20 carbon atoms (e.g., a methoxy group, an ethoxy group, a dodecyloxy group or a methoxyethoxy group), a substituted or unsubstituted phenoxy group having from 6 to 20 carbon atoms (e.g., a phenoxy group, a 3,5-dichlorophenoxy group or a 2,4-di-tert-pentylphenoxy group), a substituted or unsubstituted alkyl group having from 1 to 20 carbon atoms (e.g., a methyl group, an ethyl group, an isobutyl group, a tert-pentyl group, an octadecyl group or a cyclohexyl group) and a substituted or unsubstituted phenyl group having from 6 to 20 carbon atoms (e.g., a phenyl group, a 4-methylphenyl group, a 4-trifluoromethylphenyl group or a 3,5-dichlorophenyl group) are particularly preferred.

In formula (B), L represents a trivalent connection group wherein 5 or 7 methine groups are connected through conjugated double bonds, which may be substituted. Specifically, 1 represents a pentamethine group or a heptamethine group formed by connecting of methine groups with conjugated double bonds. More specifically, groups represented by formulae (L-1) to (L-6) shown below are preferred.

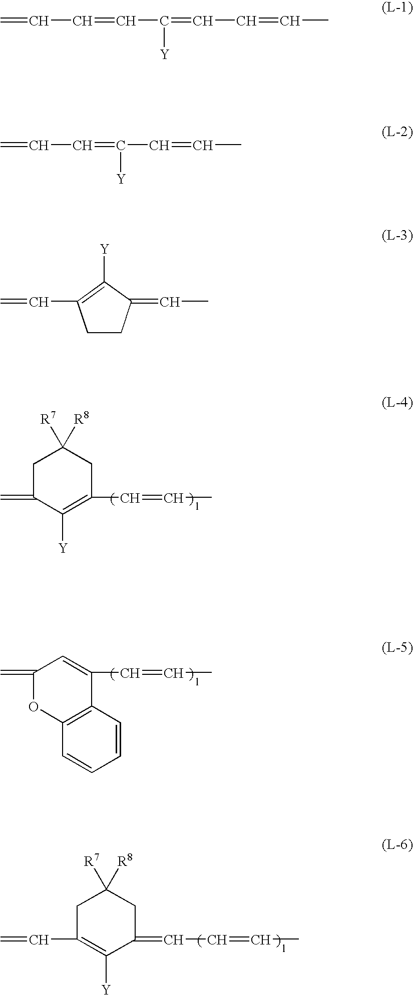

Of the specific examples, the connecting groups represented by formulae (L-2), (L-3), (L-4), (L-5) and (L-6) for forming tricarbocyanine are particularly preferred. In formulae (L-1) to (L-6), Y represents a hydrogen atom or a monovalent group. Of the monovalent group represented by Y, a lower alkyl group (e.g., a methyl group), a lower alkoxy group (e.g., a methoxy group), a substituted amino group (e.g., a dimethylamino group, a diphenylamino group, a methylphenylamiono group, a morpholino group, a imidazolidine group or an ethoxycarbonylpiperazine group), an alkylcarbonyloxy group (e.g., a acetoxy group), an alkylthio group (e.g., a methylthio group), a cyano group, a nitro group and a halogen atom (e.g., a bromine atom, a chlorine atom or a fluorine atom) are preferred.

Y is particularly preferably a hydrogen atom. R₇ and R₈ each preferably represent a hydrogen atom or a lower alkyl group (e.g., a methyl group), particularly preferably represent a hydrogen atom. In formulae (L-4) to (L-6), i represents 1 or 2, j represents 0 or 1. M represents a divalent connecting group, preferably represents a substituted or unsubstituted alkylene group having from 1 to 20 carbon atoms, for example, an ethylene group, a propylene group or a butylene group.

In formula (B), a cation represented by X⁺ includes, for example, a metal ion (e.g., Na⁺ or K⁺), an ammonium ion (e.g., an ion represented by HN⁺(C₂H₅)₃) or a pyridinium ion.

Specific examples of the compound represented by formula (B) are set forth below, but the invention should not be construed as being limited thereto.

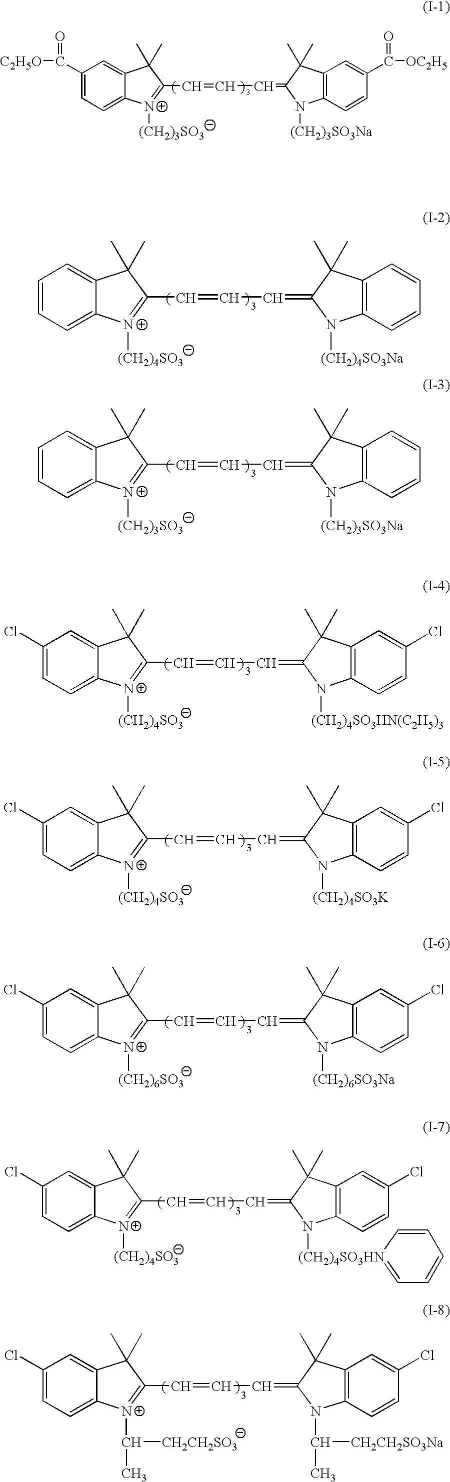

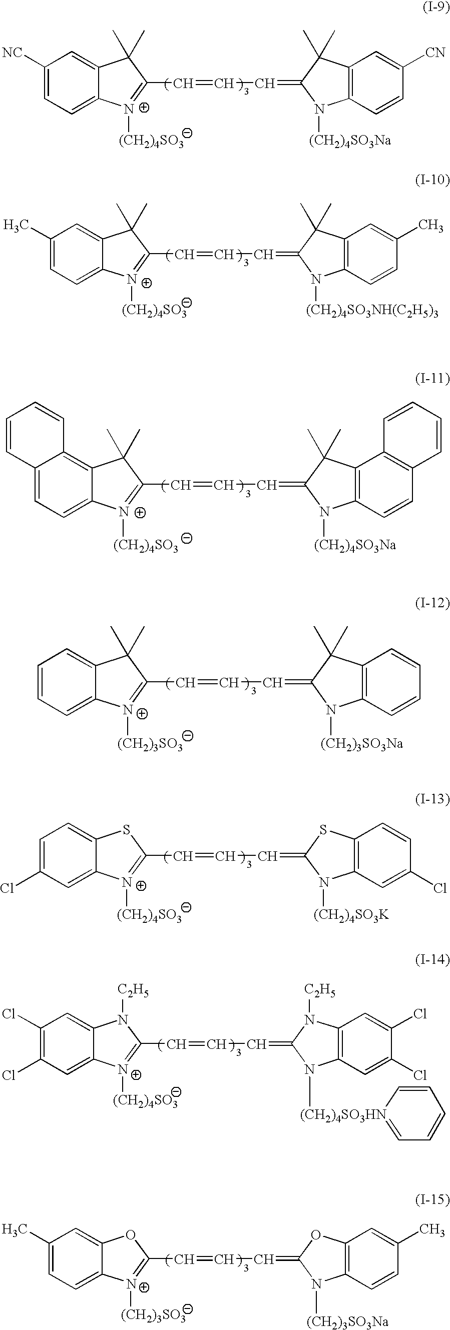

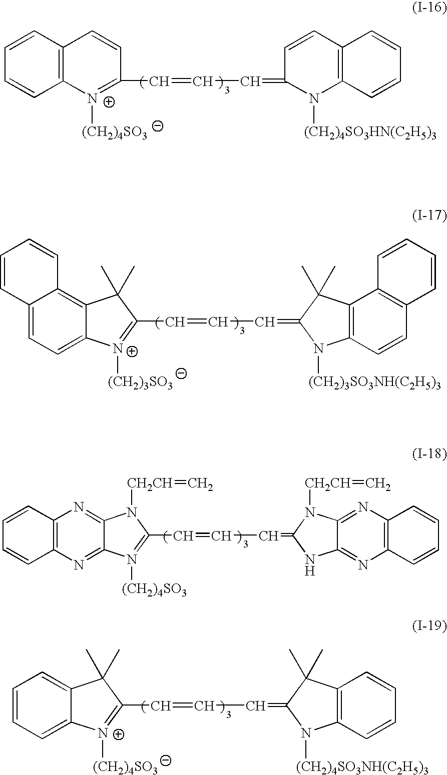

The compound represented by formula (B) can ordinarily be synthesized easily in the same manner as in synthesis of carbocyanine dye. Specifically, it can be easily synthesized by reacting a heterocyclic enamine with an acetal, for example, CH₃O—CH═CH—CH═CH—CH(OCH₃)₂ or a compound represented by Ph-N═CH—(CH═CH)₂—NHPh (wherein Ph represents a phenyl group). With respect to the synthesis method of compound, the descriptions of JP-A-5-116450 are also specifically referred to.

When the light-to-heat converting substance has a high decomposition temperature and is hardly decomposed, defect of fog caused by coloration due to decomposed material of the light-to-heat converting substance can be prevented. From such a standpoint, the decomposition temperature of the light-to-heat converting substance is preferably not less than 200° C., more preferably not less than 250° C. When the decomposition temperature of the light-to-heat converting substance is less than 200° C., the coloration due to decomposed material of the light-to-heat converting substance may cause fog and degrade the image quality in some cases.

According to the present invention, it is preferred that the light-to-heat converting layer of the heat transfer sheet for at least one color contains a polyamideimide resin binder and a cyanine dye having a sulfonic acid group.

The cyanine dye having a sulfonic acid group has high stability and a property of being hardly decomposed. Further, the dye has good compatibility with polyamideimide so that the migration thereof to the image forming layer can be restrained, thereby exhibiting a effect of preventing the change in hue before and after the translation to the image forming layer. Thus, the change in hue of the image forming layer, particularly, the change in white hue is prevented. Moreover, when both of them are contained, it is also advantageous in that storage stability of a coating solution for the light-to-heat converting layer is excellent.

It is preferred in the invention that the dye represented by formula (B) is incorporated into the light-to-heat converting layer as the main component of the light-to-heat converting substance. However, the light-to-heat converting layer may further contain a conventionally known light-to-heat converting substance as long as the effect of using the dye represented by formula (B) is not impaired. Also, the compounds shown below can be used individually or in combination with other compound.

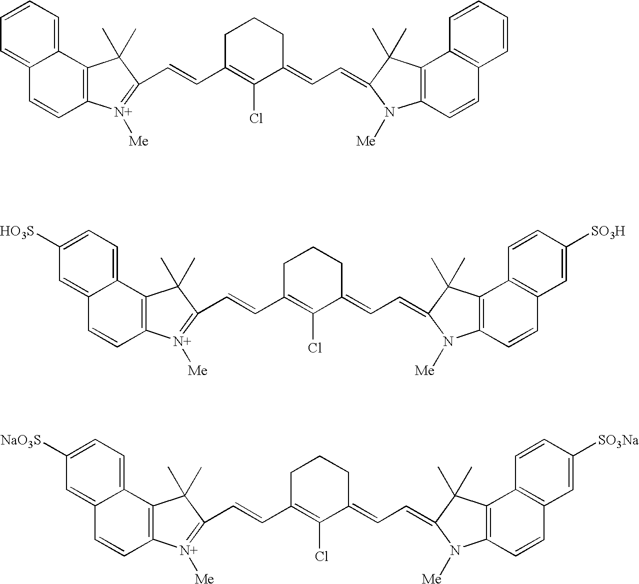

The matting agent contained in the light-to-heat converting layer includes fine inorganic particles and fine organic particles. The fine inorganic particles include a metal salt, for example, silica, titanium oxide, aluminum oxide, zinc oxide, magnesium oxide, barium sulfate, magnesium sulfate, aluminum hydroxide, magnesium hydroxide and boron nitride, kaolin, clay, talc, zinc white, white lead, zeaklite, quartz, diatomaceous earth, pearlite, bentonite, mica and synthetic mica. The fine organic particles include resin particles, for example, fluorocarbon resin particles, guanamine resin particles, acrylic resin particles, styrene-acrylic copolymer resin particles, silicone resin particles, melamine resin particles and epoxy resin particles.

A particle size of the matting agent is ordinarily from 0.3 μm to 30 μm, and preferably from 0.5 μm to 20 μm. The amount thereof added is preferably from 0.1 mg/m² to 100 mg/m².

The light-to-heat converting layer may further contain a surfactant, a thickening agent and an antistatic agent, if desired.

The light-to-heat converting layer can be formed by dissolving the light-to-heat converting substance and the binder, and further adding thereto, if desired, the matting agent and other components to prepare a coating solution, coating the solution on a support, and drying it. An organic solvent for dissolving the polyimide resin include, for example, n-hexane, cyclohexane, diglime, xylene, toluene, ethyl acetate, tetrahydrofuran, methyl ethyl ketone, acetone, cyclohexanone, 1,4-dioxane, 1,3-dioxane, dimethyl acetate, N-methyl-2-pyrrolidone, dimethyl sulfoxide, dimethylformamide, dimethylacetoamide, γ-butyrolactone, ethanol and methanol. The coating and drying can be performed according to conventional coating and drying methods. The drying is conducted ordinarily at a temperature of 300° C. or lower, and preferably at a temperature of 200° C. or lower. When polyethylene terephthalate is used as the support, the drying is preferably carried out at a temperature of from 80° C. to 150° C.

When the amount of the binder contained in the light-to-heat converting layer is too small, the cohesive force of the light-to-heat converting layer is decreased, and thus when the formed image is transferred to the image receiving sheet, the light-to-heat converting layer becomes liable to be transferred together, thereby causing color mixing. Further, when the amount of the polyimide resin is too large, the thickness of the light-to-heat converting layer for achieving a definite light absorption rate is increased to be liable to cause a reduction in sensitivity. A solid content weight ratio of the light-to-heat converting substance to the binder in the light-to-heat converting layer is preferably from 1:20 to 2:1, and more preferably from 1:10 to 2:1.

When the thickness of the light-to-heat converting layer is reduced, the sensitivity of the heat transfer sheet is preferably enhanced. The thickness of the light-to-heat converting layer is preferably from 0.03 μm to 1.0 μm, and more preferably from 0.05 μm to 0.5 μm. It is preferred that the light-to-heat converting layer has an optical density of from 0.80 to 1.26 to a peak wavelength of a laser beam, for example, a wavelength of 808 nm, because the transfer sensitivity of the image forming layer is improved. It is more preferred that the light-to-heat converting layer has an optical density of from 0.92 to 1.15 at the above-described wavelength. When the optical density at the peak wavelength of the laser beam is less than 0.80, conversion of irradiated light to heat becomes insufficient, sometimes resulting in a reduction in the transfer sensitivity. On the other hand, when it exceeds 1.26, the function of the light-to-heat converting layer is influenced at the recording to cause fog in some cases.

The light-to-heat converting layer preferably has a ratio (A/X) of the absorbance (A) of the light-to-heat converting layer to thickness (X) (μm unit) of the light-to-heat converting layer of from 2.5 to 3.2, more preferably from 2.8 to 3.1. The absorbance (A) of the light-to-heat converting layer is preferably from 1.0 to 2.0, more preferably from 1.3 to 1.75.

The term “absorbance (A)” means absorbance of the light-to-heat converting layer at a peak wavelength of a laser beam used for the image recording and it can be measured using a known spectrophotometer. In the invention, an UV spectrophotometer (UV-240, manufactured by Shimadzu Corp.) is used. The absorbance (A) is a value obtained by subtracting a value of a support alone from a value of the light-to-heat converting layer and the support.

The thickness of the light-to-heat converting layer is determined by embedding the light-to-heat converting layer provided on a support in an epoxy resin, sectioning the embedded material by a cryomicrotome and observing the section by an SEM.

The thickness of the light-to-heat converting layer is preferably from 0.3 μm to 0.8 μm in view of the ratio of A/X.

(Image Forming Layer)

The image forming layer of the heat transfer sheet contains at least a pigment transferred to the image receiving sheet to form an image and further a binder for forming the layer, and other component, if desired.

The pigment is in general classified roughly into organic pigment and inorganic pigment. The former has a property particularly excellent in transparency of a coating film, and the later has a property ordinarily excellent in opacifying power. Accordingly, the pigment can be appropriately selected depending on the purpose. When the heat transfer sheet having the image forming layer for yellow (Y), magenta (M), cyan (C), black (K), green (G), orange (O), red (R), blue (B), gold (Go), silver (S), pink (P) or the like is used organic pigment or inorganic pigment having color of Y, M, C, K, G, O, R, B, Go, S, P or the like is suitably used in the image forming layer. Particularly, organic pigments consistent with or close in hues to those ordinarily used in printing inks are suitably employed.

Examples of the organic pigment suitably used include azo pigment, phthalocyanine pigment, anthraquinone pigment, dioxazine pigment, quinacridone pigment, isoindolinone pigment and nitro pigment.

Examples of the organic pigment used include metal element and inorganic compound, for example metal oxide.

Further, as the pigment, fluorescent pigment is also used.

The blue pigment for use in the image forming layer of the heat transfer sheet W includes inorganic pigment, for example, ultramarine blue or iron blue, and organic pigment, for example, the blue pigments shown below, Pigment Blue 15, Pigment Blue 15:4, Pigment Blue 15:6 or Pigment Blue 60.

With respect to the fluorescent brightening agent for use in the image forming layer of the heat transfer sheet W, the descriptions made hereinbefore can be referred to.

The pigments for use in the image forming layer are set forth below, classified by hue, but the invention should not be construed as being limited thereto.

1) Yellow Pigment

Pigment Yellow 12 (C.I. No. 21090)

Examples: Permanent Yellow DHG (manufactured by Clariant Japan K.K.), Lionol Yellow 1212B (manufactured by Toyo Ink Mfg. Co. Ltd.), Irgalite Yellow LCT (manufactured by Ciba Specialty Chemicals) and Symuler Fast Yellow GTF 219 (manufactured by Dainippon Ink & Chemicals Inc.)

Pigment Yellow 13 (C.I. No. 21100)

Examples: Permanent Yellow GR (manufactured by Clariant Japan K.K.) and Lionol Yellow 1313 (manufactured by Toyo Ink Mfg. Co. Ltd.)

Pigment Yellow 14 (C.I. No. 21095)

Examples: Permanent Yellow G (manufactured by Clariant Japan K.K.), Lionol Yellow 1401-G (manufactured by Toyo Ink Mfg. Co. Ltd.), Seika Fast Yellow 2270 (manufactured by Dainichiseika Colour & Chemicals Mfg. Co., Ltd.) and Symuler Fast Yellow 4400 (manufactured by Dainippon Ink & Chemicals Inc.)

Pigment Yellow 17 (C.I. No. 21105)

Examples: Permanent Yellow GG02 (manufactured by Clariant Japan K.K.) and Symuler Fast Yellow 8GF (manufactured by Dainippon Ink & Chemicals Inc.)

Pigment Yellow 155

Examples: Graphtol Yellow 3GP (manufactured by Clariant Japan K.K.)

Pigment Yellow 180 (C.I. No. 21290)

Examples: Novoperm Yellow P-HG (manufactured by Clariant Japan K.K.) and PV Fast Yellow HG (manufactured by Clariant Japan K.K.)

Pigment Yellow 139 (C.I. No. 56298)

Examples: Novoperm Yellow M2R70 (manufactured by Clariant Japan K.K.)

2) Magenta Pigment

Pigment Red 57:1 (C.I. No. 15850:1)

Examples: Graphtol Rubine L6B (manufactured by Clariant Japan K.K.), Lionol Red 6B-4290G (manufactured by Toyo Ink Mfg. Co. Ltd.), Irgalite Rubine 4BL (manufactured by Ciba Specialty Chemicals) and Symuler Brilliant Carmine 6B-229 (manufactured by Dainippon Ink & Chemicals Inc.)

Pigment Red 122 (C.I. No. 73915)

Examples: Hosterperm Pink E (manufactured by Clariant Japan K.K.), Lionogen Magenta 5790 (manufactured by Toyo Ink Mfg. Co. Ltd.) and Fastogen Super Magenta RH (manufactured by Dainippon Ink & Chemicals Inc.)

Pigment Red 53:1 (C.I. No. 15585:1)

Examples: Permanent Lake Red LCY (manufactured by Clariant Japan K.K.) and Symuler Lake Red C conc (manufactured by Dainippon Ink & Chemicals Inc.)

Pigment Red 48:2 (C.I. No. 15865:2)

Examples: Permanent Red W2T (manufactured by Clariant Japan K.K.), Lionol RedLX235 (manufactured by Toyo Ink Mfg. Co. Ltd.) and Symuler Red 3012 (manufactured by Dainippon Ink & Chemicals Inc.)

Pigment Red 177 (C.I. No. 65300)

Examples: Cromophtal Red A2B (manufactured by Ciba Specialty Chemicals)

3) Cyan Pigment

Pigment Blue 15 (C.I. No. 74160)

Examples: Lionol Blue 7027 (manufactured by Toyo Ink Mfg. Co. Ltd.) and Fastogen Blue BB (manufactured by Dainippon Ink & Chemicals Inc.)

Pigment Blue 15:1 (C.I. No. 74160)

Examples: Hosterperm Blue A2R (manufactured by Clariant Japan K.K.) and Fastogen Blue 5050 (manufactured by Dainippon Ink & Chemicals Inc.)

Pigment Blue 15:2 (C.I. No. 74160)

Examples: Hosterperm Blue AFL (manufactured by Clariant Japan K.K.), Irgalite Blue BSP (manufactured by Ciba Specialty Chemicals) and Fastogen Blue GP (manufactured by Dainippon Ink & Chemicals Inc.)

Pigment Blue 15:3 (C.I. No. 74160)

Examples: Hosterperm Blue B2G (manufactured by Clariant Japan K.K.), Lionol Blue FG7330 (manufactured by Toyo Ink Mfg. Co. Ltd.), Cromophtal Blue 4GNP (manufactured by Ciba Specialty Chemicals) and Fastogen Blue FGF (manufactured by Dainippon Ink & Chemicals Inc.)

Pigment Blue 15:4 (C.I. No. 74160)

Examples: Hosterperm Blue BFL (manufactured by Clariant Japan K.K.), Cyanine Blue 700-10FG (manufactured by Toyo Ink Mfg. Co. Ltd.), Irgalite Blue GLNF (manufactured by Ciba Specialty Chemicals) and Fastogen Blue FGS (manufactured by Dainippon Ink & Chemicals Inc.)

4) Black Pigment

Pigment Black 7 (Carbon Black C.I. No. 77266)

Examples: Mitsubishi Carbon Black MA100 (manufactured by Mitsubishi Chemical Corp.), Mitsubishi Carbon Black #5 (manufactured by Mitsubishi Chemical Corp.) and Black Pearls 430 (manufactured by Cabot Co.).

5) White Pigment

ZnO and lithopone (ZnO+BaSO₄), in addition to those described above.

6) Red Pigment

Pigment Red 48:1 (C.I. No. 15865:1)

Examples: Lionol Red 2B-FG3300 (manufactured by Toyo Ink Mfg. Co. Ltd.) and Symuler Red NRY and Symuler Red 3108 (manufactured by Dainippon Ink & Chemicals Inc.)

Pigment Red 48:3 (C.I. No. 15865:3)

Examples: Permanent Red 3RL (manufactured by Clariant Japan K.K.) and Symuler Red 2BS (manufactured by Dainippon Ink & Chemicals Inc.)

7) Blue Pigment

Pigment Blue 15:6 (C.I. No. 74160)

Examples: Lionol Blue ES (manufactured by Toyo Ink Mfg. Co. Ltd.)

Pigment Blue 60 (C.I. No. 69800)

Examples: Hosterperm Blue RL01 (manufactured by Clariant Japan K.K.) and Lionogen Blue 6501 (manufactured by Toyo Ink Mfg. Co. Ltd.)

8) Green Pigment

Pigment Green 7 (C.I. No. 74260)

Examples: Fastogen Green S (manufactured by Dainippon Ink & Chemicals Inc.)

Pigment Green 36 (C.I. No. 74265)

Examples: Fastogen Green MY (manufactured by Dainippon Ink & Chemicals Inc.)

9) Orange Pigment

Pigment Orange 43 (C.I. No. 71105)

Examples: Hosterperm Orange GR (manufactured by Clariant Japan K.K.)

10) Gold Pigment

Mica and aluminum powder

11) Silver Pigment

Mica and aluminum powder

As the pigment, which can be used in the invention, commercial products are appropriately selected by reference to Ganryo Binran (Pigment Handbook) edited by Nippon Ganryo Gijutsu Kyokai, Seibundo Shinkosha Inc. (1989) and Colour Index, Third Edition, The Society of Dyers & Colourist (1987).

An average particle size of the pigment other than that for white color is preferably from 0.03 μm to 1 μm, and more preferably from 0.05 μm to 0.5 μm.

When the particle size is 0.03 μm or more, increase in dispersion cost and gelation of dispersion solution are prevented. On the other hand, when the particle size is 1 μm or less, no coarse particles exist in the pigment, so that the adhesion between the image forming layer and the image receiving layer is good, and the transparency of the image forming layer can also be improved.

As the binder for the image forming layer of the heat transfer sheet other than the heat transfer sheet W, an amorphous organic polymer having a softening point of from 40° C. to 150° C. is also preferred. The amorphous organic polymer which can be used includes, for example, butyral resins, polyamide resins, polyethyleneimine resins, sulfonamide resins, polyesterpolyol resins, petroleum resins, homopolymers or copolymers of styrene and derivatives thereof, for example, styrene, vinyltoluene, α-methylstyrene, 2-methylstyrene, chlorostyrene, vinyl-benzoic acid, sodium vinylbenzenesulfonate or aminostyrene, and homopolymers of vinylmonomers, for example, methacrylates, e.g., methyl methacrylate, ethyl methacrylate, butyl methacrylate or hydroxyethyl methacrylate, methacrylic acid, acrylates, e.g., methyl acrylate, ethyl acrylate, butyl acrylate or α-ethylhexyl acrylate, acrylic acid, dienes, for example, butadiene or isoprene, acrylonitrile, vinyl ethers, maleic acid, maleates, maleic anhydride, cinnamic acid, vinyl chloride or vinyl acetate, and copolymers thereof with other monomers. The resins may also be used as a mixture of two or more thereof.

The image forming layer of the heat transfer sheet other than the heat transfer sheet W contains the pigment preferably in an amount of from 30% by weight to 70% by weight, and more preferably in an amount of from 30% by weight to 50% by weight. Further, the image forming layer contains the resin in an amount of from 30% by weight to 70% by weight, and more preferably in an amount of 40% by weight to 70% by weight.

The image forming layer can contain the following components of (1) to (3) as the other components.

(1) Waxes

The waxes include mineral waxes, natural waxes and synthetic waxes. Examples of the mineral wax include petroleum wax, for example, paraffin wax, microcrystalline wax, ester wax or oxide wax, montan wax, ozokerite and ceresin. Above all, paraffin wax is preferred. The paraffin wax is separated from petroleum, and various kinds of the paraffin waxes depending on their melting points are commercially available.

Examples of the natural wax include plant waxes, for example, carnauba wax, Japan tallow, auricurie wax or espar wax, and animal waxes, for example, beeswax, insect wax, shellac wax or spermaceti.

The synthetic wax is ordinarily used as a lubricant, and usually comprises a higher fatty acid compound. Examples of the synthetic wax include the following.

1) Fatty Acid Wax

Straight chain saturated fatty acid represented by formula shown below is illustrated.
CH₃(CH₂)ₙCOOH
wherein n represents an integer of from 6 to 28. Specific examples thereof include stearic acid, behenic acid, palmitic acid, 12-hydroxystearic acid and azelaic acid.

The wax further includes metal salt (for example, K, Ca, Zn or Mg) of the above-described fatty acid.

2) Fatty Acid Ester Wax

Specific examples of ester of the above-described fatty acid include ethyl stearate, lauryl stearate, ethyl behenate, hexyl behenate and behenyl myristate.

3) Fatty Acid Amide Wax

Specific examples of the fatty acid amide include stearic acid amide and lauric acid amide.

4) Aliphatic Alcohol Wax

Straight chain saturated aliphatic alcohol represented by formula shown below is illustrated.
CH₃ (CH₂)ₙOH
wherein n represents an integer of from 6 to 28. Specific examples thereof include stearyl alcohol.

Of the synthetic waxes of the above 1) to 4), the higher fatty acid amide, for example, stearic acid amide or lauric acid amide is particularly suitable. The above-described wax compounds can be used individually or as a combination of two or more thereof, if desired.

(2) Plasticizers

As the plasticizers, those preferred are ester compounds, which include known plasticizers, for example, phthalates, e.g., dibutyl phthalate, di-n-octyl phthalate, di(2-ethylhexyl) phthalate, dinonyl phthalate, dilauryl phthalate, butyllauryl phthalate or butylbenzyl phthalate, aliphatic dibasic acid esters, e.g., di(2-ethylhexyl) adipate and di(2-ethylhexyl) sebacate, phosphoric trimesters, e.g., tricresyl phosphate or tri(2-ethylhexyl) phosphate, polyolpolyesters, e.g., polyethylene glycol ester, and epoxy compounds, epoxy fatty acid ester. Of these, esters of vinyl monomers, particularly esters of acrylic acid or methacrylic acid, are preferred because the addition thereof improves transfer sensitivity and provides the large effects of improving transfer unevenness and controlling breaking elongation.

The ester compounds of acrylic acid or methacrylic acid include, for example, polyethylene glycol dimethacrylate, 1,2,4-butanetriol trimethacrylate, trimethylolethane triacrylate, pentaerythritol acrylate, pentaerythritol tetraacrylate and dipentaerythritol polyacrylate.

The plasticizer may be a polymer. Above all, a polyester is preferred because it has the great addition effect and is difficult to diffuse under storage conditions. The polyester includes, for example, sebacic acid polyester and adipic acid polyester.

The above-described additives contained in the image forming layer are not limited thereto. The plasticizers may be used individually or in combination of two or more thereof.

When the amount of the above-described additive contained in the image forming layer is too large, the resolution of the transferred image is deteriorated, the film strength of the image forming layer itself is decreased, or an unexposed area is transferred to the image receiving sheet due to a reduction in adhesion between the light-to-heat converting layer and the image forming layer in some cases. From the above-described viewpoint, an amount of the wax is preferably from 0.1% by weight to 30% by weight, and more preferably from 1% by weight to 20% by weight, based on the total solid content contained in the image forming layer. An amount of the plasticizer is preferably from 0.1% by weight to 20% by weight, and more preferably from 0.1% by weight to 10% by weight, based on the total solid content contained in the image forming layer.

(3) Others

The image receiving layer may further contain a surfactant, fine inorganic or organic particles (for example, metal powder or silica gel), an oil (for example, linseed oil or mineral oil), a thickening agent and an antistatic agent, in addition to the above-mentioned components. Except for the case that a black image is obtained, energy necessary for transfer can be decrease by containing a substance absorbing the wavelength of a light source used for the image recording. The substance absorbing the wavelength of a light source may be either a pigment or a dye. For obtaining a color image, it is preferred in respect to color reproduction that an infrared light source, for example, a semiconductor laser is used for the image recording, and that a dye having low absorption in the visible region and high absorption in the wavelength of the light source is used. Examples of the near infrared dye include compounds described in JP-A-3-103476.

The image forming layer can be formed by dissolving or dispersing the pigment, the binder and the like to prepare a coating solution, coating the solution on the light-to-heat converting layer (when a heat-sensitive release layer described below is provided on the light-to-heat converting layer, coating the solution on the heat-sensitive release layer) and drying it. A solvent used for the preparation of coating solution includes n-propyl alcohol, methyl ethyl ketone, propylene glycol monomethyl ether (MFG), methanol and water. The coating and drying can be conducted according to conventional methods.

The heat-sensitive release layer can be provided on the light-to-heat converting layer of the heat transfer sheet. The heat-sensitive release layer contains a heat-sensitive material generating gas or releasing adhesive water by the action of heat generated in the light-to-heat converting layer, thereby weakening the bonding strength between the light-to-heat converting layer and the image forming layer. As such a heat-sensitive material, there can be used a compound (polymer or low molecular weight compound) which itself is decomposed or deteriorated by heat to generate gas, or a compound (polymer or low molecular weight compound) on which a considerable amount of easily volatile gas, for example, moisture absorbs or adsorbs. The heat-sensitive materials may be used in combination.

Examples of the polymer decomposed or deteriorated by heat to generate gas include a self-oxidative polymer, for example, nitrocellulose, a halogen-containing polymer, for example, chlorinated polyolefin, chlorinated rubber, polychlorinated rubber, polyvinyl chloride or polyvinylidene chloride, an acrylic polymer, for example, polyisobutyl methacrylate, on which a volatile compound, for example, moisture adsorbs, a cellulose ester, for example, ethyl cellulose on which a volatile compound, for example, moisture adsorbs and a natural polymer, for example, gelatin on which a volatile compound, for example, moisture adsorbs. Examples of the low molecular weight compound decomposed or deteriorated by heat to generate gas include a compound decomposed by heat generation to generate gas, for example, a diazo compound or an azide compound.

The decomposition or deterioration of the heat-sensitive material by heat as described above occurs preferably at a temperature of 280° C. or less, particularly preferably at a temperature of 230° C. or less.

When the low molecular weight compound is used as the heat-sensitive material of the heat-sensitive release layer, it is desirable to use the compound in combination with a binder. As the binder, there can also be used the above-described polymer which itself is decomposed or deteriorated by heat to generate gas. However, a conventional binder not having such a property can also be used. When the heat-sensitive low molecular weight compound and the binder are used in combination, a weight ratio of the former to the latter is preferably from 0.02:1 to 3:1, and more preferably from 0.05: 1 to 2: 1. It is desirable that almost the whole surface of the light-to-heat converting layer is covered with the heat-sensitive release layer, the thickness of heat-sensitive release layer is ordinarily from 0.03 μm to 1 μm, and preferably within the range of from 0.05 μm to 0.5 μm.

In the case of the heat transfer sheet in which the light-to-heat converting layer, the heat-sensitive release layer and the image forming layer are provided on the support in this order, the heat-sensitive release layer is decomposed or deteriorated by heat transmitted from the light-to-heat converting layer to generate gas. Then, the decomposition or gas generation causes the heat-sensitive release layer to partly disappear or causes cohesive failure to occur in the heat-sensitive release layer, thereby decreasing the bonding force between the light-to-heat converting layer and the image forming layer. Accordingly, depending on the behavior of the heat-sensitive release layer, a part of the heat-sensitive release layer adheres to the image forming layer, and appears on a surface of a finally formed image to cause color mixing of the image in some cases. It is therefore desirable that the heat-sensitive release layer is scarcely colored, that is, has high transparency to visible light so that no visible color mixing appears on the image formed even when such transfer of the heat-sensitive release layer occurs. Specifically, the light absorption rate of the heat-sensitive release layer is 50% or less, and preferably 10% or less, with respect to visible light.

Instead of the heat-sensitive release layer independently formed in the heat transfer sheet, the above-described heat-sensitive material may be added to a coating solution for the light-to-heat converting layer to form the light-to-heat converting layer which serves both as the light-to-heat converting layer and the heat-sensitive release layer.

The coefficient of static friction of the uppermost layer on the side of the heat transfer sheet on which the image forming layer is provided is preferably 0.35 or less, and more preferably 0.20 or less. Roll contamination in conveying the heat transfer sheet can be prevented and the image quality of the image formed can be improved by adjusting the coefficient of static friction of the uppermost layer to 0.35 or less. The coefficient of static friction is measured according to a method described in JP-A-2001-47753, paragraph (0011).

The smooster value of the surface of the image forming layer is preferably from 0.5 mmHg to 50 mmHg (approximately equal to 0.0665 kPa to 6.65 kPa) at 23° C. and 55% RH, and Ra thereof is preferably from 0.05 μm to 0.4 μm. This can decrease a large number of micro voids which prevent the image receiving layer and the image forming layer from coming contact with each other at the contact surfaces thereof, and is preferred in terms of transfer and further image quality. The above-described Ra value can be measured based on JIS B0601 using a surface roughness tester (Surfcom manufactured by Tokyo Seimitsu Co. Ltd.). The surface hardness of the image forming layer is preferably 10 g or more in terms of a sapphire needle.

When the heat transfer sheet is charged according to the Federal Government Test Standard 4046, followed by grounding of the heat transfer sheet, the charged potential of the image forming layer is preferably from −100 V to 100 V, one second after the grounding. The surface resistance of the image forming layer is preferably 10⁹Ω or less at 23° C. and 55% RH.

Now, the image receiving sheet, which can be used in combination with the above-described heat transfer sheet, is described below.

[Image Receiving Sheet]

(Layer Constitution)

The image receiving sheet usually comprises a support having provided thereon one or more image receiving layers. One or more layers of any of a cushion layer, a release layer and an intermediate layer are provided between the support and the image receiving layer, if desired. It is preferred in view of transporting property that the support has a back layer on the side opposite to the image receiving layer.

(Support)

The support includes an ordinary sheet-like base material, for example, a plastic sheet, a metal sheet, a glass sheet, resin-coated paper, paper and various composite materials. Examples of the plastic sheet include polyethylene terephthalate sheet, polycarbonate sheet, polyethylene sheet, polyvinyl chloride sheet, polyvinylidene chloride sheet, polystyrene sheet, styrene-acrylonitrile sheet and polyester sheet. As the paper, there can be used stock paper and coated paper.

It is preferred that the support has minute voids, because the image quality can be improved. Such a support can be prepared, for example, by mixing a thermoplastic resin with a filler comprising an inorganic pigment or a polymer incompatible with the above-described thermoplastic resin to prepare a mixed melt, forming the melt into a monolayer or multilayer film through a melt extruder, and stretching the film uniaxially or biaxially. In such a case, the percentage of voids is determined depending on the selection of the resin and the filler, the mixing ratio and the stretching conditions.

As the thermoplastic resin, polyolefin resin, for example, polypropylene and polyethylene terephthalate resin are preferred because of their good crystallinity, good stretchability and easy formation of voids. It is preferred that the polyolefin resin or polyethylene terephthalate resin is used as a main component, appropriately in combination with a small amount of other thermoplastic resin. As an inorganic pigment used as the filler, one having an average particle size of from 1 μm to 20 μm is preferred. Such inorganic pigment includes calcium carbonate, clay, diatomaceous earth, titanium oxide, aluminum hydroxide and silica. As the incompatible resin used as the filler, when polypropylene is used as the thermoplastic resin, polyethylene terephthalate is preferably used as the filler in combination. Details of the support having minute voids are described in JP=A-2001-105752.

The content of the filler, for example, the inorganic pigment in the support is ordinarily from about 2% to about 30% by volume.

The thickness of the support of the image receiving sheet is ordinarily from 10 μm to 400 μm, and preferably from 25 μm to 200 μm. A surface of the support may be subjected to surface treatment, for example, corona discharge treatment and glow discharge treatment for enhancing adhesion to the image receiving layer (or the cushion layer) or adhesion to the image forming layer of the heat transfer sheet.

(Image Receiving Layer)

For transferring the image forming layer onto a surface of the image receiving sheet and fixing it, one or more image receiving layers are preferably provided on the support thereof. The image receiving layer is preferably a layer mainly composed of an organic polymer binder. The binder is preferably a thermoplastic resin. Examples thereof include homopolymers and copolymers of acrylic monomers, for example, acrylic acid, methacrylic acid, acrylates or methacrylates, cellulose polymers, for example, methyl cellulose, ethyl cellulose or cellulose acetate, homopolymers and copolymers of vinyl monomers, for example, polystyrene, polyvinylpyrrolidone, polyvinyl butyral, polyvinyl alcohol and polyvinyl chloride, condensation polymers, for example, polyesters and polyamides, and rubber polymers, for example, butadiene-styrene copolymers. The binder of the image receiving layer is preferably a polymer having a glass transition temperature (Tg) of 90° C. or less for obtaining the proper adhesion between the image receiving layer and the image forming layer. For such a purpose, it is also possible to add a plasticizer to the image receiving layer. Further, it is preferred that the binder polymer has a Tg of 30° C. or more for preventing blocking between the sheets. As the binder polymer of the image receiving layer, a polymer same as or similar to the binder polymer of the image forming layer is particularly preferably used in view of improvement in adhesion with the image forming layer at the laser recording and improvement in sensitivity and image strength.

The smooster value of the surface of the image receiving layer is preferably from 0.5 mmHg to 50 mmHg (approximately equal to 0.0665 kPa to 6.65 kPa) at 23° C. and 55% RH, and Ra is preferably from 0.05 μm to 0.4 μm. This can decrease a large number of micro voids which prevent the image receiving layer and the image forming layer from coming contact with each other at contact surfaces thereof, and is preferred in view of transfer and further image quality. The above-described Ra value can be measured based on JIS B0601 using a surface roughness tester (Surfcom manufactured by Tokyo Seimitsu Co. Ltd.). When the image receiving sheet is charged according to the Federal Government Test Standard 4046, followed by grounding of the image receiving sheet, the charged potential of the image receiving layer is preferably from −100 V to 100 V, one second after the grounding. The surface resistance of the image receiving layer is preferably 10⁹Ω or less at 23° C. and 55% RH. The coefficient of static friction of the surface of the image receiving layer is preferably 0.2 or less. The surface energy of the surface of the image receiving layer is preferably from 23 mg/m² to 35 mg/m².

When the image once formed on the image receiving layer is transferred again to stock paper, it is also preferred that at least one image receiving layer is formed of a photo-curing material. The composition of such a photo-curing material include, for example, a combination of a) a photopolymerizable monomer comprising at least one multifunctional vinyl or vinylidene compound which can form a photopolymer by addition polymerization, b) an organic polymer, c) a photopolymerization initiator, and an additive, for example, a thermopolymerization inhibitor, if desired. As the multifunctional vinyl monomer, there is used an unsaturated ester of a polyol, particularly an acrylate or methacrylate (for example, ethylene glycol diacrylate or pentaerythritol tetraacrylate).

The organic polymer includes the above-described polymer for forming the image receiving layer. As the photopolymerization initiator, a conventional photoradical polymerization initiator, for example, benzophenone or Michler's ketone is used in an amount of from 0.1% by weight to 20% by weight in the layer.

The thickness of the image receiving layer is ordinarily from 0.3 μm to 7 μm, and preferably 0.7 μm to 4 μm. In the case of the thickness of 0.3 μm or more, the film strength is secured when the image is transferred again to stock paper. Adjustment of the thickness to 4 μm or less lowers the glossiness of the image transferred again to the stock paper, thereby improving the approximation to printed matter.

(Other Layers)

A cushion layer may be provided between the support and the image receiving layer. The use of the cushion layer improves the adhesion between the image forming layer and the image receiving layer at the laser heat transfer to improve image quality. Further, even when foreign matter enters between the heat transfer sheet and the image receiving sheet at the recording, the clearance between the image receiving layer and the image forming layer is decreased by the deformation action of the cushion layer. As a result, the size of an image defect, for example, a white spot can also be decreased. Furthermore, when the image formed by transfer is transferred again, for example, to stock paper separately prepared, the image receiving surface is deformed depending on the uneven surface of the paper, so that the transferring property of the image receiving layer can be improved, and the approximation to printed matter can also be improved by lowering the glossiness of the image transferred.

The cushion layer is easily deformable when the image receiving layer is stressed. For achieving the above-described effect, the cushion layer is preferably formed of a material having low elasticity, a material having rubber elasticity or a thermoplastic resin easily softened by heating. The elasticity of the cushion layer is preferably from 0.5 MPa to 1.0 GPa, more preferably from 1 MPa to 0.5 GPa, and still more preferably 10 MPa to 100 MPa, at room temperature. Further, for allowing foreign matter, for example, dust to sink into the cushion layer, the penetration (25° C., 100 g, 5 seconds) defined by JIS K2530 is preferably 10 or more. Furthermore, the glass transition temperature of the cushion layer is ordinarily 80° C. or less, and preferably 25° C. or less. The softening point thereof is preferably from 50° C. to 200° C. For controlling these properties, for example, Tg, it is also suitable to add a plasticizer to the binder.

Specific materials used as the binder of the cushion layer include polyethylene, polypropylene, polyesters, styrene-butadiene copolymers, ethylene-vinyl acetate copolymers, ethylene-acrylic copolymers, vinyl chloride-vinyl acetate copolymers, vinylidene chloride resins, plasticizer-containing vinyl chloride resins, polyamide resins and phenol resins, as well as rubbers, for example, urethane rubber, butadiene rubber, nitrile rubber, acrylic rubber or natural rubber.

Although the thickness of the cushion layer varies depending on the resin used and other conditions, it is ordinarily from 3 μm to 100 μm, and preferably from 10 μm to 52 μm.

The image receiving layer and the cushion layer are required to be adhered to each other until the step of laser recording. However, for transferring the image to the stock paper, they are preferably releasable from each other. For making the release easy, it is also preferred that a release layer having a thickness of from about 0.1 μm to about 2 μm is provided between the cushion layer and the image receiving layer. Too thick a layer thickness results in the difficulty of exhibiting the performance of the cushion layer, so that the thickness is necessary to adjust depending on the kind of release layer.

Specific examples of binder for the release layer include polyolefin, polyesters, polyvinyl acetal, polyvinyl formal, polyparabanic acid, polymethyl methacrylate, polycarbonates, ethyl cellulose, nitrocellulose, methyl cellulose, carboxymethyl cellulose, hydroxypropyl cellulose, polyvinyl alcohol, polyvinyl chloride, urethane resins, fluororesins, polystyrene, styrene derivatives, for example, acrylonitrilestyrene, and crosslinked products of these resins, thermosetting resins having a Tg of 65° C. or more, for example, polyamides, polyimides, polyether imide polysulfones, polyethersulfones or alamids, and cured products of these resins. As a curing agent, there can be used a conventional curing agent, for example, isocyanate or melamine.

When the binder for the release layer is selected according to the above-described properties, polycarbonate, acetal and ethyl cellulose are preferred in view of preservability, and in the case of using an acrylic resin in the image receiving layer these binder are particularly preferred, because the releasability is improved at the retransfer of the image after the laser heat transfer.

Separately, a layer extremely decreased in the adhesion with the image receiving layer upon cooling can be utilized as the release layer. Specifically, a layer mainly composed of a heat-meltable compound or a thermoplastic resin, for example, wax or binder can be used.

The heat-meltable compound includes substances described in JP-A-63-193886. In particular, microcrystalline wax, paraffin wax and carnauba wax are preferably used. As the thermoplastic resins, there are preferably used ethylenic copolymers, for example, ethylene-vinyl acetate resin, and cellulose resins.

A higher fatty acid, a higher alcohol, a higher fatty acid ester, an amide or a higher amine can be added as an additive to the release layer, if desired.

Another constitution of the release layer is a layer having releasability by cohesive failure of itself caused by melting or softening at the heating. It is preferred that a supercooling material is added to such a release layer.

The supercooling material includes poly-ε-caprolactone, polyoxyethylene, benzotriazole, tribenzylamine and vanillin.

Further, in still another constitution of the release layer, a compound decreasing the adhesion with the image receiving layer is contained. Such a compound includes silicone resins, for example, silicone oil; fluororesins, for example, Teflon or fluorine-containing acrylic resin; polysiloxane resins; acetal resins, for example, polyvinyl butyral, polyvinyl acetal or polyvinyl formal; solid waxes, for example, polyethylene wax or amide wax; and surfactants of fluorine type or phosphate type.

As to methods for forming the release layer, the above-described materials are dissolved or dispersed in the latex form in a solvent, and coated on the cushion layer by a coating method, for example, blade coating, roll coating, bar coating, curtain coating or gravure coating, or extrusion lamination by hot melt. Alternatively, the above-described materials are dissolved or dispersed in the latex form in a solvent, and coated on a temporary base by the above-described method, and then the cushion layer is laminated therewith, followed by separation of the temporary base to form the release layer.

In the image receiving sheet combined with the heat transfer sheet, the image receiving layer may also serve as the cushion layer. In such a case, the image receiving sheet may have the constitution of a support/a cushioning image receiving layer, or a support/an undercoat layer/a cushioning image receiving layer. Also in such a case, it is preferred that the cushioning image receiving layer is provided releasably so that the image can be transferred again to the stock paper. Thus, the image retransferred to the stock paper is excellent in glossiness.

The thickness of the cushioning image receiving layer is ordinarily from 5 μm to 100 μm, and preferably from 10 μm to 40 μm.

It is preferred that the image receiving sheet is provided with a back layer on the side opposite to the face on which the image receiving layer is formed, because the transporting property of the image receiving sheet is improved. For improving the transporting property in the recording device, it is preferred that an antistatic agent, for example, a surfactant or fine tin oxide particles or a matting agent, for example, silicon oxide or PMMA particles is added to the back layer.

The above-described additive can be added not only to the back layer, but also to the image receiving layer and other layers, if desired. The kind of additive cannot be defined definitely depending on the purpose thereof. For example, in the case of the matting agent, particles having an average particle size of from 0.5 μm to 10 μm can be added to the layer in an amount of from about 0.5% by weight to 80% by weight. The antistatic agent can be selected from various surfactants and conductive agents so as to give a layer surface resistance of 10¹²Ω or less, preferably 10⁹Ω or less, at 23° C. and 50% RH.

Binder used for the back layer includes conventional polymers, for example, gelatin, polyvinyl alcohol, methyl cellulose, nitrocellulose, acetyl cellulose, an aromatic polyamide resin, a silicone resin, an epoxy resin, an alkyd resin, a phenol resin, a melamine resin, a fluorocarbon resin, a polyimide resin, a urethane resin, an acrylic resin, a urethane-modified silicone resin, a polyethylene resin, a polypropylene resin, a polyester resin, a Teflon resin, a polyvinyl butyral resin, a vinyl chloride resin, polyvinyl acetate, a polycarbonate, an organic boron compound, an aromatic ester, fluorinated polyurethane and a polyethersulfone.

It is effective for prevention of powdering of the matting agent and improvement in scratch resistance of the back layer that a crosslinkable water-soluble binder is used as the binder for the back layer and crosslinked. This also has the large effect of preventing blocking during storage.

As the crosslinking means, any one of heat, active ray and pressure or a combination thereof can be employed without particular limitation depending on the characteristics of the crosslinking agent used. Depending on the circumstances, any adhesive layer may be provided on the back layer side of the support for imparting the adhesion to the support.

As the matting agent preferably added to the back layer, there can be used fine organic or inorganic particles. The organic matting agent includes fine particles of polymethyl methacrylate (PMMA), polystyrene, polyethylene, polypropylene and other radical polymerization polymers, and fine particles of condensation polymers, for example, a polyester and a polycarbonate.

The back layer is preferably provided in an amount of from 0.5 g/m² to 5 g/m². The amount less than 0.5 g/m² results in unstable coating property to be liable to cause the problem of powdering of the matting agent. On the other hand, the amount largely exceeding 5 g/m² results in the extremely large particle size of the suitable matting agent. Consequently, a surface of the image forming layer is embossed by the back layer in storage, so that particularly, in heat transfer in which the thin image forming layer is transferred, a blank area and unevenness of the recorded image become liable to occur.

The number average particle size of the matting agent is preferably 2.5 μm to 20 μm larger than the film thickness of the back layer composed of the binder alone. The matting agent is required to contain particles having a particle size of 8 μm or more in an amount of 5 mg/m² or more, preferably in an amount of from 6 mg/m² to 600 mg/m², thereby particularly improving the foreign matter failure. The use of the particles having such a narrow particle size distribution that the value of the standard deviation of the particle size distribution divided by the number average particle size (σ/rn, the coefficient of variation of particle distribution) is 0.3 or less can improve defects caused by particles having an abnormally large particle size, and moreover, provides the desired performance with the less amount thereof added. The coefficient of variation is more preferably 0.15 or less.

An antistatic agent is preferably added to the back layer for preventing the adhesion of foreign matter caused by frictional electrification with the conveying roll. As the antistatic agent, there are widely used compounds described in Chemical Commercial Products of 11290, pages 875 to 876, Kagaku Kogyo Nipposha, as well as cationic surfactants, anionic surfactants, nonionic surfactants, polymer antistatic agents and fine conductive particles.

Of the above-described materials, fine conductive particles of carbon black, metal oxides, for example, zinc oxide, titanium oxide or tin oxide, and organic semiconductors are preferably used as the antistatic agent in the back layer. In particular, the use of the fine conductive particles is preferred because the antistatic agent is not dissociated from the back layer, and the stable antistatic effect is obtained regardless of the circumstances.

It is also possible to add a releasing agent, for example, various surfactants, silicone oil and fluororesin to the back layer for imparting coating property and releasability.

The use of the back layer having the softening point at least 70° C. lower than that of the cushion layer and the image receiving layer, measured by the TMA (thermomechanical analysis) is particularly preferred.

The TMA softening point is determined by observing a phase of a sample to be measured, elevating the temperature of the sample while loading a definite load at a definite rate of temperature rise. In the invention, the temperature at which the phase of the sample to be measured starts to change is defined as the TMA softening point. The measurement of the softening point by the TMA can be made by use of a device, for example, Thermoflex manufactured by Rigaku Corp.

The heat transfer sheet is overlaid with the image receiving sheet, allowing the image forming layer of the heat transfer sheet to face toward the image receiving layer of the image receiving sheet, to form a laminate which is utilized for the image formation.

The laminate of the heat transfer sheet and the image receiving sheet can be formed by various methods. For example, the heat transfer sheet is overlaid with the image receiving sheet, allowing the image forming layer of the heat transfer sheet to face toward the image receiving layer of the image receiving sheet, and passed through heated pressure rolls, thereby easily obtaining the laminate. In such a case, the heating temperature is preferably 160° C. or less, more preferably 130° C. or less.

As another method for obtaining the laminate, the above-described vacuum adhesion method is also preferably used. The vacuum adhesion method is a method in which the image receiving sheet is first wound around a drum provided with suction holes for vacuum suction, and then, the heat transfer sheet having a size somewhat larger than that of the image receiving sheet is vacuum adhered to the image receiving sheet while uniformly ejecting air by a squeeze roller. As still another method, there is a method in which the image receiving sheet is mechanically adhered onto a metal drum with stretching, and the heat transfer sheet is further similarly mechanically adhered onto it with stretching. Of these methods, the vacuum adhesion method is particularly preferred, because no temperature control of heat rolls is required, and rapid and uniform lamination is easily performed.

### EMBODIMENT

The invention will be described in more detail with reference to the following examples below, but the invention should not be construed as being limited thereto. The term “part” as used herein means a part by weight, unless otherwise indicated.

### EXAMPLE 101

-Preparation of Heat Transfer Sheet W (White)-

[Preparation of Back Layer]

[Preparation of Coating Solution for First Back Layer]

| | | |
|---|---|---|
| Aqueous Dispersion of Acrylic Resin | 2 | parts |
| (Jurimer ET410, solid content: 20% by weight, | | |
| manufactured by Nippon Junyaku Co., Ltd.) | | |
| Antistatic Agent | 7.0 | parts |
| (An aqueous dispersion of tin oxide-antimony oxide, | | |
| average particle size: 0.1 μm, 17% by weight) | | |
| Polyoxyethylene Phenyl Ether | 0.1 | part |
| Melamine Compound | 0.3 | parts |
| (Sumitex Resin M-3, manufactured by Sumitomo Chemical | | |
| Co., Ltd.) | | |
| Distilled Water to make | 100 | parts |

[Formation of First Back Layer]

Corona treatment was conducted on one face (back surface) of a biaxially stretched polyethylene terephthalate support having a thickness of 75 μm (Ra on both surfaces is 0.01 μm), and the coating solution for first back layer was applied thereto so as to give a dry layer thickness of 0.03 μm, followed by drying at 180° C. for 30 seconds to form a first back layer. The support has a longitudinal Young's modulus of 450 kg/mm² (approximately equal to 4.4 GPa) and a lateral Young's modulus of 500 kg/mm² (approximately equal to 4.9 GPa). The support has a longitudinal F-5 value of 10 kg/mm² (approximately equal to 98 MPa) and a lateral F-5 value of 13 kg/mm² (approximately equal to 127.4 MPa). The degrees of heat shrinkage of the support in longitudinal and lateral directions at 100° C. for 30 minutes are 0.3% and 0.1%, respectively. The longitudinal breaking strength is 20 kg/mm² (approximately equal to 196 MPa), the lateral breaking strength is 25 kg/mm² (approximately equal to 245 MPa), and the elasticity is 400 kg/mm² (approximately equal to 3.9 GPa).

[Preparation of Coating Solution for Second Back Layer]

| | | |
|---|---|---|
| Polyolefin | 3.0 | parts |
| (Chemipearl S-120, 27% by weight, manufactured by | | |
| Mitsui Petrochemical Industries, Ltd.) | | |
| Antistatic Agent | 2.0 | parts |
| (An aqueous dispersion of tin oxide-antimony oxide, | | |
| average particle size: 0.1 μm, 17% by weight) | | |
| Colloidal Silica | 2.0 | parts |
| (Snowtex C, 20% by weight, manufactured by Nissan | | |
| Chemical Industries, Ltd.) | | |
| Epoxy Compound | 0.3 | parts |
| (Dinacol EX-614B, manufactured by Nagase Kasei Co., | | |
| Ltd.) | | |
| Distilled Water to make | 100 | parts |

[Formation of Second Back Layer]

The coating solution for second back layer was applied onto the first back layer so as to give a dry layer thickness of 0.03 μm, followed by drying at 170° C. for 30 seconds to form a second back layer.

[Formation of Light-To-Heat Converting Layer]

[Preparation of Coating Solution for Light-To-Heat Converting Layer]

The following respective components were mixed with stirring by a stirrer to prepare a coating solution for light-to-heat converting layer.

[Composition of Coating Solution for
Light-To-Heat Converting Layer]

| | | |
|---|---|---|
| Infrared Absorption Dye | 7.6 | parts |
| (Compound (I-17) represented by formula (B)) | | |
| Polyamideimide | 29.3 | parts |
| (Compound represented by formula (A), wherein R | | |
| represents a divalent connecting group represented by | | |
| (6)) | | |
| N-Methylpyrrolidone (NMP) | 1,500 | parts |
| Methyl Ethyl Ketone | 360 | parts |
| Surfactant | 0.5 | parts |
| (Megafac F-176PF, manufactured by Dainippon Ink & | | |
| Chemicals Inc., fluorine-containing surfactant) | | |
| Matting Agent Dispersion shown below | 14.1 | parts |

[Preparation of Matting Agent Dispersion]

Ten parts of fine spherical silica particles having an average particle size of 1.5 μm (Seahoster KE-P150, manufactured by Nippon Shokubai Kagaku Kogyo Co., Ltd.), 2 parts of a dispersing agent polymer (an acrylate-styrene copolymer, Juncril 611, manufactured by Johnson Polymer Co., Ltd.), 16 parts of methyl ethyl ketone and 64 parts of N-methylpyrrolidone were mixed, and the resulting mixture and 30 parts of glass beads having a diameter of 2 mm were placed in a polyethylene container having a volume of 200 ml, followed by dispersing for 2 hours using a paint shaker (manufactured by Toyoseikiseisaku-sho, Ltd.) to obtain a dispersion of fine silica particles.

[Formation of Light-To-Heat Converting Layer on Surface of Support]

The coating solution for light-to-heat converting layer prepared above was applied onto one surface of a 75-μm thick polyethylene terephthalate film (support) with a wire bar, followed by drying in an oven at 120° C. for 2 minutes to form a light-to-heat converting layer on the support. The optical density of the resulting light-to-heat converting layer at a wavelength of 808 nm was measured by an UV spectrophotometer, UV-240, manufactured by Shimadzu Corp. As a result, the optical density (OD) was 0.93. Observation of a cross section of the light-to-heat converting layer under a scanning electron microscope showed that the layer thickness was 0.3 μm on average.

[Formation of Image Forming Layer]

[Preparation of Coating Solution for White Image Forming Layer]

The following respective components were placed in a mill of a kneader, and a shear force was applied thereto while adding a small amount of a solvent to conduct dispersion pre-treatment. The solvent was further added to the resulting dispersion to adjust so as to finally give the following composition, followed by sand mill dispersion for 2 hours to obtain white pigment dispersion W1.

[Composition of White Pigment Dispersion W1]

| | | |
|---|---|---|
| Titanium Oxide (TiO₂, particle size: 0.3 μm) | 112 | parts |
| Polyvinyl Butyral | 30.8 | parts |
| (Esreck B BL-SH, manufactured by Sekisui Chemical | | |
| Co., Ltd.) | | |
| n-Propyl Alcohol | 252.7 | parts |

The following components were mixed with stirring by a
stirrer to prepare a coating solution for white image
forming layer.

[Composition of Coating Solution for White Image
Forming Layer]

| | | |
|---|---|---|
| n-Propyl Alcohol | 836.94 | parts |
| Methyl Ethyl ketone | 288.55 | parts |
| Wax Compounds | | |
| (Stearic acid amide, Newtron 2, manufactured by Nippon | 1.36 | parts |
| Fine Chemical Co., Ltd.) | | |
| (Behenic acid amide, Diamid B45, manufactured by | 1.36 | parts |
| Nippon Kasei Chemical Co., Ltd.) | | |
| (Lauric acid amide, DiamidY, manufactured by | 1.36 | parts |
| Nippon Kasei Chemical Co., Ltd.) | | |
| (Palmitic acid amide, Diamid KP, manufactured by | 1.36 | parts |
| Nippon Kasei Chemical Co., Ltd.) | | |
| (Oleic acid amide, Diamid O-200, manufactured by | 1.36 | parts |
| Nippon Kasei Chemical Co., Ltd.) | | |
| (Erucic acid amide, Diamid L-200, manufactured by | 1.36 | parts |
| Nippon Kasei Chemical Co., Ltd.) | | |
| Rosin | 3.94 | parts |
| (KE-311, manufactured by Arakawa Kagaku Co., Ltd., | | |
| component: resin acid 80-97%; resin acid component: | | |
| abietic acid 30-40%, neoabietic acid 10-20%, | | |
| dihydroabietic acid 14%, tetrahydroabietic acid 14%) | | |
| Pigment Dispersion W1 | 358.13 | parts |

[Formation of White Image Forming Layer on Surface of Light-To-Heat Converting Layer]
By the above-described process, a heat trans The coating solution for white image forming layer prepared above was applied onto a surface of the light-to-heat converting layer with a wire bar to prepare a coated product, and the coated product was left for 1 minute, followed by drying of the coated product in an oven at 100° C. for 2 minutes to form a white image forming layer on the light-to-heat converting layer. fer sheet W was prepared in which the light-to-heat converting layer and the white image forming layer were provided on the support in this order.

The thickness of the white image forming layer of the heat transfer sheet W measured was 2.3 μm on average. The optical density of the image forming layer measured by X-rite 938 manufactured by X-rite inc. was 0.3.

-Preparation of Image Receiving Sheet-

A coating solution for cushion layer and a coating solution for image receiving layer each having the following compositions were prepared.

1) Coating Solution for Cushion Layer

| | | |
|---|---|---|
| Vinyl Chloride-Vinyl Acetate Copolymer | 20 | parts |
| (Main binder, MPR-TSL, manufactured by Nissin Chemical | | |
| Industry Co., Ltd.) | | |
| plasticizer | 10 | parts |
| (Paraplex G-40, manufactured by CP. HALL. COMPANY) | | |
| Surfactant (fluorine-containing: coating aid) | 0.5 | parts |
| (Megafac F-177, manufactured by Dainippon Ink & | | |
| Chemicals Inc.) | | |
| Antistatic Agent (quaternary ammonium salt) | 0.3 | parts |
| (SAT-5 Supper (IC), manufactured by Nippon Junyaku Co., | | |
| Ltd.) | | |
| Methyl Ethyl Ketone | 60 | parts |
| Toluene | 10 | parts |
| N,N-Dimethylformamide | 3 | parts |

2) Coating Solution for Image Receiving Layer

| | | |
|---|---|---|
| Polyvinyl Butyral | 8 | parts |
| (Esreck B BL-SH, manufactured by Sekisui Chemical Co., | | |
| Ltd.) | | |
| Antistatic Agent | 0.7 | parts |
| (Sanstat 2012A, manufactured by Sanyo Chemical Industries, | | |
| Ltd.) | | |
| Surfactant | 0.1 | part |
| (Megafac F-176PF, manufactured by Dainippon Ink & | | |
| Chemicals Inc.) | | |
| n-Propyl Alcohol | 20 | parts |
| Methanol | 20 | parts |
| 1-Methoxy-2-propanol | 50 | parts |

The coating solution for cushion layer described above was applied onto a white PET support (Lumirror #130E58, manufactured by Toray Industries Inc., thickness: 130 μm) with a narrow coater, and the coated layer was dried. Then, the coating solution for image receiving layer was applied thereto, followed by drying. The amounts coated were adjusted so as to give a layer thickness of 20 μm after drying for the cushion layer, and a layer thickness of 2 μm after drying for the image receiving layer. The white PET support was a void-containing plastic support comprising a laminate (total thickness: 130 μm, specific gravity: 0.8) in which a void-containing polyethylene terephthalate layer (thickness: 116μ, void ratio: 20%) was laminated with titanium oxide-containing polyethylene terephthalate layers (thickness: 7 μm, titanium oxide content: 2%) on both sides thereof. The image receiving material thus prepared was wound in the roll form, and stored at room temperature for 1 week. Then, the image receiving material was used for the image recording using a laser beam as described below.

The properties of the resulting image forming layer were as follows.

The surface roughness Ra is preferably from 0.01 μm to 0.4 μm, and specifically, it was 0.02 μm.

The undulation of the surface of the image receiving layer is preferably 2 μm or less, and specifically, it was 1.2 μm.

The smooster value of the surface of the image receiving layer is preferably from 0.5 mmHg to 50 mmHg (approximately equal to 0.0665 kPa to 6.65 kPa) at 23° C. and 55% RH, and specifically, it was 0.8 mmHg (approximately equal to 0.11 kPa).

The coefficient of static friction of the surface of the image receiving layer is preferably 0.8 or less, and specifically, it was 0.37.

The surface energy of the image receiving layer was 29 mJ/m². The contact angle of water was 85 degrees.

### EXAMPLE 102

A heat transfer sheet W and an image receiving sheet were prepared in the same manner as in Example 101 except that the composition of coating solution for image forming layer of the transfer sheet W of Example 101 to the composition shown below. The thickness of the image forming layer of the transfer sheet W was 1.5 μm, and the optical density thereof was 0.8.

[Composition of White Pigment Dispersion W2]

| | | |
|---|---|---|
| Titanium Oxide (TiO₂, particle size: 0.15 μm) | 112 | parts |
| Polyvinyl Butyral | 30.8 | parts |
| (Esreck B BL-SH, manufactured by Sekisui Chemical Co., | | |
| Ltd.) | | |
| n-Propyl Alcohol | 252.7 | parts |

[Composition of Coating Solution for White Image Forming Layer]

| | |
|---|---|
| n-Propyl Alcohol | 836.94 parts |
| Methyl Ethyl ketone | 288.55 parts |
| Wax Compounds | |
| (Stearic acid amide, Newtron 2, manufactured by Nippon | 1.36 parts |
| Fine Chemical Co., Ltd.) | |
| (Behenic acid amide, Diamid B45, manufactured by | 1.36 parts |
| Nippon Kasei Chemical Co., Ltd.) | |
| (Lauric acid amide, DiamidY, manufactured by Nippon | 1.36 parts |
| Kasei Chemical Co., Ltd.) | |
| (Palmitic acid amide, Diamid KP, manufactured by | 1.36 parts |
| Nippon Kasei Chemical Co., Ltd.) | |
| (Oleic acid amide, Diamid O-200, manufactured by | 1.36 parts |
| Nippon Kasei Chemical Co., Ltd.) | |
| (Erucic acid amide, Diamid L-200, manufactured by | 1.36 parts |
| Nippon Kasei Chemical Co., Ltd.) | |
| Rosin | 3.94 parts |
| (KE-311, manufactured by Arakawa Kagaku Co., Ltd., | |
| component: resin acid 80-97%; resin acid component: | |
| abietic acid 30-40%, neoabietic acid 10-20%, | |
| dihydroabietic acid 14%, tetrahydroabietic acid 14%) | |
| Pigment Dispersion W2 | 358.13 parts |

### EXAMPLE 103

The composition of coating solution for image forming layer of the transfer sheet W of Example 101 was changed to the composition shown below.

[Composition of White Pigment Dispersion W3]

| | |
|---|---|
| Titanium Oxide (TiO₂, particle size: 0.15 μm) | 112 parts |
| Polyvinyl Butyral | 30.8 parts |
| (Esreck B BL-SH, manufactured by Sekisui Chemical | |
| Co., Ltd.) | |
| n-Propyl Alcohol | 252.7 parts |

[Composition of Coating Solution for White Image
Forming Layer]

| | |
|---|---|
| n-Propyl Alcohol | 836.94 parts |
| Methyl Ethyl ketone | 288.55 parts |
| Wax Compounds | |
| (Stearic acid amide, Newtron 2, manufactured by Nippon | 1.36 parts |
| Fine Chemical Co., Ltd.) | |
| (Behenic acid amide, Diamid B45, manufactured by | 1.36 parts |
| Nippon Kasei Chemical Co., Ltd.) | |
| (Lauric acid amide, DiamidY, manufactured by Nippon | 1.36 parts |
| Kasei Chemical Co., Ltd.) | |
| (Palmitic acid amide, Diamid KP, manufactured by | 1.36 parts |
| Nippon Kasei Chemical Co., Ltd.) | |
| (Oleic acid amide, Diamid O-200, manufactured by | 1.36 parts |
| Nippon Kasei Chemical Co., Ltd.) | |
| (Erucic acid amide, Diamid L-200, manufactured by | 1.36 parts |
| Nippon Kasei Chemical Co., Ltd.) | |
| Rosin | 3.94 parts |
| (KE-311, manufactured by Arakawa Kagaku Co., Ltd., | |
| component: resin acid 80-97%; resin acid component: | |
| abietic acid 30-40%, neoabietic acid 10-20%, | |
| dihydroabietic acid 14%, tetrahydroabietic acid 14%) | |
| Pigment Dispersion W3 | 358.13 parts |

Further, a coating solution prepared by diluting an ionomer resin (Chemipearl S-100, manufactured by Mitsui Chemicals Inc.) with ion-exchanged water was applied onto the light-to-heat converting layer with a wire bar, followed by drying at 120° C. for 2 minutes to from an intermediate layer (layer thickness: 0.2 μm). On the intermediate layer, the image forming layer having the composition described above was provided. The thickness of the image forming layer of the transfer sheet W was 1.5 μm, and the optical density thereof was 0.8.

A heat transfer sheet W and an image receiving sheet were prepared in the same manner as in Example 101 except for the above.

### COMPARATIVE EXAMPLE 101

A heat transfer sheet W and an image receiving sheet were prepared in the same manner as in Example 101 except that the composition of coating solution for image forming layer of the transfer sheet W of Example 101 to the composition shown below. The thickness of the image forming layer of the transfer sheet W was 2.7 μm, and the optical density thereof was 1.2.

[Composition of White Pigment Dispersion W3]

| | | |
|---|---|---|
| Titanium Oxide (TiO₂, particle size: 0.5 μm) | 112 | parts |
| Polyvinyl Butyral | 30.8 | parts |
| (Esreck B BL-SH, manufactured by Sekisui | | |
| Chemical Co., Ltd.) | | |
| n-Propyl Alcohol | 252.7 | parts |

[Composition of Coating Solution for White Image Forming Layer]

| | | |
|---|---|---|
| n-Propyl Alcohol | 836.94 | parts |
| Methyl Ethyl ketone | 288.55 | parts |
| Wax Compounds | | |
| (Stearic acid amide, Newtron 2, manufactured by Nippon | 1.36 | parts |
| Fine Chemical Co., Ltd.) | | |
| (Behenic acid amide, Diamid B45, manufactured | 1.36 | parts |
| by Nippon Kasei Chemical Co., Ltd.) | | |
| (Lauric acid amide, Diamid Y, manufactured | 1.36 | parts |
| by Nippon Kasei Chemical Co., Ltd.) | | |
| (Palmitic acid amide, Diamid KP, manufactured | 1.36 | parts |
| by Nippon Kasei Chemical Co., Ltd.) | | |
| (Oleic acid amide, Diamid O-200, manufactured | 1.36 | parts |
| by Nippon Kasei Chemical Co., Ltd.) | | |
| (Erucic acid amide, Diamid L-200, manufactured | 1.36 | parts |
| by Nippon Kasei Chemical Co., Ltd.) | | |
| Rosin | 3.94 | parts |
| (KE-311, manufactured by Arakawa Kagaku Co., Ltd., | | |
| component: resin acid 80-97%; resin acid component: | | |
| abietic acid 30-40%, neoabietic acid 10-20%, | | |
| dihydroabietic acid 14%, tetrahydroabietic acid 14%) | | |
| Pigment Dispersion W3 | 358.13 | parts |

In addition to the image forming materials of each of the examples and comparative example, transfer sheet Y (yellow), transfer sheet M (magenta), transfer sheet C (cyan) and transfer sheet K (black) shown below were prepared.

-Preparation of Heat Transfer Sheet Y-

Heat transfer sheet Y was prepared in the same manner as in the preparation of heat transfer sheet W described in Example 101 except that a coating solution for yellow image forming layer having the composition shown below was used in place of the coating solution for white image forming layer. The image forming layer of heat transfer sheet Y thus obtained had a layer thickness of 0.42 μm.

[Composition of Yellow Pigment Dispersion Mother Liquor]
Yellow Pigment Composition 1:

| | | |
|---|---|---|
| Polyvinyl Butyral | 7.1 | parts |
| (Esreck B BL-SH, manufactured by Sekisui Chemical Co., | | |
| Ltd.) | | |
| Pigment Yellow 180 (C.I. No. 21290) | 12.9 | parts |
| (Novoperm Yellow P-HG, manufactured by | | |
| Clariant Japan K.K.) | | |
| Pigment Dispersant | 0.6 | parts |
| (Solsperse S-20000, manufactured by I.C.I.) | | |
| n-Propyl Alcohol | 79.4 | parts |

Yellow Pigment Composition 2:

| | | |
|---|---|---|
| Polyvinyl Butyral | 7.1 | parts |
| (Esreck B BL-SH, manufactured by Sekisui Chemical Co., | | |
| Ltd.) | | |
| Pigment Yellow 139 (C.I. No. 56298) | 12.9 | parts |
| (Novoperm Yellow M2R 70, manufactured by | | |
| Clariant Japan K.K.) | | |
| Pigment Dispersant | 0.6 | parts |
| (Solsperse S-20000, manufactured by I.C.I.) | | |
| n-Propyl Alcohol | 79.4 | parts |

[Composition of Coating Solution for Yellow Image Forming Layer].

| | | |
|---|---|---|
| Above-Described Yellow Pigment Dispersion Mother | 126 | parts |
| Liquor | | |
| (Yellow pigment composition 1:Yellow pigment | | |
| composition 2 = 95:5 (parts)) | | |
| Polyvinyl Butyral | 4.6 | parts |
| (Esreck B BL-SH, manufactured by Sekisui Chemical Co., | | |
| Ltd.) | | |
| Wax Compounds | | |
| (Stearic acid amide, Newtron 2, manufactured by Nippon | 0.7 | parts |
| Fine Chemical Co., Ltd.) | | |
| (Behenic acid amide, Diamid BM, manufactured by Nippon | 0.7 | parts |
| Kasei Chemical Co., Ltd.) | | |
| (Lauric acid amide, Diamid Y, manufactured by Nippon | 0.7 | parts |
| Kasei Chemical Co., Ltd.) | | |
| (Palmitic acid amide, Diamid KP, manufactured by Nippon | 0.7 | parts |
| Kasei Chemical Co., Ltd.) | | |
| (Erucic acid amide, Diamid L-200, manufactured by | 0.7 | parts |
| Nippon Kasei Chemical Co., Ltd.) | | |
| (Oleic acid amide, Diamid O-200, manufactured by Nippon | 0.7 | parts |
| Kasei Chemical Co., Ltd.) | | |
| Nonionic Surfactant | 0.4 | parts |
| (Chemistat 1100, manufactured by Sanyo Chemical | | |
| Industries, Ltd.) | | |
| Rosin | 2.4 | parts |
| (KE-311, manufactured by Arakawa Kagaku Co., Ltd.) | | |
| Surfactant | 0.8 | parts |
| (Megafac F-176PF, solid content: 20%, manufactured by | | |
| Dainippon Ink & Chemicals Inc.) | | |
| n-Propyl Alcohol | 793 | parts |
| Methyl Ethyl Ketone | 198 | parts |

The properties of the resulting image forming layer were as follows.

The surface hardness of the image forming layer is preferably 10 g or more in terms of a sapphire needle, and specifically, it was 200 g or more.

The smooster value of the surface is preferably from 0.5 mmHg to 50 mmHg (approximately equal to 0.0665 kPa to 6.65 kPa) at 23° C. and 55% RH, and specifically, it was 2.3 mmHg (approximately equal to 0.31 kPa).

The coefficient of static friction of the surface is preferably 0.2 or less, and specifically, it was 0.1.

The surface energy was 24 mJ/m². The contact angle of water was 108.1 degrees.

The deformation rate of the light-to-heat converting layer at the time when an image was recorded at a linear speed of 1 m/sec or more with a laser beam having an optical intensity of 1,000 W/mm² or more on the exposed surface was 150%.

-Preparation of Heat Transfer Sheet M-

Heat transfer sheet M was prepared in the same manner as in the preparation of heat transfer sheet W described in Example 101 except that a coating solution for magenta image forming layer having the composition shown below was used in place of the coating solution for white image forming layer. The image forming layer of heat transfer sheet M thus obtained had a layer thickness of 0.38 μm.

[Composition of Magenta Pigment Dispersion Mother Liquor]

| Magenta Pigment Composition 1: | |
|---|---|
| Polyvinyl Butyral | 12.6 parts |
| (Denka Butyral #2000-L, manufactured by Denki | |
| Kagaku Kogyo K.K., Vicat softening point: 57° C.) | |
| Pigment Red 57:1 (C.I. No. 15850:1) | 15.0 parts |
| (Symuler Brilliant Carmine 6B-229, manufactured by | |
| Dainippon Ink & Chemicals Inc.) | |
| Pigment Dispersant | 0.6 parts |
| (Solsperse S-20000, manufactured by I.C.I.) | |
| n-Propyl Alcohol | 80.4 parts |

[Composition of Magenta Pigment Dispersion Mother Liquor]
Magenta Pigment Composition 2:

| | | |
|---|---|---|
| Polyvinyl Butyral | 12.6 | parts |
| (Denka Butyral #2000-L, manufactured by Denki Kagaku | | |
| Kogyo K.K., Vicat softening point: 57° C.) | | |
| Pigment Red 57:1 (C.I. No. 15850:1) | 15.0 | parts |
| (Lionol Red 6B-4290G, manufactured by Toyo | | |
| Ink Mfg. Co. Ltd.) | | |
| Pigment Dispersant | 0.6 | parts |
| (Solsperse S-20000, manufactured by I.C.I.) | | |
| n-Propyl Alcohol | 79.4 | parts |

[Composition of Coating Solution for Magenta Image Forming Layer]

| | | |
|---|---|---|
| Above-Described Magenta Pigment Dispersion | 163 | parts |
| Mother Liquor | | |
| (Magenta pigment composition 1:Magenta pigment | | |
| composition 2 = 95:5 (parts)) | | |
| Polyvinyl Butyral | 4.0 | parts |
| (Denka Butyral #2000-L, manufactured by Denki Kagaku | | |
| Kogyo K.K., Vicat softening point: 57° C.) | | |
| Wax Compounds | | |
| (Stearic acid amide, Newtron 2, manufactured by Nippon | 1.0 | part |
| Fine Chemical Co., Ltd.) | | |
| (Behenic acid amide, Diamid BM, manufactured by Nippon | 2.0 | parts |
| Kasei Chemical Co., Ltd.) | | |
| (Palmitic acid amide, Diamid KP, manufactured by Nippon | 1.0 | part |
| Kasei Chemical Co., Ltd.) | | |
| (Erucic acid amide, Diamid L-200, manufactured | 1.0 | part |
| by Nippon Kasei Chemical Co., Ltd.) | | |
| (Oleic acid amide, Diamid O-200, manufactured by Nippon | 1.0 | part |
| Kasei Chemical Co., Ltd.) | | |
| Nonionic Surfactant | 0.7 | parts |
| (Chemistat 1100, manufactured by Sanyo Chemical | | |
| Industries, Ltd.) | | |
| Rosin | 4.6 | parts |
| (KE-311, manufactured by Arakawa Kagaku Co., Ltd.) | | |
| Pentaerythritol Tetraacrylate | 2.5 | parts |
| (NK Ester A-TMMT, manufactured by | | |
| Shin-Nakamura Kagaku Co., Ltd.) | | |
| Surfactant | 1.3 | parts |
| (Megafac F-176PF, solid content: 20%, manufactured by | | |
| Dainippon Ink & Chemicals Inc.) | | |
| n-Propyl Alcohol | 848 | parts |
| Methyl Ethyl Ketone | 246 | parts |

The properties of the resulting image forming layer were as follows.

The surface hardness of the image forming layer is preferably 10 g or more in terms of a sapphire needle, and specifically, it was 200 g or more.

The smooster value of the surface is preferably from 0.5 mmHg to 50 mmHg (approximately equal to 0.0665 kPa to 6.65 kPa) at 23° C. and 55% RH, and specifically, it was 3.5 mmHg (approximately equal to 0.47 kPa).

The coefficient of static friction of the surface is preferably 0.2 or less, and specifically, it was 0.08.

The surface energy was 25 mJ/m². The contact angle of water was 98.8 degrees.

The deformation rate of the light-to-heat converting layer at the time when an image is recorded at a linear speed of 1 m/sec or more with a laser beam having an optical intensity of 1000 W/mm² or more on the exposed surface was 160%.

-Preparation of Heat Transfer Sheet C-

Heat transfer sheet C was prepared in the same manner as in the preparation of heat transfer sheet W described in Example 101 except that a coating solution for cyan image forming layer having the composition shown below was used in place of the coating solution for white image forming layer. The image forming layer of heat transfer sheet C thus obtained had a layer thickness of 0.45 μm.

[Composition of Cyan Pigment Dispersion Mother Liquor]
Cyan Pigment Composition 1:

| | | |
|---|---|---|
| Polyvinyl Butyral | 12.6 | parts |
| (Esreck B BL-SH, manufactured by Sekisui Chemical Co., | | |
| Ltd.) | | |
| Pigment Blue 15:4 (C.I. No. 74160) | 15.0 | parts |
| (Cyanine Blue 700-10FG, manufactured by Toyo Ink Mfg. | | |
| Co. Ltd.) | | |
| Pigment Dispersant | 0.8 | parts |
| (PW-36, manufactured by Kusumoto Kasei Co., Ltd.) | | |
| n-Propyl Alcohol | 110 | parts |

[Composition of Cyan Pigment Dispersion Mother Liquor]
Cyan Pigment Composition 2:

| | | |
|---|---|---|
| Polyvinyl Butyral | 12.6 | parts |
| (Esreck B BL-SH, manufactured by Sekisui Chemical Co., | | |
| Ltd.) | | |
| Pigment Blue 15 (C.I. No. 74160) | 15.0 | parts |
| (Lionol Blue 7027, manufactured by Toyo Ink Mfg. | | |
| Co. Ltd.) | | |
| Pigment Dispersant | 0.8 | parts |
| (PW-36, manufactured by Kusumoto Kasei Co., Ltd.) | | |
| n-Propyl Alcohol | 110 | parts |

[Composition of Coating Solution for Cyan Image Forming Layer]

| | | |
|---|---|---|
| Above-Described Cyan Pigment Dispersion Mother Liquor | 118 | parts |
| (Cyan pigment composition 1:Cyan pigment | | |
| composition 2 = 90:10 (parts)) | | |
| Polyvinyl Butyral | 5.2 | parts |
| (Esreck B BL-SH, manufactured by Sekisui Chemical Co., | | |
| Ltd.) | | |
| Inorganic Pigment, MEK-ST | 1.3 | parts |
| Wax Compounds | | |
| (Stearic acid amide, Newtron 2, manufactured by Nippon | 1.0 | part |
| Fine Chemical Co., Ltd.) | | |
| (Behenic acid amide, Diamid BM, manufactured by Nippon | 1.0 | part |
| Kasei Chemical Co., Ltd.) | | |
| (Lauric acid amide, Diamid Y, manufactured by | 1.0 | part |
| Nippon Kasei Chemical Co., Ltd.) | | |
| (Palmitic acid amide, Diamid KP, manufactured by Nippon | 1.0 | part |
| Kasei Chemical Co., Ltd.) | | |
| (Erucic acid amide, Diamid L-200, manufactured | 1.0 | part |
| by Nippon Kasei Chemical Co., Ltd.) | | |
| (Oleic acid amide, Diamid O-200, manufactured by Nippon | 1.0 | part |
| Kasei Chemical Co., Ltd.) | | |
| Rosin | 2.8 | parts |
| (KE-311, manufactured by Arakawa Kagaku Co., Ltd.) | | |
| Pentaerythritol Tetraacrylate | 1.7 | parts |
| (NK Ester A-TMMT, manufactured by | | |
| Shin-Nakamura Kagaku Co., Ltd.) | | |
| Surfactant | 1.7 | parts |
| (Megafac F-176PF, solid content: 20%, manufactured by | | |
| Dainippon Ink & Chemicals Inc.) | | |
| n-Propyl Alcohol | 890 | parts |
| Methyl Ethyl Ketone | 247 | parts |

The properties of the resulting image forming layer were as follows.

The surface hardness of the image forming layer is preferably 10 g or more in terms of a sapphire needle, and specifically, it was 200 g or more.

The smooster value of the surface is preferably from 0.5 mmHg to 50 mmHg (approximately equal to 0.0665 kPa to 6.65 kPa) at 23° C. and 55% RH, and specifically, it was 7.0 mmHg (approximately equal to 0.93 kPa).

The coefficient of static friction of the surface is preferably 0.2 or less, and specifically, it was 0.08.

The surface energy was 25 mJ/m². The contact angle of water was 98.8 degrees.

The deformation rate of the light-to-heat converting layer at the time when an image is recorded at a linear speed of 1 m/sec or more with a laser beam having an optical intensity of 1,000 W/mm² or more on the exposed surface was 165%.

-Preparation of Image Receiving Sheet K-

Heat transfer sheet K was prepared in the same manner as in the preparation of heat transfer sheet W described in Example 101 except that a coating solution for black image forming layer having the composition shown below was used in place of the coating solution for white image forming layer. The image forming layer of heat transfer sheet K thus obtained had a layer thickness of 0.60 μm.

[Composition of Black Pigment Dispersion Mother Liquor]
Composition 1

| | | |
|---|---|---|
| Polyvinyl Butyral | 12.6 | parts |
| (Esreck B BL-SH, manufactured by Sekisui Chemical Co., | | |
| Ltd.) | | |
| Pigment Black 7 (carbon black, C.I. No. 77266) | 4.5 | parts |
| (Mitsubishi Carbon Black #5, manufactured by Mitsubishi | | |
| Chemical Corp., PVC blackness: 1) | | |
| Dispersing Assistant | 0.8 | parts |
| (Solsperse S-20000, manufactured by I.C.I.) | | |
| n-Propyl Alcohol | 79.4 | parts |

Composition 2

| | | |
|---|---|---|
| Polyvinyl Butyral | 12.6 | parts |
| (Esreck B BL-SH, manufactured by Sekisui Chemical | | |
| Co., Ltd.) | | |
| Pigment Black 7 (carbon black, C.I. No. 77266) | 10.5 | parts |
| (Mitsubishi Carbon Black MA100, manufactured by | | |
| Mitsubishi Chemical Corporation, PVC blackness: 10) | | |
| Dispersing Assistant | 0.8 | parts |
| (Solsperse S-20000, manufactured by I.C.I.) | | |
| n-Propyl Alcohol | 79.4 | parts |

[Composition of Coating Solution for Black Image Formation Layer]

| | | |
|---|---|---|
| Above-Described Black Pigment Dispersion Mother Liquor | 185.7 | parts |
| (Composition 1:Composition 2 = 70:30 (parts)) | | |
| Polyvinyl Butyral | 11.9 | parts |
| (Esreck B BL-SH, manufactured by Sekisui Chemical Co., | | |
| Ltd.) | | |
| Wax Compounds | | |
| (Stearic acid amide, Newtron 2, manufactured by Nippon | 1.7 | parts |
| Fine Chemical Co., Ltd.) | | |
| (Behenic acid amide, Diamid BM, manufactured by Nippon | 1.7 | parts |
| Kasei Chemical Co., Ltd.) | | |
| (Lauric acid amide, Diamid Y, manufactured by | 1.7 | parts |
| Nippon Kasei Chemical Co., Ltd.) | | |
| (Palmitic acid amide, Diamid KP, manufactured by Nippon | 1.7 | parts |
| Kasei Chemical Co., Ltd.) | | |
| (Erucic acid amide, Diamid L-200, manufactured | 1.7 | parts |
| by Nippon Kasei Chemical Co., Ltd.) | | |
| (Oleic acid amide, Diamid O-200, manufactured by Nippon | 1.7 | parts |
| Kasei Chemical Co., Ltd.) | | |
| Rosin | 11.4 | parts |
| (KE-311, manufactured by Arakawa Kagaku Co., Ltd., | | |
| component: resin acid 80-97%; resin acid component: | | |
| abietic acid 30-40%, neoabietic acid 10-20%, | | |
| dihydroabietic acid 14%, tetrahydroabietic acid 14%) | | |
| Surfactant | 2.1 | parts |
| (Megafac F-176PF, solid content: 20%, manufactured by | | |
| Dainippon Ink & Chemicals Inc.) | | |
| Inorganic Pigment | 7.1 | parts |
| (MEK-ST, 30% methyl ethyl ketone solution, manufactured | | |
| by Nissan Chemical Industries, Ltd.) | | |
| n-Propyl Alcohol | 1050 | parts |
| Methyl Ethyl Ketone | 295 | parts |

The properties of the resulting image forming layer were as follows.

The surface hardness of the image forming layer is preferably 10 g or more in terms of a sapphire needle, and specifically, it was 200 g or more.

The smooster value of the surface was 9.3 mmHg (approximately equal to 1.24 kPa).

The coefficient of static friction of the surface is preferably 0.2 or less, and specifically, it was 0.08.

The surface energy was 29 mJ/m². The contact angle of water was 94.8 degrees.

The reflection optical density was 1.82, the layer thickness was 0.60 μm, and the OD/layer thickness was 3.03.

The deformation rate of the light-to-heat converting layer at the time when an image is recorded at a linear speed of 1 m/sec or more with a laser beam having an optical intensity of 1,000 W/mm² or more on the exposed surface was 168%.

Using the image forming materials thus-obtained, performances of the image forming materials for the examples and comparative example were evaluated in the following manner.

-Formation of Transferred Image-

As an image formation system, there was used the system described in FIG. 4 employing a Luxel FINALPROOF 5600 recording device, and a transferred image was obtained on stock paper according to the image formation sequence of the system and the stock paper transfer method used in the system.

The image receiving sheet (56 cm×79 cm) prepared above was wound around a 38-cm diameter rotary drum provided with 1-mm diameter vacuum suction holes (at a surface density of 1 hole per 3 cm×8 cm area), and adhered thereon by suction. Then, the above-described heat transfer sheet K cut to a size of 61 cm×84 cm was overlaid on the image receiving sheet so that the heat transfer sheet K was uniformly protruded from the image receiving sheet, and air was sucked through the suction holes with squeezing by a squeeze roller to adhere and laminate the sheets. The degree of pressure reduction in the state that the suction holes were stopped up was −150 mmHg (approximately equal to 81.13 kPa) per atom. The drum was driven for rotation, and a semiconductor laser beam having a wavelength of 808 nm was condensed from the outside onto a surface of the laminate on the drum so as to give a 7-μm spot on a surface of the light-to-heat converting layer. Thus, laser image recording on the laminate was conducted while moving (sub-scanning) the laser beam perpendicularly to the rotational direction (main scanning direction) of the rotary drum. The laser irradiation conditions were described below. The laser beam comprising multiple laser beams two-dimensionally arranged in a parallelogram of 5 lines in the main scanning direction and 3 lines in the sub-scanning direction was used.
Laser Power: 110 mW
Drum Rotation Number: 500 rpm
Sub-Scanning Pitch: 6.35 μm
Environmental Temperature and Humidity: three conditions of 20° C. and 40%, 23° C. and 50%, and 26° C. and 65%

The diameter of the exposure drum is preferably 360 mm or more, and specifically, the drum having a diameter of 380 mm was used.

The image size was 515 mm×728 mm, and the resolution was 2,600 dpi.

Using each of the heat transfer sheets C, M and Y in place of the heat transfer sheet K, imagewise laser beam irradiation was sequentially conducted on the image forming layer thereof, and the irradiated area was sequentially transferred onto the image receiving sheet to laminate, thereby forming a multicolor image on the image receiving sheet. Then, using each of the heat transfer sheets W of Examples 101 to 103 and Comparative Example 101, solid recording was conducted on the multicolor image, and then the resulting laminate was transferred again onto a transparent support by a heat transfer device.

With respect to the heat transfer device used, a coefficient of dynamic friction of the material of insertion table to polyethylene phthalate was from 0.1 to 0.7, and transporting speed was from 15 mm/sec to 50 mm/sec. A Vicker's hardness of the material of heat roll of the heat transfer device is preferably from 10 to 100, and specifically, it was 70.

In the case of using the heat transfer sheets W of Examples 101 to 103, the multicolor image transferred onto the transparent support was clear under any environment, and the white solid image had high opacifying power and was effective as the background.

On the contrary, in the case of using the heat transfer sheet W of Comparative Example 101, the multicolor image transferred onto the transparent support was transparent under any environment, and the opacifying power of the white solid image was insufficient.

Further, using the heat transfer sheets W of Examples 101 to 103 and Comparative Example 101 as the heat transfer sheets, white images were formed, and durability and transfer sensitivity thereof were evaluated in the following manner. The evaluation results are shown in Table 1 below.

(1) Durability-Scratch Resistance (Surface Hardness)—

A white solid image was formed, and a sapphire needle having a curvature radius of 0.25 mm was perpendicularly put on the image. The surface of the image was scratched with a sapphire needle at a rate of 1 cm/second while gradually increasing the load, and the minimum load required for the needle to break the image to reach the interface of the transferred image and the image receiving layer of the image receiving sheet was measured. The measurement was conducted after the storage of sample under an atmosphere of 25° C. and 60% RH for 24 hours. A preferred range of the scratch resistance of the transferred image is from 200 g to 2,000 g in terms of the above-described load.

With each of the examples and comparative example, the evaluation was performed according the following criteria.

O: Scratch resistance of 200 g or more

X: Scratch resistance less than 200 g

(2) Transfer Sensitivity

The white transferred image was observed by an optical microscope, a recording linewidth d of the image area in the transferred image wherein the laser irradiation portion was recorded in the form of line was measured, and the sensitivity was calculated according to the following formula:
Sensitivity=(Laser Power)/(Linewidth d×Drum Rotation Speed)

The smaller the value, the higher the sensitivity.

TABLE 1

| | | Sensitivity |
|---|---|---|
| | Durability | (mJ/cm²) |
| Example 101 | ◯ | 250 |
| Example 102 | ◯ | 200 |
| Example 103 | ◯ | 250 |
| Comparative | X | 350 |
| Example 101 | | |

### EXAMPLE 201

-Preparation of Heat Transfer Sheet W (White)-

[Preparation of Back Layer]

[Preparation of Coating Solution for First Back Layer]

| | | |
|---|---|---|
| Aqueous Dispersion of Acrylic Resin | 2 | parts |
| (Jurimer ET410, solid content: 20% by weight, | | |
| manufactured by Nippon Junyaku Co., Ltd.) | | |
| Antistatic Agent | 7.0 | parts |
| (An aqueous dispersion of tin oxide-antimony oxide, | | |
| average particle size: 0.1 μm, 17% by weight) | | |
| Polyoxyethylene Phenyl Ether | 0.1 | part |
| Melamine Compound | 0.3 | parts |
| (Sumitex Resin M-3, manufactured by Sumitomo Chemical | | |
| Co., Ltd.) | | |
| Distilled Water to make | 100 | parts |

[Formation of First Back Layer]

Corona treatment was conducted on one face (back surface) of a biaxially stretched polyethylene terephthalate support having a thickness of 75 μm (Ra on both surfaces is 0.01 μm), and the coating solution for first back layer was applied thereto so as to give a dry layer thickness of 0.03 μm, followed by drying at 180° C. for 30 seconds to form a first back layer. The support has a longitudinal Young's modulus of 450 kg/mm² (approximately equal to 4.4 GPa) and a lateral Young's modulus of 500 kg/mm² (approximately equal to 4.9 GPa). The support has a longitudinal F-5 value of 10 kg/mm² (approximately equal to 98 MPa) and a lateral F-5 value of 13 kg/mm² (approximately equal to 127.4 MPa). The degrees of heat shrinkage of the support in longitudinal and lateral directions at 100° C. for 30 minutes are 0.3% and 0.1%, respectively. The longitudinal breaking strength is 20 kg/mm² (approximately equal to 196 MPa), the lateral breaking strength is 25 kg/mm² (approximately equal to 245 MPa), and the elasticity is 400 kg/mm² (approximately equal to 3.9 GPa).

[Preparation of Coating Solution for Second Back Layer]

| | | |
|---|---|---|
| Polyolefin | 3.0 | parts |
| (Chemipearl S-120, 27% by weight, manufactured by | | |
| Mitsui Petrochemical Industries, Ltd.) | | |
| Antistatic Agent | 2.0 | parts |
| (An aqueous dispersion of tin oxide-antimony oxide, | | |
| average particle size: 0.1 μm, 17% by weight) | | |
| Colloidal Silica | 2.0 | parts |
| (Snowtex C, 20% by weight, manufactured by Nissan | | |
| Chemical Industries, Ltd.) | | |
| Epoxy Compound | 0.3 | parts |
| (Dinacol EX-614B, manufactured by Nagase Kasei Co., | | |
| Ltd.) | | |
| Distilled Water to make | 100 | parts |

[Formation of Second Back Layer]

The coating solution for second back layer was applied onto the first back layer so as to give a dry layer thickness of 0.03 μm, followed by drying at 170° C. for 30 seconds to form a second back layer.

[Formation of Light-To-Heat Converting Layer]

[Preparation of Coating Solution for Light-To-Heat Converting Layer]

The following respective components were mixed with stirring by a stirrer to prepare a coating solution for light-to-heat converting layer.

[Composition of Coating Solution for Light-To-Heat Converting
Layer]

| | | |
|---|---|---|
| Infrared Absorption Dye | 7.6 | parts |
| (Compound (I-17) represented by formula (B)) | | |
| Polyamideimide | 29.3 | parts |
| (Compound represented by formula (A), wherein R | | |
| represents a divalent connecting group represented by | | |
| (6)) | | |
| Exxon Naphtha | 5.8 | parts |
| N-Methylpyrrolidone (NMP) | 1,500 | parts |
| Methyl Ethyl Ketone | 360 | parts |
| Surfactant | 0.5 | parts |
| (Megafac F-176PF, manufactured by Dainippon Ink & | | |
| Chemicals Inc., fluorine-containing surfactant) | | |
| Matting Agent Dispersion shown below | 14.1 | parts |

[Preparation of Matting Agent Dispersion]

Ten parts of fine spherical silica particles having an average particle size of 1.5 μm (Seahoster KE-P150, manufactured by Nippon Shokubai Kagaku Kogyo Co., Ltd.), 2 parts of a dispersing agent polymer (an acrylate-styrene copolymer, Juncril 611, manufactured by Johnson Polymer Co., Ltd.), 16 parts of methyl ethyl ketone and 64 parts of N-methylpyrrolidone were mixed, and the resulting mixture and 30 parts of glass beads having a diameter of 2 mm were placed in a polyethylene container having a volume of 200 ml, followed by dispersing for 2 hours using a paint shaker (manufactured by Toyoseikiseisaku-sho, Ltd.) to obtain a dispersion of fine silica particles.

[Formation of Light-To-Heat Converting Layer on Surface of Support]

The coating solution for light-to-heat converting layer prepared above was applied onto one surface of a 75-μm thick polyethylene terephthalate film (support) with a wire bar, followed by drying in an oven at 120° C. for 2 minutes to form a light-to-heat converting layer on the support. The optical density of the resulting light-to-heat converting layer at a wavelength of 808 nm was measured by an UV spectrophotometer, UV-240, manufactured by Shimadzu Corp. As a result, the optical density (OD) was 0.93. Observation of a cross section of the light-to-heat converting layer under a scanning electron microscope showed that the layer thickness was 0.3 μm on average.

[Formation of Image Forming Layer]

[Preparation of Coating Solution for White Image Forming Layer]

The following respective components were placed in a mill of a kneader, and a shear force was applied thereto while adding a small amount of a solvent to conduct dispersion pre-treatment. The solvent was further added to the resulting dispersion to adjust so as to finally give the following composition, followed by sand mill dispersion for 2 hours to obtain white pigment dispersion mother liquor.

[Composition of White Pigment Dispersion Mother Liquor]

| | |
|---|---|
| n-Propyl Alcohol | 257.2 parts |
| Polyvinyl Butyral | 30.8 parts |
| (Esreck B BL-SH, manufactured by Sekisui Chemical Co., | |
| Ltd.) | |
| Titanium Oxide (particle size: 300 nm) | 140 parts |
| Blue Pigment (Pigment Blue 15:4) | 0.014 parts |

The following components were mixed with stirring by a stirrer to prepare a coating solution for white image forming layer.

[Composition of Coating Solution for White Image Forming Layer]

| | | |
|---|---|---|
| n-Propyl Alcohol | 836.94 | parts |
| Methyl Ethyl ketone | 304.61 | parts |
| Wax Compounds | | |
| (Behenic acid amide, Diamid B45, manufactured by | 2.16 | parts |
| Nippon Kasei Chemical Co., Ltd.) | | |
| (Stearic acid amide, Newtron 2, manufactured by Nippon | 2.16 | parts |
| Fine Chemical Co., Ltd.) | | |
| (Lauric acid amide, Diamid Y, manufactured by Nippon | 2.16 | parts |
| Kasei Chemical Co., Ltd.) | | |
| (Palmitic acid amide, Diamid KP, manufactured by | 2.16 | parts |
| Nippon Kasei Chemical Co., Ltd.) | | |
| (Oleic acid amide, Diamid O-200, manufactured by | 2.16 | parts |
| Nippon Kasei Chemical Co., Ltd.) | | |
| (Erucic acid amide, Diamid L-200, manufactured by | 2.16 | parts |
| Nippon Kasei Chemical Co., Ltd.) | | |
| Rosin | 6.24 | parts |
| (KE-311, manufactured by Arakawa Kagaku Co., Ltd., | | |
| component: resin acid 80-97%; resin acid component: | | |
| abietic acid 30-40%, neoabietic acid 10-20%, | | |
| dihydroabietic acid 14%, tetrahydroabietic acid 14%) | | |
| White Pigment Dispersion Mother Liquor | 567.09 | parts |
| Surfactant | 18.05 | parts |
| (Megafac F780F, manufactured by Dainippon Ink & | | |
| Chemicals Inc., fluorine-containing surfactant) | | |

[Formation of White Image Forming Layer on Surface of Light-To-Heat Converting Layer]

The coating solution for white image forming layer prepared above was applied onto a surface of the light-to-heat converting layer with a wire bar to prepare a coated product, and the coated product was left for 1 minute, followed by drying of the coated product in an oven at 100° C. for 2 minutes to form a white image forming layer on the light-to-heat converting layer. By the above-described process, a heat transfer sheet W was prepared in which the light-to-heat converting layer and the white image forming layer were provided on the support in this order.

The thickness of the white image forming layer of the heat transfer sheet W measured was 0.8 μm on average.

The properties of the resulting image forming layer were as follows.

The surface hardness of the image forming layer is preferably 10 g or more in terms of a sapphire needle, and specifically, it was 200 g or more.

The contact angle of water was 48.1 degrees.

-Preparation of Heat Transfer Sheet Y-

Heat transfer sheet Y was prepared in the same manner as in the preparation of heat transfer sheet W described above except that a coating solution for yellow image forming layer having the composition shown below was used in place of the coating solution for white image forming layer. The image forming layer of heat transfer sheet Y thus obtained had a layer thickness of 0.42 μm.

[Composition of Yellow Pigment Dispersion Mother Liquor]
Yellow Pigment Composition 1:

| | |
|---|---|
| Polyvinyl Butyral | 7.1 parts |
| (Esreck B BL-SH, manufactured by Sekisui Chemical Co., | |
| Ltd.) | |
| Pigment Yellow 180 (C.I. No. 21290) | 12.9 parts |
| (Novoperm Yellow P-HG, manufactured by Clariant | |
| Japan K.K.) | |
| Pigment Dispersant | 0.6 parts |
| (Solsperse S-20000, manufactured by I.C.I.) | |
| n-Propyl Alcohol | 79.4 parts |

[Composition of Yellow Pigment Dispersion Mother Liquor]
Yellow Pigment Composition 2:

| | |
|---|---|
| Polyvinyl Butyral | 7.1 parts |
| (Esreck B BL-SH, manufactured by Sekisui Chemical Co., | |
| Ltd.) | |
| Pigment Yellow 139 (C.I. No. 56298) | 12.9 parts |
| (Novoperm Yellow M2R 70, manufactured by Clariant | |
| Japan K.K.) | |
| Pigment Dispersant | 0.6 parts |
| (Solsperse S-20000, manufactured by I.C.I.) | |
| n-Propyl Alcohol | 79.4 parts |

[Composition of Coating Solution for Yellow Image Forming Layer]

| | | |
|---|---|---|
| Above-Described Yellow Pigment Dispersion Mother | 126 | parts |
| Liquor (Yellow pigment composition 1:Yellow | | |
| pigment composition 2 = 95:5 (parts)) | | |
| Polyvinyl Butyral | 4.6 | parts |
| (Esreck B BL-SH, manufactured by Sekisui Chemical Co., | | |
| Ltd.) | | |
| Wax Compounds | | |
| (Stearic acid amide, Newtron 2, manufactured by Nippon | 0.7 | parts |
| Fine Chemical Co., Ltd.) | | |
| (Behenic acid amide, Diamid BM, manufactured by Nippon | 0.7 | parts |
| Kasei Chemical Co., Ltd.) | | |
| (Lauric acid amide, DiamidY, manufactured by Nippon | 0.7 | parts |
| Kasei Chemical Co., Ltd.) | | |
| (Palmitic acid amide, Diamid KP, manufactured by Nippon | 0.7 | parts |
| Kasei Chemical Co., Ltd.) | | |
| (Erucic acid amide, Diamid L-200, manufactured by | 0.7 | parts |
| Nippon Kasei Chemical Co., Ltd.) | | |
| (Oleic acid amide, Diamid O-200, manufactured by Nippon | 0.7 | parts |
| Kasei Chemical Co., Ltd.) | | |
| Nonionic Surfactant | 0.4 | parts |
| (Chemistat 1100, manufactured by Sanyo Chemical | | |
| Industries, Ltd.) | | |
| Rosin | 2.4 | parts |
| (KE-311, manufactured by Arakawa Kagaku Co., Ltd.) | | |
| Surfactant | 0.8 | parts |
| (Megafac F-176PF, solid content: 20%, manufactured by | | |
| Dainippon Ink & Chemicals Inc.) | | |
| n-Propyl Alcohol | 793 | parts |
| Methyl Ethyl Ketone | 198 | parts |

The properties of the resulting image forming layer were as follows.

The surface hardness of the image forming layer is preferably 10 g or more in terms of a sapphire needle, and specifically, it was 200 g or more.

The smooster value of the surface is preferably from 0.5 mmHg to 50 mmHg (approximately equal to 0.0665 kPa to 6.65 kPa) at 23° C. and 55% RH, and specifically, it was 2.3 mmHg (approximately equal to 0.31 kPa).

The coefficient of static friction of the surface is preferably 0.2 or less, and specifically, it was 0.1.

The surface energy was 24 mJ/m². The contact angle of water was 108.1 degrees.

The deformation rate of the light-to-heat converting layer at the time when an image was recorded at a linear speed of 1 m/sec or more with a laser beam having an optical intensity of 1,000 W/mm² or more on the exposed surface was 150%.

-Preparation of Heat Transfer Sheet M-

Heat transfer sheet M was prepared in the same manner as in the preparation of heat transfer sheet W described above except that a coating solution for magenta image forming layer having the composition shown below was used in place of the coating solution for white image forming layer. The image forming layer of heat transfer sheet M thus obtained had a layer thickness of 0.38 μm.

[Composition of Magenta Pigment Dispersion Mother Liquor]

| | |
|---|---|
| Magenta Pigment Composition 1: | |
| Polyvinyl Butyral | 12.6 parts |
| (Denka Butyral #2000-L, manufactured by Denki Kagaku | |
| Kogyo K.K., Vicat softening point: 57° C.) | |
| Pigment Red 57:1 (C.I. No. 15850:1) | 15.0 parts |
| (Symuler Brilliant Carmine 6B-229, manufactured by | |
| Dainippon Ink & Chemicals Inc.) | |
| Pigment Dispersant | 0.6 parts |
| (Solsperse S-20000, manufactured by I.C.I.) | |
| n-Propyl Alcohol | 80.4 parts |
| Magenta Pigment Composition 2: | |
| Polyvinyl Butyral | 12.6 parts |
| (Denka Butyral #2000-L, manufactured by Denki Kagaku | |
| Kogyo K.K., Vicat softening point: 57° C.) | |
| Pigment Red 57:1 (C.I. No. 15850:1) | 15.0 parts |
| (Lionol Red 6B-4290G, manufactured by Toyo Ink Mfg. Co. | |
| Ltd.) | |
| Pigment Dispersant | 0.6 parts |
| (Solsperse S-20000, manufactured by I.C.I.) | |
| n-Propyl Alcohol | 79.4 parts |

[Composition of Coating Solution for Magenta Image Forming
Layer]

| | | |
|---|---|---|
| Above-Described Magenta Pigment Dispersion Mother | 163 | parts |
| Liquor (Magenta pigment composition | | |
| 1:Magenta pigment composition 2 = 95:5 (parts)) | | |
| Polyvinyl Butyral | 4.0 | parts |
| (Denka Butyral #2000-L, manufactured by Denki Kagaku | | |
| Kogyo K.K., Vicat softening point: 57° C.) | | |
| Wax Compounds | | |
| (Stearic acid amide, Newtron 2, manufactured by Nippon | 1.0 | part |
| Fine Chemical Co., Ltd.) | | |
| (Behenic acid amide, Diamid BM, manufactured by Nippon | 2.0 | parts |
| Kasei Chemical Co., Ltd.) | | |
| (Palmitic acid amide, Diamid KP, manufactured by | 1.0 | part |
| Nippon Kasei Chemical Co., Ltd.) | | |
| (Erucic acid amide, Diamid L-200, manufactured by | 1.0 | part |
| Nippon Kasei Chemical Co., Ltd.) | | |
| (Oleic acid amide, Diamid O-200, manufactured by | 1.0 | part |
| Nippon Kasei Chemical Co., Ltd.) | | |
| Nonionic Surfactant | 0.7 | parts |
| (Chemistat 1100, manufactured by Sanyo Chemical | | |
| Industries, Ltd.) | | |
| Rosin | 4.6 | parts |
| (KE-311, manufactured by Arakawa Kagaku Co., Ltd.) | | |
| Pentaerythritol Tetraacrylate | 2.5 | parts |
| (NK Ester A-TMMT, manufactured by Shin-Nakamura | | |
| Kagaku Co., Ltd.) | | |
| Surfactant | 1.3 | parts |
| (Megafac F-176PF, solid content: 20%, manufactured by | | |
| Dainippon Ink & Chemicals Inc.) | | |
| n-Propyl Alcohol | 848 | parts |
| Methyl Ethyl Ketone | 246 | parts |

The properties of the resulting image forming layer were as follows.

The surface hardness of the image forming layer is preferably 10 g or more in terms of a sapphire needle, and specifically, it was 200 g or more.

The smooster value of the surface is preferably from 0.5 mmHg to 50 mmHg (approximately equal to 0.0665 kPa to 6.65 kPa) at 23° C. and 55% RH, and specifically, it was 3.5 mmHg (approximately equal to 0.47 kPa).

The coefficient of static friction of the surface is preferably 0.2 or less, and specifically, it was 0.08.

The surface energy was 25 mJ/m². The contact angle of water was 98.8 degrees.

The deformation rate of the light-to-heat converting layer at the time when an image is recorded at a linear speed of 1 m/sec or more with a laser beam having an optical intensity of 1000 W/mm² or more on the exposed surface was 160%.

-Preparation of Heat Transfer Sheet C-

Heat transfer sheet C was prepared in the same manner as in the preparation of heat transfer sheet W described above except that a coating solution for cyan image forming layer having the composition shown below was used in place of the coating solution for white image forming layer. The image forming layer of heat transfer sheet C thus obtained had a layer thickness of 0.45 μm.

[Composition of Cyan Pigment Dispersion Mother Liquor]
Cyan Pigment Composition 1:

| | |
|---|---|
| Polyvinyl Butyral | 12.6 parts |
| (Esreck B BL-SH, manufactured by Sekisui Chemical Co., | |
| Ltd.) | |
| Pigment Blue 15:4 (C.I. No. 74160) | 15.0 parts |
| (Cyanine Blue 700-10FG, manufactured by Toyo Ink Mfg. | |
| Co. Ltd.) | |
| Pigment Dispersant | 0.8 parts |
| (PW-36, manufactured by Kusumoto Kasei Co., Ltd.) | |
| n-Propyl Alcohol | 110 parts |

[Composition of Cyan Pigment Dispersion Mother Liquor]
Cyan Pigment Composition 2:

| | |
|---|---|
| Polyvinyl Butyral | 12.6 parts |
| (Esreck B BL-SH, manufactured by Sekisui Chemical Co., | |
| Ltd.) | |
| Pigment Blue 15 (C.I. No. 74160) | 15.0 parts |
| (Lionol Blue 7027, manufactured by Toyo Ink Mfg. Co. Ltd.) | |
| Pigment Dispersant | 0.8 parts |
| (PW-36, manufactured by Kusumoto Kasei Co., Ltd.) | |
| n-Propyl Alcohol | 110 parts |

[Composition of Coating Solution for Cyan Image Forming Layer]

| | |
|---|---|
| Above-Described Cyan Pigment Dispersion Mother Liquor | 118 parts |
| (Cyan pigment composition 1:Cyan pigment | |
| composition 2 = 90:10 (parts)) | |
| Polyvinyl Butyral | 5.2 parts |
| (Esreck B BL-SH, manufactured by Sekisui Chemical Co., | |
| Ltd.) | |
| Inorganic Pigment, MEK-ST | 1.3 parts |
| Wax Compounds | |
| (Stearic acid amide, Newtron 2, manufactured by Nippon | 1.0 part |
| Fine Chemical Co., Ltd.) | |
| (Behenic acid amide, Diamid BM, manufactured by Nippon | 1.0 part |
| Kasei Chemical Co., Ltd.) | |
| (Lauric acid amide, Diamid Y, manufactured by Nippon Kasei | 1.0 part |
| Chemical Co., Ltd.) | |
| (Palmitic acid amide, Diamid KP, manufactured by Nippon | 1.0 part |
| Kasei Chemical Co., Ltd.) | |
| (Erucic acid amide, Diamid L-200, manufactured by Nippon | 1.0 part |
| Kasei Chemical Co., Ltd.) | |
| (Oleic acid amide, Diamid O-200, manufactured by Nippon | 1.0 part |
| Kasei Chemical Co., Ltd.) | |
| Rosin | 2.8 parts |
| (KE-311, manufactured by Arakawa Kagaku Co., Ltd.) | |
| Pentaerythritol Tetraacrylate | 1.7 parts |
| (NK Ester A-TMMT, manufactured by Shin-Nakamura | |
| Kagaku Co., Ltd.) | |
| Surfactant | 1.7 parts |
| (Megafac F-176PF, solid content: 20%, manufactured by | |
| Dainippon Ink & Chemicals Inc.) | |
| n-Propyl Alcohol | 890 parts |
| Methyl Ethyl Ketone | 247 parts |

The properties of the resulting image forming layer were as follows.

The surface hardness of the image forming layer is preferably 10 g or more in terms of a sapphire needle, and specifically, it was 200 g or more.

The smooster value of the surface is preferably from 0.5 mmHg to 50 mmHg (approximately equal to 0.0665 kPa to 6.65 kPa) at 23° C. and 55% RH, and specifically, it was 7.0 mmHg (approximately equal to 0.93 kPa).

The coefficient of static friction of the surface is preferably 0.2 or less, and specifically, it was 0.08.

The surface energy was 25 mJ/m². The contact angle of water was 98.8 degrees.

The deformation rate of the light-to-heat converting layer at the time when an image is recorded at a linear speed of 1 m/sec or more with a laser beam having an optical intensity of 1,000 W/mm² or more on the exposed surface was 165%.

-Preparation of Image Receiving Sheet K-

Heat transfer sheet K was prepared in the same manner as in the preparation of heat transfer sheet W described above except that a coating solution for black image forming layer having the composition shown below was used in place of the coating solution for white image forming layer. The image forming layer of heat transfer sheet K thus obtained had a layer thickness of 0.60 μm.

[Preparation of Coating Solution for Black Image Forming Layer]

The following respective components were placed in a mill of a kneader, and a shear force was applied thereto while adding a small amount of a solvent to conduct dispersion pre-treatment. The solvent was further added to the resulting dispersion to adjust so as to finally give the following composition, followed by sand mill dispersion for 2 hours to obtain black pigment dispersion mother liqour.

[Composition of Black Pigment Dispersion Mother Liquor]

| | |
|---|---|
| Composition 1 | |
| Polyvinyl Butyral | 12.6 parts |
| (Esreck B BL-SH, manufactured by Sekisui Chemical Co., | |
| Ltd.) | |
| Pigment Black 7 (carbon black, C.I. No. 77266) | 4.5 parts |
| (Mitsubishi Carbon Black #5, manufactured by Mitsubishi | |
| Chemical Corp., PVC blackness: 1) | |
| Dispersing Assistant | 0.8 parts |
| (Solsperse S-20000, manufactured by I.C.I.) | |
| n-Propyl Alcohol | 79.4 parts |
| Composition 2 | |
| Polyvinyl Butyral | 12.6 parts |
| (Esreck B BL-SH, manufactured by Sekisui Chemical | |
| Co., Ltd.) | |
| Pigment Black 7 (carbon black, C.I. No. 77266) | 10.5 parts |
| (Mitsubishi Carbon Black MA100, manufactured by | |
| Mitsubishi Chemical Corporation, PVC blackness: 10) | |
| Dispersing Assistant | 0.8 parts |
| (Solsperse S-20000, manufactured by I.C.I.) | |
| n-Propyl Alcohol | 79.4 parts |

The following components were mixed with stirring by a stirrer to prepare a coating solution for white image forming layer.

[Composition of Coating Solution for Black Image Formation Layer]

| | |
|---|---|
| Above-Described Black Pigment Dispersion Mother | 185.7 parts |
| Liquor (Composition 1:Composition 2 = 70:30 (parts)) | |
| Polyvinyl Butyral | 11.9 parts |
| (Esreck B BL-SH, manufactured by Sekisui Chemical | |
| Co., Ltd.) | |
| Wax Compounds | |
| (Stearic acid amide, Newtron 2, manufactured by Nippon | 1.7 parts |
| Fine Chemical Co., Ltd.) | |
| (Behenic acid amide, Diamid BM, manufactured by | 1.7 parts |
| Nippon Kasei Chemical Co., Ltd.) | |
| (Lauric acid amide, Diamid Y, manufactured by Nippon | 1.7 parts |
| Kasei Chemical Co., Ltd.) | |
| (Palmitic acid amide, Diamid KP, manufactured by | 1.7 parts |
| Nippon Kasei Chemical Co., Ltd.) | |
| (Erucic acid amide, Diamid L-200, manufactured by | 1.7 parts |
| Nippon Kasei Chemical Co., Ltd.) | |
| (Oleic acid amide, Diamid O-200, manufactured by | 1.7 parts |
| Nippon Kasei Chemical Co., Ltd.) | |
| Rosin | 11.4 parts |
| (KE-311, manufactured by Arakawa Kagaku Co., Ltd., | |
| component: resin acid 80-97%; resin acid component: | |
| abietic acid 30-40%, neoabietic acid 10-20%, | |
| dihydroabietic acid 14%, tetrahydroabietic acid 14%) | |
| Surfactant | 2.1 parts |
| (Megafac F-176PF, solid content: 20%, manufactured by | |
| Dainippon Ink & Chemicals Inc.) | |
| Inorganic Pigment | 7.1 parts |
| (MEK-ST, 30% methyl ethyl ketone solution, | |
| manufactured by Nissan Chemical Industries, Ltd.) | |
| n-Propyl Alcohol | 1050 parts |
| Methyl Ethyl Ketone | 295 parts |

Particles of the coating solution for black image forming layer were measured using a grain size distribution measuring device of a laser scattering system. The average particle size was 0.25 μm, and a ratio of particles having a particle size of 1 μm or more was 0.5%.

The properties of the resulting image forming layer were as follows.

The surface hardness of the image forming layer is preferably 10 g or more in terms of a sapphire needle, and specifically, it was 200 g or more.

The smooster value of the surface was 9.3 mmHg (approximately equal to 1.24 kPa).

The coefficient of static friction of the surface is preferably 0.2 or less, and specifically, it was 0.08.

The surface energy was 29 mJ/m². The contact angle of water was 94.8 degrees.

The reflection optical density was 1.82, the layer thickness was 0.60 μm, and the OD/layer thickness was 3.03.

The deformation rate of the light-to-heat converting layer at the time when an image is recorded at a linear speed of 1 m/sec or more with a laser beam having an optical intensity of 1,000 W/mm² or more on the exposed surface was 168%.

-Preparation of Image Receiving Sheet-

A coating solution for cushion layer and a coating solution for image receiving layer each having the following compositions were prepared.

| | |
|---|---|
| 1) Coating Solution for Cushion Layer | |
| Vinyl Chloride-Vinyl Acetate Copolymer | 20 parts |
| (Main binder, MPR-TSL, manufactured by Nissin Kagaku | |
| Co., Ltd.) | |
| Plasticizer | 10 parts |
| (Paraplex G-40, manufactured by CP. HALL. COMPANY) | |
| Surfactant (fluorine-containing: coating aid) | 0.5 parts |
| (Megafac F-177, manufactured by Dainippon Ink & | |
| Chemicals Inc.) | |
| Antistatic Agent (quaternary ammonium salt) | 0.3 parts |
| (SAT-5 Supper (IC), manufactured by Nippon Junyaku Co., | |
| Ltd.) | |
| Methyl Ethyl Ketone | 60 parts |
| Toluene | 10 parts |
| N,N-Dimethylformamide | 3 parts |
| 2) Coating Solution for Image Receiving Layer | |
| Polyvinyl Butyral | 8 parts |
| (Esreck B BL-SH, manufactured by Sekisui Chemical Co., | |
| Ltd.) | |
| Antistatic Agent | 0.7 parts |
| (Sanstat 2012A, manufactured by Sanyo Chemical Industries, | |
| Ltd.) | |
| Surfactant | 0.1 part |
| (Megafac F-176PF, manufactured by Dainippon Ink & | |
| Chemicals Inc.) | |
| n-Propyl Alcohol | 20 parts |
| Methanol | 20 parts |
| 1-Methoxy-2-propanol | 50 parts |

The coating solution for cushion layer was applied onto a white PET support (Lumirror #130E58, manufactured by Toray Industries Inc., thickness: 130 μm) with a narrow coater, and the coated layer was dried. Then, the coating solution for image receiving layer was applied thereto, followed by drying. The amounts coated were adjusted so as to give a layer thickness of 20 μm after drying for the cushion layer, and a layer thickness of 2 μm after drying for the image receiving layer. The white PET support was a void-containing plastic support comprising a laminate (total thickness: 130 μm, specific gravity: 0.8) in which a void-containing polyethylene terephthalate layer (thickness: 116μ, void ratio: 20%) was laminated with titanium oxide-containing polyethylene terephthalate layers (thickness: 7 μm, titanium oxide content: 2%) on both sides thereof. The image receiving material thus prepared was wound in the roll form, and stored at room temperature for 1 week. Then, the image receiving material was used for the image recording using a laser beam as described below.

The properties of the resulting image forming layer were as follows.

The surface roughness Ra is preferably from 0.01 μm to 0.4 μm, and specifically, it was 0.02 μm.

The undulation of the surface of the image receiving layer is preferably 2 μm or less, and specifically, it was 1.2 μm.

The smooster value of the surface of the image receiving layer is preferably from 0.5 mmHg to 50 mmHg (approximately equal to 0.0665 kPa to 6.65 kPa) at 23° C. and 55% RH, and specifically, it was 0.8 mmHg (approximately equal to 0.11 kPa).

The coefficient of static friction of the surface of the image receiving layer is preferably 0.8 or less, and specifically, it was 0.37.

The surface energy of the image receiving layer was 29 mJ/m². The contact angle of water was 85 degrees.

Thus, a multicolor image forming material comprising the heat transfer sheets W, Y, M, C and B and the image receiving sheet described above was obtained.

### EXAMPLE 202

A heat transfer sheet W was prepared in the same manner as in Example 201, except for changing the white pigment dispersion mother liquor to a white pigment dispersion mother liquor shown below, whereby a multicolor image forming material was obtained.

[Composition of White Pigment Dispersion Mother Liquor]

| | |
|---|---|
| n-Propyl Alcohol | 328.2 parts |
| Polyvinyl Butyral | 31.8 parts |
| (Esreck B BL-SH, manufactured by Sekisui Chemical Co., | |
| Ltd.) | |
| Titanium Oxide (particle size: 300 nm) | 140 parts |
| Fluorescent Brightening Agent | 0.014 parts |
| (Uvitex OB, Ciba Specialty Chemicals) | |

### COMPARATIVE EXAMPLE 201

A heat transfer sheet W was prepared in the same manner as in Example 201, except for changing the white pigment dispersion mother liquor to a white pigment dispersion mother liquor shown below, whereby a multicolor image forming material was obtained.

[Composition of White Pigment Dispersion Mother Liquor]

| | |
|---|---|
| n-Propyl Alcohol | 328.2 parts |
| Polyvinyl Butyral | 31.8 parts |
| (Esreck B BL-SH, manufactured by Sekisui Chemical Co., | |
| Ltd.) | |
| Titanium Oxide (particle size: 300 nm) | 140 parts |

Using the multicolor image forming materials thus-obtained, performances thereof were evaluated in the following manner.

-Formation of Transferred Image-

As an image formation system, there was used the system described in FIG. 4 employing a Luxel FINALPROOF 5600 recording device, and a transferred image was obtained on an image receiving substance according to the image formation sequence of the system and the image receiving substance transfer method used in the system.

The image receiving sheet (56 cm×79 cm) prepared above was wound around a 38-cm diameter rotary drum provided with 1-mm diameter vacuum suction holes (at a surface density of 1 hole per 3 cm×8 cm area), and adhered thereon by suction. Then, the above-described heat transfer sheet K cut to a size of 61 cm×84 cm was overlaid on the image receiving sheet so that the heat transfer sheet K was uniformly protruded from the image receiving sheet, and air was sucked through the suction holes with squeezing by a squeeze roller to adhere and laminate the sheets. The degree of pressure reduction in the state that the suction holes were stopped up was −150 mmHg (approximately equal to 81.13 kPa) per atom. The drum was driven for rotation, and a semiconductor laser beam having a wavelength of 808 nm was condensed from the outside onto a surface of the laminate on the drum so as to give a 7-μm spot on a surface of the light-to-heat converting layer. Thus, laser image recording on the laminate was conducted while moving (sub-scanning) the laser beam perpendicularly to the rotational direction (main scanning direction) of the rotary drum. The laser irradiation conditions were described below. The laser beam comprising multiple laser beams two-dimensionally arranged in a parallelogram of 5 lines in the main scanning direction and 3 lines in the sub-scanning direction was used.
Laser Power: 110 mW
Drum Rotation Number: 500 rpm
Sub-Scanning Pitch: 6.35 μm
Environmental Temperature and Humidity: three conditions of 20° C. and 40%, 23° C. and 50%, and 26° C. and 65%

The diameter of the exposure drum is preferably 360 mm or more, and specifically, the drum having a diameter of 380 mm was used.

The image size was 515 mm×728 mm, and the resolution was 2,600 dpi.

Using each of the heat transfer sheets C, M and Y in place of the heat transfer sheet K, imagewise laser beam irradiation was sequentially conducted on the image forming layer thereof, and the irradiated area was sequentially transferred onto the image receiving sheet to laminate, thereby forming a multicolor image on the image receiving sheet. Then, using each of the heat transfer sheets W of Examples 201 to 202 and Comparative Example 201, solid recording was conducted on the multicolor image, and then the resulting laminate was transferred again onto a transparent plastic film (Melinex 709, manufactured by Teij in DuPont Films Japan Ltd.) by a heat transfer device. The image transferred on the film was visually evaluated and the results are shown in Table 2 below.

With respect to the heat transfer device used, a coefficient of dynamic friction of the material of insertion table to polyethylene phthalate was from 0.1 to 0.7, and transporting speed was from 15 mm/sec to 50 mm/sec. A Vicker's hardness of the material of heat roll of the heat transfer device is preferably from 10 to 100, and specifically, it was 70.

The hue of the white solid image transferred on the transparent plastic film was evaluated in the following manner and the results are shown in Table 2 below.

Measurement of Hue:

The evaluation of hue was performed by putting the white solid image transferred on the transparent plastic film on a black board (4 Batch B, manufactured by Murakami Color Research Laboratory Co., Ltd.) and measured by X-rite 938. Regarding color of stock paper (STROBE) as favorable color of the white area, the white area was compared with the color of stock paper.

TABLE 2

| | Visual Evaluation | Hue |
|---|---|---|
| Example 201 | Coloration due to decomposed material | L* = 75.3 |
| | of infrared absorbing dye was | a* = −2.9 |
| | sufficiently low and original color of | b* = −0.9 |
| | image forming layer was kept on white | |
| | area and image areas of Y, M, C and K | |
| Example 202 | Coloration due to decomposed material | L* = 76.8 |
| | of infrared absorbing dye was | a* = −1.3 |
| | sufficiently low and original color of | b* = −2.7 |
| | image forming layer was kept on white | |
| | area and image areas of Y, M, C and K | |
| Comparative | Coloration due to decomposed material | L* = 75.2 |
| Example 201 | of infrared absorbing dye was | a* = −2.4 |
| | recognized and color of white area and | b* = 0.4 |
| | image areas of Y, M, C and K were changed, | |
| | resulting in bad appearance | |

It was found that since the multicolor forming materials of Examples 201 and 202 contained the blue pigment or fluorescent brightening agent in the image forming layer of the heat transfer sheet W thereof, the multicolor image on the white background of the transparent plastic film was clear and kept the original hue, so that they were useful as the package.

On the contrary, it was found that with the multicolor forming materials of Comparative Example 201 containing neither blue pigment nor fluorescent brightening agent in the image forming layer of the heat transfer sheet W thereof, the multicolor image on the white background of the transparent plastic film was discolored with the color of the decomposed material of infrared absorbing dye, so that it was inappropriate for the package.

### EXAMPLE 301

-Preparation of Heat Transfer Sheet W (White)-

[Preparation of Back Layer]

[Preparation of Coating Solution for First Back Layer]

| | |
|---|---|
| Aqueous Dispersion of Acrylic Resin | 2 parts |
| (Jurimer ET410, solid content: 20% by weight, | |
| manufactured by Nippon Junyaku Co., Ltd.) | |
| Antistatic Agent | 7.0 parts |
| (An aqueous dispersion of tin oxide-antimony oxide, | |
| average particle size: 0.1 μm, 17% by weight) | |
| Polyoxyethylene Phenyl Ether | 0.1 part |
| Melamine Compound | 0.3 parts |
| (Sumitex Resin M-3, manufactured by Sumitomo Chemical | |
| Co., Ltd.) | |
| Distilled Water to make | 100 parts |

[Formation of First Back Layer]

Corona treatment was conducted on one face (back surface) of a biaxially stretched polyethylene terephthalate support having a thickness of 75 μm (Ra on both surfaces is 0.01 μm), and the coating solution for first back layer was applied thereto so as to give a dry layer thickness of 0.03 μm, followed by drying at 180° C. for 30 seconds to form a first back layer.

[Preparation of Coating Solution for Second Back Layer]

| | |
|---|---|
| Polyolefin | 3.0 parts |
| (Chemipearl S-120, 27% by weight, manufactured by Mitsui | |
| Petrochemical Industries, Ltd.) | |
| Antistatic Agent | 2.0 parts |
| (An aqueous dispersion of tin oxide-antimony oxide, | |
| average particle size: 0.1 μm, 17% by weight) | |
| Colloidal Silica | 2.0 parts |
| (Snowtex C, 20% by weight, manufactured by Nissan | |
| Chemical Industries, Ltd.) | |
| Epoxy Compound | 0.3 parts |
| (Dinacol EX-614B, manufactured by Nagase Kasei Co., Ltd.) | |
| Distilled Water to make | 100 parts |

[Formation of Second Back Layer]

The coating solution for second back layer was applied onto the first back layer so as to give a dry layer thickness of 0.03 μm, followed by drying at 170° C. for 30 seconds to form a second back layer.

[Formation of Light-To-Heat Converting Layer]

[Preparation of Coating Solution for Light-To-Heat Converting Layer]

The following respective components were mixed with stirring by a stirrer to prepare a coating solution for light-to-heat converting layer.

[Composition of Coating Solution for Light-To-Heat Converting Layer]

| | | |
|---|---|---|
| Infrared Absorption Dye having Structure Shown Below | 4.9 | parts |
| 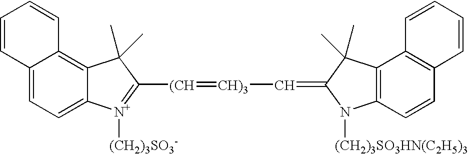 | | |
| Polyamideimide Resin | 179 | parts |
| (15% N-Methylpyrrolidone Solution, Vylomax HR-11N, | | |
| manufactured by Toyobo Co., Ltd.) | | |
| Silicone Particles | 1.1 | part |
| (1.5 μm, Tospaerl 120, manufactured by G E Toshiba Silicones Co., Ltd.) | | |
| Polyvinylpyrrolidone-Styrene Copolymer | 3.4 | parts |
| (ANTARA 430, manufactured by ISP Co., Ltd.) | | |
| N-Methylpyrrolidone (NMP) | 1,023 | parts |
| Methyl Ethyl Ketone | 686 | parts |
| Methanol | 98 | parts |
| Surfactant | 0.23 | parts |

(Megafac F-780F, Manufactured by Dainippon Ink & Chemicals Inc., Fluorine-Containing Surfactant)

[Formation of Light-To-Heat Converting Layer on Surface of Support]

The coating solution for light-to-heat converting layer prepared above was applied onto one surface of a 75-μm thick polyethylene terephthalate film (support) with a wire bar, followed by drying in an oven at 120° C. for 2 minutes to form a light-to-heat converting layer on the support. The optical density of the resulting light-to-heat converting layer at a wavelength of 808 nm was measured by an UV spectrophotometer, UV-240, manufactured by Shimadzu Corp. As a result, the optical density (OD) was 1.48. Observation of a cross section of the light-to-heat converting layer under a scanning electron microscope showed that the layer thickness was 0.5 μm on average.

[Formation of White Image Forming Layer on Surface of Light-To-Heat Converting Layer]

The coating solution for white image forming layer shown below was applied onto a surface of the light-to-heat converting layer with a wire bar to prepare a coated product, and the coated product was left for 1 minute, followed by drying of the coated product in an oven at 100° C. for 2 minutes to form a white image forming layer on the light-to-heat converting layer.

The thickness of the white image forming layer of the heat transfer sheet W measured was 1.50 μm.

[Composition of White Pigment Dispersion Mother Liquor]

| | |
|---|---|
| Polyvinyl Butyral | 2.7 parts |
| (Esreck B BL-SH, manufactured by Sekisui Chemical Co., | |
| Ltd.) | |
| Rutile Type Titanium Oxide | 35.0 parts |
| (JR805, manufactured by Tayca Corp.; weight average | |
| particle size: 0.29 μm) | |
| Dispersing Assistant | 0.35 parts |
| (Solsperse 20000, manufactured by Avecia Ltd.) | |
| n-Propyl Alcohol | 62.0 parts |

[Composition of Coating Solution for White Image Formation Layer]

| | |
|---|---|
| Above-Described White Pigment Dispersion | 1,200 parts |
| Mother Liquor | |
| 2,5-Bis[2-(5-tert-butylbenzoxazolyl)]thiophene | 2.8 parts |
| (Uvitex OB, Ciba Specialty Chemicals) | |
| Wax Compounds | |
| (Stearic acid amide, Newtron 2, manufactured by Nippon | 5.7 parts |
| Fine Chemical Co., Ltd.) | |
| (Behenic acid amide, Diamid BM, manufactured | 5.7 parts |
| by Nippon Kasei Chemical Co., Ltd.) | |
| (Lauric acid amide, Diamid Y, manufactured by | 5.7 parts |
| Nippon Kasei Chemical Co., Ltd.) | |
| (Palmitic acid amide, Diamid KP, manufactured | 5.7 parts |
| by Nippon Kasei Chemical Co., Ltd.) | |
| (Erucic acid amide, Diamid L-200, manufactured | 5.7 parts |
| by Nippon Kasei Chemical Co., Ltd.) | |
| (Oleic acid amide, Diamid O-200, manufactured | 5.7 parts |
| by Nippon Kasei Chemical Co., Ltd.) | |
| Rosin | 80.0 parts |
| (KE-311, manufactured by Arakawa Kagaku Co., Ltd., | |
| component: resin acid 80-97%; resin acid component: | |
| abietic acid 30-40%, neoabietic acid 10-20%, | |
| dihydroabietic acid 14%, tetrahydroabietic acid 14%) | |
| Surfactant | 16.0 parts |
| (Megafac F-780F, solid content: 30%, manufactured by | |
| Dainippon Ink & Chemicals Inc.) | |
| n-Propyl Alcohol | 1600 parts |
| Methyl Ethyl Ketone | 580 parts |

-Preparation of Image Receiving Sheet-

A coating solution for cushion layer and a coating solution for image receiving layer each having the following compositions were prepared.

| 1) Coating Solution for Cushion Layer | | |
|---|---|---|
| Vinyl Chloride-Vinyl Acetate Copolymer | 20 | parts |
| (Main binder, Solbin CL2, manufactured | | |
| by Nissin Chemical Industry Co., Ltd.) | | |
| Plasticizer | 10 | parts |
| (Paraplex G-40, manufactured by CP. HALL. COMPANY) | | |
| Surfactant (fluorine-containing: coating aid) | 0.5 | parts |
| (Megafac F-178K, manufactured by Dainippon Ink & | | |
| Chemicals Inc.) | | |
| Methyl Ethyl Ketone | 60 | parts |
| Toluene | 10 | parts |
| N,N-Dimethylformamide | 3 | parts |
| 2) Coating Solution for Image Receiving Layer | | |
| Polyvinyl Butyral | 8 | parts |
| (Esreck B BL-SH, manufactured by Sekisui Chemical Co., | | |
| Ltd.) | | |
| Antistatic Agent | 0.7 | parts |
| (Sanstat 2012A, manufactured by Sanyo Chemical Industries, | | |
| Ltd.) | | |
| Surfactant | 0.1 | part |
| (Megafac F-476, manufactured by Dainippon Ink & | | |
| Chemicals Inc.) | | |
| n-Propyl Alcohol | 20 | parts |
| Methanol | 20 | parts |
| 1-Methoxy-2-propanol | 50 | parts |

The coating solution for cushion layer described above was applied onto a white PET support (Lumirror #130E58, manufactured by Toray Industries Inc., thickness: 130 μm) with a test coater, and the coated layer was dried. Then, the coating solution for image receiving layer was applied thereto, followed by drying. The amounts coated were adjusted so as to give a layer thickness of 20 μm after drying for the cushion layer, and a layer thickness of 2 μm after drying for the image receiving layer.

Then, image recording with a laser beam was performed in the following manner.

-Formation of Transferred Image-

Using the above-described image receiving sheet and heat transfer sheet W together with a laser heat transfer printer (Luxel FINALPROOF 5600, manufactured by Fuji Photo Film Co., Ltd.), image recording was conducted to form a white solid image on the image receiving sheet. The image recording was carried out with a recording energy of 434 mL/cm².

Further, the white solid image and image receiving layer were transferred again onto a transparent support (Merinex 709, manufactured by Teijin DuPont Films Ltd.; thickness: 50 μm) using Laminator FPL760, manufactured by Fuji Photo Film Co., Ltd.

-Measurement of Hue

Values of L* a* b* of the recorded solid mage portion were measured using a color measuring densitometer (X-rite, manufactured by X-rite Inc.). The measurement was carried out on a black backing under the condition of D50².

Hue:

⊚: having favorable white without any yellowish color
O: having favorable white
X: having visually yellowish color and being unfavorable
   -Measurement of Opacifying Ratio-

With the recorded solid mage portion, an XYZ value on a black backing and an XYZ value on a white backing were measured using a color measuring densitometer (X-rite), and a ratio of Y value measured on the black backing/Y value measured on the white backing was calculated, which was designated as an opacifying ratio. The measurement was carried out on under The condition of D65².

Opacifying Performance:

O: having sufficient opacifying performance, when intended package use
Δ: having opacifying performance, when intended package use (allowing the opposite side to slightly show the transparent support, but no problems for practical use)
X: having insufficient opacifying performance, when intended package use, and being unfavorable because of allowing the opposite side to show through the transparent support
   -Measurement of Transfer Sensitivity-

A solid image was recorded, and an irradiation energy of laser beam necessary for forming the solid image closely.

### EXAMPLE 302

A heat transfer sheet was prepared in the same manner as in Example 301, except that the image forming layer used in Example 301 was changed to an image forming layer shown below.

[Coating Solution for Image Formation Layer]

The titanium oxide in the white pigment dispersion mother liquor was changed as follows:

Rutile Type Titanium Oxide 35.0 parts

(KR380, Manufactured by Titan Kogyo Kabushiki Kaisha; Weight Average Particle Size: 0.35 μm)

[Formation of Image Forming Layer on Surface of Light-To-Heat Converting Layer]

The thickness of the image forming layer was adjusted to 3.0 μm.

### EXAMPLE 303

A heat transfer sheet was prepared in the same manner as in Example 301, except that the amount of Uvitex-OB added to the image forming layer of Example 301 was changed to 1.4 parts.

### EXAMPLE 304

A heat transfer sheet was prepared in the same manner as in Example 301, except that the Uvitex-OB was not added to the image forming layer of Example 301.

### EXAMPLE 305

A heat transfer sheet was prepared in the same manner as in Example 301, except that the amount of the infrared absorbing dye added to the light-to-heat converting layer of Example 301 was changed to 3.3 parts and that the thickness thereof was changed to 0.6 μm.

Optical density (OD) of the light-to-heat converting layer at a wavelength of 808 nm was 1.45.

### EXAMPLE 306

A heat transfer sheet was prepared in the same manner as in Example 301, except that the thickness of the image forming layer of Example 301 was changed to 1.5 μm.

### COMPARATIVE EXAMPLE 301

A heat transfer sheet was prepared in the same manner as in Example 301, except that the amount of the infrared absorbing dye added to the light-to-heat converting layer of Example 301 was changed to 9.7 parts and that the thickness thereof was changed to 0.34 μm.

Optical density (OD) of the light-to-heat converting layer at a wavelength of 808 nm was 1.45.

The results obtained are shown in Table 3 below.

TABLE 3

| | Absorbance | Thickness (X) | | Thickness | | | | | | | |
|---|---|---|---|---|---|---|---|---|---|---|---|
| | (A) of | of | | of Image | | | | | | | |
| | Light-To-Heat | Light-To-Heat | | Forming | | | | | Transfer | | |
| | Converting | Converting | A/X | Layer | | | | Opacifying | Sensitivity | | Opacifying |
| | Layer | Layer | Ratio | (μm) | L* | a* | b* | Ratio (%) | (mJ/cm²) | Hue | Performance |
| Example 1 | 1.48 | 0.50 | 3.0 | 1.5 | 76.8 | −1.4 | −5.0 | 61.0 | 430.0 | ⊚ | ◯ |
| Example 2 | 1.48 | 0.50 | 3.0 | 3.0 | 75.5 | −1.3 | −5.1 | 63.0 | 520.0 | ⊚ | ◯ |
| Example 3 | 1.48 | 0.50 | 3.0 | 1.5 | 76.0 | −1.4 | −2.9 | 62.0 | 430.0 | ◯ | ◯ |
| Example 4 | 1.48 | 0.50 | 3.0 | 1.5 | 76.0 | −1.3 | −2.0 | 61.0 | 430.0 | ◯ | ◯ |
| Example 5 | 1.45 | 0.60 | 2.4 | 1.5 | 76.2 | −1.3 | −6.0 | 61.0 | 600.0 | ⊚ | ◯ |
| Example 6 | 1.48 | 0.50 | 3.0 | 1.5 | 73.0 | −1.3 | −2.9 | 43.0 | 430.0 | ◯ | Δ |
| Comparative | 1.45 | 0.34 | 4.3 | 1.5 | 75.2 | −2.4 | 1.0 | 61.0 | 400.0 | X | ◯ |
| Example 1 | | | | | | | | | | | |

From the results shown in Table 3 above, it can be understood that not only the whiteness preferred as a white image but also the image having high image quality are obtained according to the invention.

### INDUSTRIAL APPLICABILITY

According to the invention, the image having high resolution, good resistance to scratch and white color excellent in opacifying power can be obtained. By expressing hue of white color, a range of reproducible hue is enlarged and the desired breadth of design is amplified. Further, a clear image is provided by using the white color obtained by the invention as the background.

The multicolor forming materials according to the invention containing the blue pigment or fluorescent brightening agent in the image forming layer thereof can effectively restrain the change of hue due to the decomposed material of infrared absorbing dye, so that it is extremely useful for preparing the multicolor image on the white background of a plastic film, for example, for packaging.

The heat transfer sheet according to the invention can provide favorable whiteness as a white image and an image of high image quality.

1. A heat transfer sheet comprising a support, a light-to-heat converting layer and an image forming layer, wherein the image forming layer contains at least a white pigment and an amorphous organic polymer having a softening point of 40° C. to 150° C., an average particle size of the white pigment is from 0.01 μm to 0.32 μm, an amount of the white pigment is from 40% by weight to 90% by weight based on the total weight of the image forming layer, an amount of the amorphous organic polymer is from 10% by weight to 60% by weight based on the total weight of the image forming layer, and a thickness of the image forming layer is from 0.5 μm to 3.0 μm.

2. The heat transfer sheet as claimed in claim 1, wherein the white pigment is at least one white pigment selected from titanium oxide, aluminum oxide and silicon oxide.

3. The heat transfer sheet as claimed in claim 1, wherein the image-forming layer contains titanium oxide having an average particle size of from 0.15 μm to 0.32 μm.

4. The heat transfer sheet as claimed in claim 1, wherein the light-to-heat converting layer contains at least a polyamideimide resin or a polyimide resin as a binder.

5. The heat transfer sheet as claimed in claim 1, wherein the light-to-heat converting layer contains a cyanine dye as a light-to-heat converting agent.

6. The heat transfer sheet as claimed in claim 1, wherein the image forming layer contains at least one of a blue pigment and a fluorescent brightening agent.

7. The heat transfer sheet as claimed in claim 6, wherein the blue pigment is at least one blue pigment selected from ultramarine blue and organic blue pigments.

8. The heat transfer sheet as claimed in claim 1, wherein hue of the image-forming layer after image recording satisfies the following conditions when measured on a black backing:
L* is not less than 70,
a* is from −3.0 to 0 and
b* is from −6.0 to −3.0.

9. The heat transfer sheet as claimed in claim 8, wherein b* is from −6.0 to −3.0.

10. The heat transfer sheet as claimed in claim 1, wherein an opacifying ratio of the image forming layer is not less than 55%.

11. The heat transfer sheet as claimed in claim 1, wherein thickness of the image forming layer is from 0.5 μm to 1.8 μm.

12. The heat transfer sheet as claimed in claim 1, wherein absorbance (A) of the light-to-heat converting layer at an absorption wavelength of a laser beam used for image recording is from 1.0 to 2.0 and a ratio (A/X) of the absorbance (A) of the light-to-heat converting layer to thickness (X) (μm unit) of the light-to-heat converting layer is 2.5 to 3.2.

13. The heat transfer sheet as claimed in claim 1, which further comprises an intermediate layer between the light-to-heat converting layer and the image forming layer.

14. The heat transfer sheet as claimed in claim 13, wherein the intermediate layer contains at least an ionomer resin or polyvinyl alcohol.

15. The heat transfer sheet as claimed in claim 1, wherein an extinction coefficient of the light-to-heat converting layer at a wavelength of an active ray is not more than 1.3.

16. An image forming material which comprises an image receiving sheet having an image receiving layer and the heat transfer sheet as claimed in claim 1, and is used by superposing the image forming layer on the image receiving layer of image receiving sheet so that the image forming layer faces the image receiving layer, irradiating the image forming layer with a laser beam, and transferring the irradiated area of the image forming layer onto the image receiving layer of image receiving sheet to perform image recording.

17. An image forming method comprising preparing the image forming material as claimed in claim 16, superposing the image forming layer on the image receiving layer of image receiving sheet so that the image forming layer faces the image receiving layer, irradiating the image forming layer with a laser beam, and transferring the irradiated area of the image forming layer in the state of a thin film onto the image receiving layer of image receiving sheet.
